(19) United States
(12) Patent Application Publication
(10) Pub. No.: US 2026/0322554 A1
(43) Pub. Date: Oct. 15, 2026

(54) METHOD AND DEVICE FOR DETERMINING PRIORITY OF UPLINK REFERENCE SIGNAL IN WIRELESS COMMUNICATION SYSTEM

(71) Applicant: SAMSUNG ELECTRONICS CO., LTD., Suwon-si, Gyeonggi-do (KR)

(72) Inventors: Youngrok JANG, Suwon-si (KR); Ameha Tsegaye ABEBE, Suwon-si (KR); Seongmok LIM, Suwon-si (KR); Hyoungju JI, Suwon-si (KR)

(21) Appl. No.: 19/142,051

(22) PCT Filed: Dec. 22, 2023
(86) PCT No.: PCT/KR2023/021471

§ 371 Date: Jun. 20, 2025

(30) Foreign Application Priority Data
Dec. 23, 2022 (KR) 10-2022-0182700

(51) Int. Cl. H04L 5/00; H04W 72/231; H04W 80/02

(52) U.S. Cl. CPC H04L 5/0051; H04W 72/231; H04W 80/02

(57) ABSTRACT

The present invention relates to a 5G or 6G communication system for supporting higher transmission rates. A method performed by a user equipment (UE) in a wireless communication system comprises the steps in which the UE: receives, from a base station, configuration information including information about a sounding reference signal (SRS) resource for transmitting an SRS signal through eight antenna ports, wherein the SRS resource includes at least two SRS transmission units respectively associated with at least two subsets of antenna ports included among the eight antenna ports; and transmits the SRS to the base station on the basis of the configuration information, the SRS being transmitted on a first subset of antenna ports associated with first SRS transmission units and a second subset of antenna ports associated with second SRS transmission units in each of the two SRS transmission units, wherein, when at least one SRS transmission unit among the first SRS transmission units or the second SRS transmission units overlaps at least one of aperiodic uplink transmission or aperiodic downlink reception, SRS transmissions for all or a portion of the first SRS transmission units and the second SRS transmission units may be dropped.

### TECHNICAL FIELD

The disclosure relates to an operation of a terminal and a base station in a wireless communication system. Specifically, the disclosure relates to a method of determining the priority of an uplink reference signal in a wireless communication system, and a device capable of performing same.

### BACKGROUND ART

5G mobile communication technologies define broad frequency bands to enable high transmission rates and new services, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

At the beginning of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

Embodiments set forth herein are to provide a device and a method capable of effectively providing services in a mobile communication system.

### Solution to Problem

In order to achieve the tasks described above, the disclosure provides a method performed by a terminal (user equipment, UE) in a wireless communication system, the method including receiving, from a base station, configuration information including information on a sounding reference signal (SRS) resource for transmitting an SRS by the terminal through eight antenna ports, the SRS resource including at least two SRS transmission occasions associated with at least two antenna port subsets included in the eight antenna ports, respectively, and transmitting, based on the configuration information and to the base station, the SRS on a first antenna port subset associated with a first SRS transmission occasion and a second antenna port subset associated with a second SRS transmission occasion in the at least two SRS transmission occasions, respectively, wherein, in case that at least one SRS transmission occasion among the first SRS transmission occasion or the second SRS transmission occasion overlaps at least one of an aperiodic uplink transmission or an aperiodic downlink reception, an SRS transmission for all or a part of the first SRS transmission occasion and the second SRS transmission occasion is dropped.

In addition, the disclosure provides a method performed by a base station in a wireless communication system, the method including transmitting, to a terminal, configuration information including information on a sounding reference signal (SRS) resource for receiving an SRS through eight antenna ports of the terminal, the SRS resource including at least two SRS transmission occasions associated with at least two antenna port subsets included in the eight antenna ports, respectively, and receiving, based on the configuration information and from the terminal, the SRS on a first antenna port subset associated with a first SRS transmission occasion and a second antenna port subset associated with a second SRS transmission occasion in the at least two SRS transmission occasions, respectively, wherein, in case that at least one SRS transmission occasion among the first SRS transmission occasion or the second SRS transmission occasion overlaps at least one of an aperiodic uplink reception or an aperiodic downlink transmission, an SRS reception for all or a part of the first SRS transmission occasion and the second SRS transmission occasion is dropped.

In addition, the disclosure provides a terminal (user equipment, UE) in a wireless communication system, the terminal including a transceiver and a controller connected to the transceiver, wherein the controller is configured to receive, from a base station, configuration information including information on a sounding reference signal (SRS) resource for transmitting an SRS by the terminal through eight antenna ports, the SRS resource including at least two SRS transmission occasions associated with at least two antenna port subsets included in the eight antenna ports, respectively, and transmit, based on the configuration information and to the base station, the SRS on a first antenna port subset associated with a first SRS transmission occasion and a second antenna port subset associated with a second SRS transmission occasion in the at least two SRS transmission occasions, respectively, and wherein, in case that at least one SRS transmission occasion among the first SRS transmission occasion or the second SRS transmission occasion overlaps at least one of an aperiodic uplink transmission or an aperiodic downlink reception, an SRS transmission for all or a part of the first SRS transmission occasion and the second SRS transmission occasion is dropped.

In addition, the disclosure provides a base station in a wireless communication system, the base station including a transceiver and a controller connected to the transceiver, wherein the controller is configured to transmit, to a terminal, configuration information including information on a sounding reference signal (SRS) resource for receiving an SRS through eight antenna ports of the terminal, the SRS resource including at least two SRS transmission occasions associated with at least two antenna port subsets included in the eight antenna ports, respectively, and receive, based on the configuration information and from the terminal, the SRS on a first antenna port subset associated with a first SRS transmission occasion and a second antenna port subset associated with a second SRS transmission occasion in the at least two SRS transmission occasions, respectively, and wherein, in case that at least one SRS transmission occasion among the first SRS transmission occasion or the second SRS transmission occasion overlaps at least one of an aperiodic uplink reception or an aperiodic downlink transmission, an SRS reception for all or a part of the first SRS transmission occasion and the second SRS transmission occasion is dropped.

### Advantageous Effects of Invention

Embodiments set forth herein provide a device and a method capable of effectively providing services in a mobile communication system.

### BRIEF DESCRIPTION OF DRAWINGS

FIG. 1 illustrates a basic structure of a time-frequency domain in a wireless communication system according to an embodiment of the disclosure.

FIG. 2 illustrates a structure of a frame, a subframe, and a slot in a wireless communication system according to an embodiment of the disclosure.

FIG. 3 illustrates an example of a bandwidth part configuration in a wireless communication system according to an embodiment of the disclosure.

FIG. 4 illustrates an example of a control resource set configuration of a downlink control channel in a wireless communication system according to an embodiment of the disclosure.

FIG. 5A illustrates a structure of a downlink control channel in a wireless communication system according to an embodiment of the disclosure.

FIG. 5B illustrates, in terms of spans, a case in which a UE may have multiple PDCCH monitoring occasions inside a slot in a wireless communication system according to an embodiment of the disclosure.

FIG. 6 illustrates an example of a DRX operation in a wireless communication system according to an embodiment of the disclosure.

FIG. 7 illustrates an example of base station beam allocation according to a TCI state configuration in a wireless communication system according to an embodiment of the disclosure.

FIG. 8 illustrates an example of a method for allocating a TCI state to a PDCCH in a wireless communication system according to an embodiment of the disclosure

FIG. 9 illustrates a TCI indication MAC CE signaling structure for a PDCCH DMRS in a wireless communication system according to an embodiment of the disclosure.

FIG. 10 illustrates an example of beam configuration with regard to a control resource set and a search space in a wireless communication system according to an embodiment of the disclosure.

FIG. 11 illustrates a method in which a base station and a UE transmit/receive data in consideration of a downlink data channel and a rate matching resource in a wireless communication system according to an embodiment of the disclosure.

FIG. 12 illustrates a method in which, upon receiving a downlink control channel, a UE selects a receivable control resource set in consideration of priority in a wireless communication system according to an embodiment of the disclosure.

FIG. 13 illustrates an example of frequency domain resource allocation with regard to a PDSCH in a wireless communication system according to an embodiment of the disclosure.

FIG. 14 illustrates an example of time domain resource allocation with regard to a PDSCH in a wireless communication system according to an embodiment of the disclosure.

FIG. 15 illustrates an example of time domain resource allocation according to a subcarrier spacing with regard to a data channel and a control channel in a wireless communication system according to an embodiment of the disclosure.

FIG. 16 illustrates a process for beam configuration and activation with regard to a PDSCH.

FIG. 17 illustrates PUSCH repetition type B transmission in a wireless communication system according to an embodiment of the disclosure.

FIG. 18 illustrates radio protocol structures of a base station and a UE in single cell, carrier aggregation, and dual connectivity situations in a wireless communication system according to an embodiment of the disclosure.

FIG. 19 is a diagram illustrating a structure in which an SRS is allocated for each subband.

FIG. 20 is a diagram illustrating a configuration of downlink control information (DCI) for cooperative communication in a wireless communication system according to an embodiment of the disclosure.

FIG. 21 is a diagram illustrating an operation of a base station for SRS reception according to an embodiment of the disclosure.

FIG. 22 is a diagram illustrating a TPC application time order for each SRS transmission occasion according to an embodiment of the disclosure.

FIG. 23 is a diagram illustrating an operation for TPC application at the time of SRS transmission of a terminal according to an embodiment of the disclosure.

FIG. 24 is a diagram illustrating an operation of a base station for TPC application at the time of SRS transmission of a terminal according to an embodiment of the disclosure.

FIG. 25 is a diagram illustrating an operation of a terminal when an SRS transmission of the terminal overlaps another uplink or downlink channel according to an embodiment of the disclosure.

FIG. 26 is a diagram illustrating an operation of a base station when an SRS transmission of the terminal overlaps another uplink or downlink channel according to an embodiment of the disclosure.

FIG. 27 illustrates a structure of a UE in a wireless communication system according to an embodiment of the disclosure.

FIG. 28 illustrates a structure of a base station in a wireless communication system according to an embodiment of the disclosure.

### MODE FOR THE INVENTION

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, abase station is an entity that allocates resources to terminals, and may be at least one of a gNode B, an eNode B, a Node B, a base station (BS), a wireless access unit, abase station controller, and anode on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to abase station. Furthermore, in the following description, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure. The contents of the disclosure may be applied to FDD and TDD systems.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (UE) or a mobile station (MS) transmits data or control signals to a base station (BS) or eNode B, and the downlink refers to a radio link via which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. Also, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC is a cellular-based mission-critical wireless communication service. For example, URLLC may be used for services such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms, and may also requires a packet error rate of 10 or less. Therefore, for the services supporting URLLC, a 5G system must provide a transmit time interval (TTI) shorter than those of other services, and also may require a design for assigning a large number of resources in a frequency band in order to secure reliability of a communication link.

The three services in 5G, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

### [NR Time-Frequency Resources]

Hereinafter, a frame structure of a 5G system will be described in more detail with reference to the accompanying drawings.

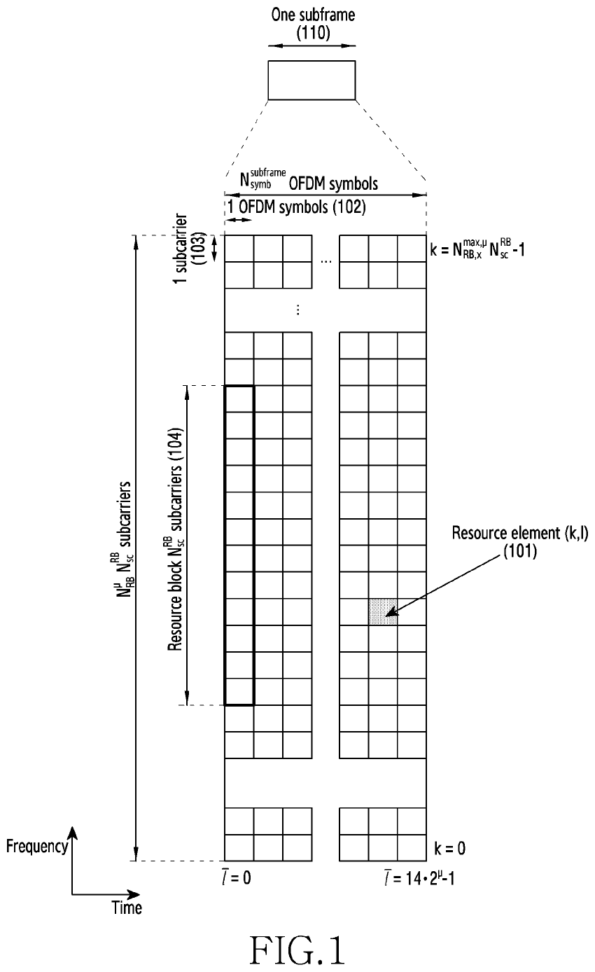

FIG. 1 illustrates a basic structure of a time-frequency domain, which is a radio resource domain used to transmit data or control channels, in a 5G system.

In FIG. 1, the horizontal axis denotes a time domain, and the vertical axis denotes a frequency domain. The basic unit of resources in the time-frequency domain is a resource element (RE) 101, which may be defined as one orthogonal frequency division multiplexing (OFDM) symbol 102 on the time axis and one subcarrier 103 on the frequency axis. In the frequency domain,

$${N}_{SC}^{R B}$$

(for example, 12) consecutive REs may constitute one resource block (RB) 104.

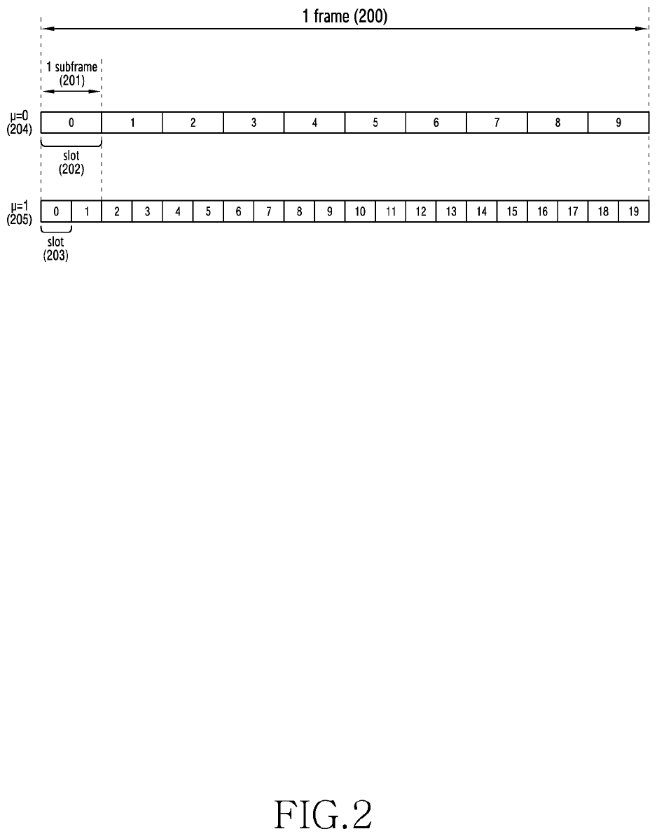

FIG. 2 illustrates a structure of a frame, a subframe, and a slot in a wireless communication system according to an embodiment of the disclosure.

An example of a structure of a frame 200, a subframe 201, and a slot 202 is illustrated in FIG. 2. One frame 200 may be defined as 10 ms. One subframe 201 may be defined as 1 ms, and thus one frame 200 may include a total of ten subframes 201. One slot 202 or 203 may be defined as 14 OFDM symbols (that is, the number of symbols per one slot

$${N}_{symb}^{slot} = 14 ) .$$

One subframe 201 may include one or multiple slots 202 and 203, and the number of slots 202 and 203 per one subframe 201 may vary depending on configuration values μ for the subcarrier spacing 204 or 205. The example in FIG. 2 illustrates a case in which the subcarrier spacing configuration value is μ=0 (204), and a case in which μ=1 (205). In the case of μ=0 (204), one subframe 201 may include one slot 202, and in the case of μ=1 (205), one subframe 201 may include two slots 203. That is, the number of slots per one subframe

$${N}_{slot}^{subframe , μ}$$

may differ depending on the subcarrier spacing configuration value μ, and the number of slots per one frame

$${N}_{slot}^{frame , μ}$$

may differ accordingly.

$${N}_{slot}^{subframe , μ} and {N}_{slot}^{frame , μ}$$

may be defined according to each subcarrier spacing configuration μ as in Table 1 below.

TABLE 1

| μ | ${N}_{symb}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [Bandwidth Part (BWP)]

Next, a bandwidth part (BWP) configuration in a 5G communication system will be described in detail with reference to the accompanying drawings.

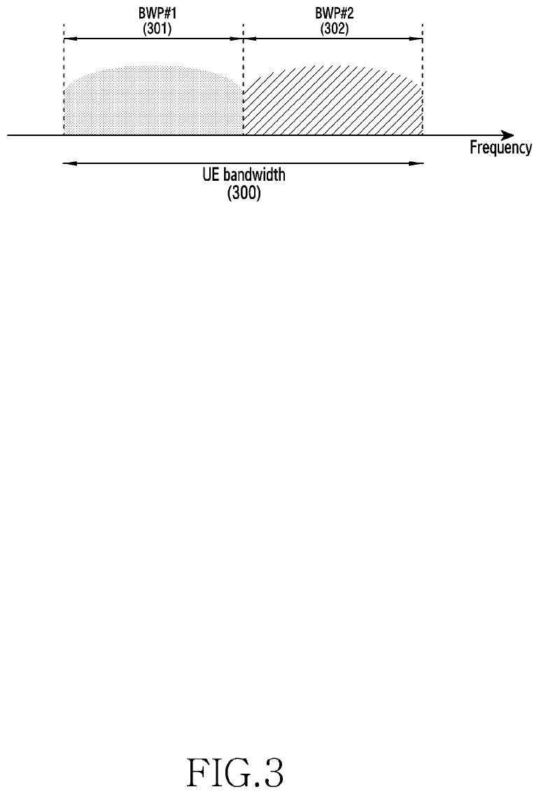

FIG. 3 illustrates an example of a bandwidth part configuration in a wireless communication system according to an embodiment of the disclosure.

FIG. 3 illustrates an example in which a UE bandwidth 300 is configured to include two bandwidth parts, that is, bandwidth part #1 (BWP #1) 301 and bandwidth part #2 (BWP #2) 302. Abase station may configure one or multiple bandwidth parts for a UE, and may configure the following pieces of information with regard to each bandwidth part as given in Table 2 below.

TABLE 2

| | |
|---|---|
| BWP ::= | SEQUENCE { |
| bwp-Id | BWP-Id, |

(bandwidth part identifier)

| | |
|---|---|
| locationAndBandwidth | INTEGER (1..65536), |

(bandwidth part location)

| | |
|---|---|
| subcarrierSpacing | ENUMERATED {n0, n1, n2, n3, n4, n5}, |

(subcarrier spacing)

| | |
|---|---|
| cyclicPrefix | ENUMERATED { extended } |

(cyclic prefix)
}

Of course, the bandwidth part configuration is not limited to the above example in Table 2, and in addition to the configuration information in Table 2, various parameters related to the bandwidth part may be configured for the UE. The base station may transfer the configuration information to the UE through upper layer signaling, for example, radio resource control (RRC) signaling. One configured bandwidth part or at least one bandwidth part among multiple configured bandwidth parts may be activated. Whether or not the configured bandwidth part is activated may be transferred from the base station to the UE semi-statically through RRC signaling, or dynamically through downlink control information (DCI).

According to an embodiment, before a radio resource control (RRC) connection, an initial bandwidth part (BWP) for initial access may be configured for the UE by the base station through a master information block (MIB). More specifically, the UE may receive configuration information regarding a control resource set (CORESET) and a search space which may be used to transmit a PDCCH for receiving system information (which may correspond to remaining system information (RMSI) or system information block 1 (SIB1) necessary for initial access through the MIB in the initial access step. Each of the control resource set and the search space configured through the MIB may be considered identity (ID) 0. The base station may notify the UE of configuration information, such as frequency allocation information, time allocation information, and numerology, regarding CORESET #0 through the MIB. In addition, the base station may notify the UE of configuration information regarding the monitoring periodicity and occasion with regard to control resource set #0, that is, configuration information regarding search space #0, through the MIB. The UE may consider that a frequency domain configured by control resource set #0 acquired from the MIB is an initial bandwidth part for initial access. The ID of the initial bandwidth part may be considered to be 0.

According to various embodiments of the disclosure, the bandwidth part-related configuration supported by 5G may be used for various purposes.

According to an embodiment, if the bandwidth supported by the UE is smaller than the system bandwidth, this may be supported through the bandwidth part configuration. For example, the base station may configure the frequency location (configuration information 2) of the bandwidth part for the UE, so that the UE can transmit/receive data at a specific frequency location within the system bandwidth.

In addition, according to an embodiment, the base station may configure multiple bandwidth parts for the UE for the purpose of supporting different numerologies. For example, in order to support a UE's data transmission/reception using both a subcarrier spacing of 15 kHz and a subcarrier spacing of 30 kHz, two bandwidth parts may be configured as subcarrier spacings of 15 kHz and 30 kHz, respectively. Different bandwidth parts may be subjected to frequency division multiplexing (FDM), and if data is to be transmitted/received at a specific subcarrier spacing, the bandwidth part configured as the corresponding subcarrier spacing may be activated.

In addition, according to an embodiment, the base station may configure bandwidth parts having different sizes of bandwidths for the UE for the purpose of reducing power consumed by the UE. For example, if the UE supports a substantially large bandwidth, for example, 100 MHz, and always transmits/receives data with the corresponding bandwidth, a substantially large amount of power consumption may occur. Particularly, it may be substantially inefficient from the viewpoint of power consumption to unnecessarily monitor the downlink control channel with a large bandwidth of 100 MHz in the absence of traffic. In order to reduce power consumed by the UE, the base station may configure a bandwidth part of a relatively small bandwidth (for example, a bandwidth part of 20 MHz) for the UE. The UE may perform a monitoring operation in the 20 MHz bandwidth part in the absence of traffic, and may transmit/receive data with the 100 MHz bandwidth part as instructed by the base station if data has occurred.

According to an embodiment, in connection with the bandwidth part configuring method, UEs, before RRC-connected, may receive configuration information regarding the initial bandwidth part (initial BWP) through an MIB in the initial access step. To be more specific, a UE may have a control resource set (CORESET) configured for a downlink control channel which may be used to transmit downlink control information (DCI) for scheduling a system information block (SIB) from the MIB of a physical broadcast channel (PBCH). The bandwidth of the control resource set configured by the MIB may be considered as the initial bandwidth part, and the UE may receive, through the configured initial bandwidth part, a physical downlink shared channel (PDSCH) through which an SIB is transmitted. The initial bandwidth part may be used not only for the purpose of receiving the SIB, but also for other system information (OSI), paging, random access, or the like.

### [Bandwidth Part (BWP) Change]

If a UE has one or more bandwidth parts configured therefor, the base station may indicate, to the UE, to change (or switch or transition) the bandwidth parts by using a bandwidth part indicator field inside DCI. As an example, if the currently activated bandwidth part of the UE is bandwidth part #1 301 in FIG. 3, the base station may indicate bandwidth part #2 302 with a bandwidth part indicator inside DCI, and the UE may change the bandwidth part to bandwidth part #2 302 indicated by the bandwidth part indicator inside received DCI.

As described above, DCI-based bandwidth part changing may be indicated by DCI for scheduling a PDSCH or a PUSCH, and thus, upon receiving a bandwidth part change request, the UE needs to be able to receive or transmit the PDSCH or PUSCH scheduled by the corresponding DCI in the changed bandwidth part with no problem. To this end, requirements for the delay time (T_{BWP}) required during a bandwidth part change are specified in standards, and may be defined given in Table 3 below, for example. Obviously, the examples given below are not limiting.

TABLE 3

| | | BWP switch delay T_{BWP} (slots) | |
|---|---|---|---|
| μ | NR Slot length (ms) | Type 1^{Note 1} | Type 2^{Note 1} |
| 0 | 1 | 1 | 3 |
| 1 | 0.5 | 2 | 5 |
| 2 | 0.25 | 3 | 9 |
| 3 | 0.125 | 6 | 18 |

^{Note 1}:
Depends on UE capability.
^{Note 2}:
If the BWP switch involves changing of SCS, the BWP switch delay is determined by the larger one between the SCS before BWP switch and the SCS after BWP switch.

The requirements for the bandwidth part change delay time support type 1 or type 2, depending on the capability of the UE. The UE may report the supportable bandwidth part change delay time type to the base station.

If the UE has received DCI including a bandwidth part change indicator in slot n, according to the above-described requirement regarding the bandwidth part change delay time, the UE may complete a change to the new bandwidth part indicated by the bandwidth part change indicator at a timepoint not later than slot n+T_{BWP}, and may transmit/receive a data channel scheduled by the corresponding DCI in the newly changed bandwidth part. According to an embodiment, if the base station wants to schedule a data channel by using the new bandwidth part, the base station may determine time domain resource allocation regarding the data channel, based on the UE's bandwidth part change delay time (T_{BWP}). That is, when scheduling a data channel by using the new bandwidth part, the base station may schedule the corresponding data channel after the bandwidth part change delay time, in connection with the method for determining time domain resource allocation regarding the data channel. Accordingly, the UE may not expect that the DCI that indicates a bandwidth part change will indicate a slot offset (K0 or K2) value smaller than the bandwidth part change delay time (T_{BWP}).

If the UE has received DCI (for example, DCI format 1_1 or 0_1) indicating a bandwidth part change, the UE may perform no transmission or reception during a time interval from the third symbol of the slot used to receive a PDCCH including the corresponding DCI to the start point of the slot indicated by a slot offset (K0 or K2) value indicated by a time domain resource allocation indicator field in the corresponding DCI. For example, if the UE has received DCI indicating a bandwidth part change in slot n, and if the slot offset value indicated by the corresponding DCI is K, the UE may perform no transmission or reception from the third symbol of slot n to the symbol before slot n+K (for example, the last symbol of slot n+K−1).

### [SS/PBCH Block]

Next, synchronization signal (SS)/PBCH blocks in 5G will be described.

An SS/PBCH block may refer to a physical layer channel block including a primary synchronization signal (PSS), a secondary synchronization signal (SSS), and a PBCH. Details thereof are as follows.
PSS: a signal which becomes a reference of downlink time/frequency synchronization, and provides partial information of a cell ID.
SSS: becomes a reference of downlink time/frequency synchronization, and provides remaining cell ID information not provided by the PSS. Additionally, the SSS may serve as a reference signal for PBCH demodulation of a PBCH.
PBCH: provides an MIB which is mandatory system information necessary for the UE to transmit/receive data channels and control channels. The mandatory system information may include search space-related control information indicating a control channel's radio resource mapping information, scheduling control information regarding a separate data channel for transmitting system information, and the like.
SS/PBCH block: the SS/PBCH block includes a combination of a PSS, an SSS, and a PBCH. One or multiple SS/PBCH blocks may be transmitted within a time period of 5 ms, and each transmitted SS/PBCH block may be distinguished by an index.

The UE may detect the PSS and the SSS in the initial access stage, and may decode the PBCH. The UE may acquire an MIB from the PBCH, and this may be used to configure control resource set (CORESET) #0 (which may correspond to a control resource set having a control resource set index of 0). The UE may monitor control resource set #0 by assuming that the demodulation reference signal (DMRS) transmitted in the selected SS/PBCH block and control resource set #0 are quasi-co-located (QCL). The UE may receive system information with downlink control information transmitted in control resource set #0. The UE may acquire configuration information related to a random access channel (RACH) necessary for initial access from the received system information. The UE may transmit a physical RACH (PRACH) to the base station in consideration of a selected SS/PBCH index, and the base station, upon receiving the PRACH, may acquire information regarding the SS/PBCH block index selected by the UE. The base station may know which block the UE has selected from respective SS/PBCH blocks, and the fact that control resource set #0 associated therewith is monitored.

### [DRX]

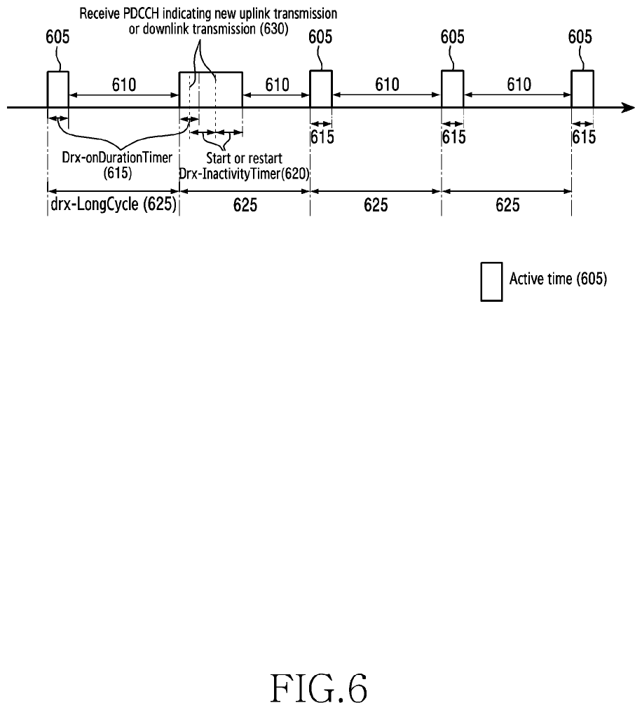

FIG. 6 illustrates discontinuous reception (DRX).

DRX refers to an operation in which a UE currently using a service discontinuously receives data in an RRC-connected state in which a radio link is configured between the base station and the UE. If the DRX is applied, the UE may turn on a receiver at a specific timepoint so as to monitor a control channel, and may turn off the receiver if there is no data received for a predetermined period of time, thereby reducing power consumed by the UE. The DRX operation may be controlled by a MAC layer device, based on various parameters and timers.

Referring to FIG. 6, the active time 605 refers to a time during which the UE wakes up at each DRX cycle and monitors the PDCCH. The active timer 605 may be defined as follows.
drx-onDurationTimer or drx-InactivityTimer or drx-RetransmissionTimerDL or drx-RetransmissionTimerUL or ra-ContentionResolutionTimer is running; or
a Scheduling Request is sent on PUCCH and is pending; or
a PDCCH indicating a new transmission addressed to the C-RNTI of the MAC entity has not been received after successful reception of a Random Access Response for the Random Access Preamble not selected by the MAC entity among the contention-based Random Access Preamble

drx-onDurationTimer, drx-InactivityTimer, drx-RetransmissionTimerDL, drx-RetransmissionTimerUL, ra-ContentionResolutionTimer, and the like are timers having values configured by the base station, and may include functions which configure the UE to monitor the PDCCH in a situation in which a predetermined condition is satisfied.

drx-onDurationTimer 615 is a parameter for configuring the minimum time during which the UE is awake at the DRX cycle. drx-InactivityTimer 620 is a parameter for configuring a time during which the UE is additionally awake upon receiving (630) a PDCCH indicating new uplink transmission or downlink transmission. drx-RetransmissionTimerDL is a parameter for configuring the maximum time during which the UE is awake in order to receive downlink retransmission in a downlink HARQ procedure. drx-RetransmissionTimerUL is a parameter for configuring the maximum time during which the UE is awake in order to receive an uplink retransmission grant in an uplink HARQ procedure. drx-onDurationTimer, drx-InactivityTimer, drx-RetransmissionTimerDL, and drx-RetransmissionTimerUL may be configured as, for example, time, the number of subframes, the number of slots, and the like. ra-ContentionResolutionTimer is a parameter for monitoring the PDCCH in a random access procedure.

inActive time 610 refers to a time configured such that the PDCCH is not monitored during the DRX operation or a time configured such that the PDCCH is not received, and the inActive time 605 may be obtained by subtracting the active timer 610 from the entire time during which the DRX operation is performed. If the UE does not monitor the PDCCH during the active time 605, the UE may enter a sleep or inActive state, thereby reducing power consumption.

The DRX cycle may refer to the cycle at which the UE wakes up and monitors the PDCCH. That is, the DRX cycle refers to the time interval between when the UE monitors a PDCCH and when the next PDCCH is monitored, or the cycle at which on-duration occurs. There are two kinds of DRX cycles: a short DRX cycle and a long DRX cycle. The short DRX cycle may be optionally applied.

The long DRX cycle 625 is the longer cycle between two DRX cycles configured for the UE. While operating with long DRX, the UE restarts the drx-onDurationTimer 615 at a timepoint at which the long DRX cycle 625 has elapsed from the start point (for example, start symbol) of the drx-onDurationTimer 615. If operating at the long DRX cycle 625, the UE may start the drx-onDurationTimer 615 in a slot after drx-SlotOffset in a subframe satisfying Equation 1 below. Here, drx-SlotOffset may refer to a delay before the drx-onDurationTimer 615 is started. The drx-SlotOffset may be configured, for example, as time, the number of slots, or the like.

$$[ ( SFN X 10 ) + subframe number ] modulo ( drx - LongCycle ) = drx - StartOffset \qquad [ Equation 1 ]$$

where, drx-LongCycleStartOffset may be used to define the long DRX cycle 625, and drx-StartOffset may be used to define a subframe to start the long DRX cycle 625. drx-LongCycleStartOffset may be configured as, for example, time, the number of subframes, the number of slots, or the like.

### [PDCCH: Regarding DCI]

Next, downlink control information (DCI) in a 5G system will be described in detail.

In a 5G system, scheduling information regarding uplink data (or physical uplink shared channel (PUSCH)) or downlink data (or physical downlink shared channel (PDSCH)) may be transferred from abase station to a UE through DCI. The UE may monitor, with regard to the PUSCH or PDSCH, a fallback DCI format and a non-fallback DCI format. The fallback DCI format may include a fixed field predefined between the base station and the UE, and the non-fallback DCI format may include a configurable field.

The DCI may be subjected to channel coding and modulation processes and then transmitted through a physical downlink control channel (PDCCH) after a channel coding and modulation process. A cyclic redundancy check (CRC) may be attached to the payload of a DCI message, and the CRC may be scrambled by a radio network temporary identifier (RNTI) corresponding to the identity of the UE. Different RNTIs may be used according to the purpose of the DCI message, for example, UE-specific data transmission, power control command, or random access response. That is, the RNTI may not be explicitly transmitted, but may be transmitted while being included in a CRC calculation process. Upon receiving a DCI message transmitted through the PDCCH, the UE may identify the CRC by using the allocated RNTI, and if the CRC identification result is right, the UE may know that the corresponding message has been transmitted to the UE.

For example, DCI for scheduling a PDSCH regarding system information (SI) may be scrambled by an SI-RNTI. DCI for scheduling a PDSCH regarding a random access response (RAR) message may be scrambled by an RA-RNTI. DCI for scheduling a PDSCH regarding a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI).

DCI format 0_0 may be used as fallback DCI for scheduling a PUSCH, and in this case, the CRC may be scrambled by a C-RNTI. DCI format 0_0 in which the CRC is scrambled by a C-RNTI may include the following pieces of information given in Table 4 below, for example. Obviously, the examples given below are not limiting.

```
TABLE 4
  - Identifier for DCI formats - [1] bit
  - Frequency domain resource assignment
$[ ⌈ {log}_{2} ( {N}_{RB}^{UL , BWP} ( {N}_{RB}^{UL , BWP} + 1 ) / 2 ) ⌉ ] bits$
  - Time domain resource assignment - X bits
  - Frequency hopping flag - 1 bit.
  - Modulation and coding scheme - 5 bits
  - New data indicator - 1 bit
  - Redundancy version - 2 bits
  - HARQ process number - 4 bits
  - Transmit power control (TPC) command for scheduled PUSCH - [2] bits
  - Uplink/ supplementary uplink (UL/SUL) indicator - 0 or 1 bit
```

DCI format 0_1 may be used as non-fallback DCI for scheduling a PUSCH, and in this case, the CRC may be scrambled by a C-RNTI. DCI format 0_1 in which the CRC is scrambled by a C-RNTI may include the following pieces of information given in Table 5 below, for example. Obviously, the examples given below are not limiting.

```
TABLE 5
  - Carrier indicator - 0 or 3 bits
  - UL/SUL indicator - 0 or 1 bit
  - Identifier for DCI formats - [1] bits
  - Bandwidth part indicator - 0, 1 or 2 bits
  - Frequency domain resource assignment
            $* For resource allocation type 0 , ⌈ {N}_{RB}^{UL , BWP} / P ⌉ bits$
            $* For resource allocation type 1 , ⌈ {log}_{2} ( {N}_{RB}^{UL , BWP} ( {N}_{RB}^{UL , BWP} + 1 ) / 2 ⌉ bits$
  - Time domain resource assignment -1, 2, 3, or 4 bits
  - Virtual resource block (VRB)-to-physical resource block (PRB) mapping -
0 or 1 bit, only for resource allocation type 1.
            * 0 bit if only resource allocation type 0 is configured;
            * 1 bit otherwise.
  - Frequency hopping flag - 0 or 1 bit, only for resource allocation type 1.
            * 0 bit if only resource allocation type 0 is configured;
            * 1 bit otherwise.
  - Modulation and coding scheme - 5 bits
  - New data indicator - 1 bit
  - Redundancy version - 2 bits
  - HARQ process number - 4 bits
  - 1st downlink assignment index- 1 or 2 bits
            * 1 bit for semi-static HARQ-ACK codebook;
            * 2 bits for dynamic HARQ-ACK codebook with single HARQ-
            ACK codebook.
  - 2nd downlink assignment index - 0 or 2 bits
            * 2 bits for dynamic HARQ-ACK codebook with two HARQ-
            ACK sub-codebooks;
            * 0 bit otherwise.
  - TPC command for scheduled PUSCH - 2 bits
  $‐ SRS resource indicator - ⌈ {log}_{2} ( {\sum }_{k = 1}^{{L}_{max}} ( \begin{matrix}{N}_{SRS} \\ k\end{matrix} ) ) ⌉ or ⌈ {log}_{2} ( {N}_{SRS} ) ⌉ bits$
            $* ⌈ {log}_{2} ( {\sum }_{k = 1}^{{L}_{max}} ( \begin{matrix}{N}_{SRS} \\ k\end{matrix} ) ) ⌉ bits for non - codebook based PUSCH transmission ;$
            * ┌log₂(N_{SRS})┐ bits for codebook based PUSCH transmission.
  - Precoding information and number of layers - up to 6 bits
  - Antenna ports - up to 5 bits
  - SRS request - 2 bits
  - Channel state information (CSI) request - 0, 1, 2, 3, 4, 5, or 6 bits
  - Code block group (CBG) transmission information - 0, 2, 4, 6, or 8 bits
  - Phase tracking reference signal (PTRS)-demodulation reference signal
(DDMRS) association - 0 or 2 bits.
  - beta_offset indicator - 0 or 2 bits
  - DMRS sequence initialization - 0 or 1 bit
```

DCI format 1_0 may be used as fallback DCI for scheduling a PDSCH, and in this case, the CRC may be scrambled by a C-RNTI. DCI format 1_0 in which the CRC is scrambled by a C-RNTI may include the following pieces of information given in Table 6 below, for example. Obviously, the examples given below are not limiting.

```
TABLE 6
  - Identifier for DCI formats - [1] bit
  - Frequency domain resource assignment -
$[ ⌈ {log}_{2} ( {N}_{RB}^{DL , BWP} ( {N}_{RB}^{DL , BWP} + 1 ) / 2 ) ⌉ ] bits$
  - Time domain resource assignment - X bits
  - VRB-to-PRB mapping - 1 bit.
  - Modulation and coding scheme - 5 bits
  - New data indicator - 1 bit
  - Redundancy version - 2 bits
  - HARQ process number - 4 bits
  - Downlink assignment index - 2 bits
  - TPC command for scheduled PUCCH - [2] bits
  - Physical uplink control channel (PUCCH) resource indicator - 3 bits
  - PDSCH-to-HARQ feedback timing indicator - [3] bits
```

DCI format 11 may be used as non-fallback DCI for scheduling a PDSCH, and in this case, the CRC may be scrambled by a C-RNTI. DCI format 1_1 in which the CRC is scrambled by a C-RNTI may include the following pieces of information given in Table 7 below, for example. Obviously, the examples given below are not limiting.

```
TABLE 7
  - Carrier indicator - 0 or 3 bits
  - Identifier for DCI formats - [1] bits
  - Bandwidth part indicator - 0, 1 or 2 bits
  - Frequency domain resource assignment
            $* For resource allocation type 0 , ⌈ {N}_{RB}^{DL , BWP} / P ⌉ bits$
            $* For resource allocation type 1 , ⌈ {log}_{2} ( {N}_{RB}^{DL , BWP} ( {N}_{RB}^{DL , BWP} + 1 ) / 2 ⌉ bits$
  - Time domain resource assignment -1, 2, 3, or 4 bits
  - VRB-to-PRB mapping - 0 or 1 bit, only for resource allocation type 1.
            * 0 bit if only resource allocation type 0 is configured;
            * 1 bit otherwise.
  - Physical resource block (PRB) bundling size indicator - 0 or 1 bit
  - Rate matching indicator - 0, 1, or 2 bits
  - Zero power (ZP) channel state information (CSI)-reference signal (RS)
trigger - 0, 1, or 2 bits
  For transport block 1:
    - Modulation and coding scheme - 5 bits
    - New data indicator - 1 bit
    - Redundancy version - 2 bits
  For transport block 2:
    - Modulation and coding scheme - 5 bits
    - New data indicator - 1 bit
    - Redundancy version - 2 bits
  - HARQ process number - 4 bits
  - Downlink assignment index - 0 or 2 or 4 bits
  - TPC command for scheduled PUCCH - 2 bits
  - PUCCH resource indicator - 3 bits
  - PDSCH-to-HARQ feedback timing indicator - 3 bits
  - Antenna ports - 4, 5 or 6 bits
  - Transmission configuration indication - 0 or 3 bits
  - SRS request - 2 bits
  - CBG transmission information - 0, 2, 4, 6, or 8 bits
  - CBG flushing out information - 0 or 1 bit
  - DMRS sequence initialization - 1 bit
```

### [PDCCH: CORESET, REG, CCE, and Search Space]

Hereinafter, a downlink control channel in a 5G communication system will be described in more detail with reference to the accompanying drawings.

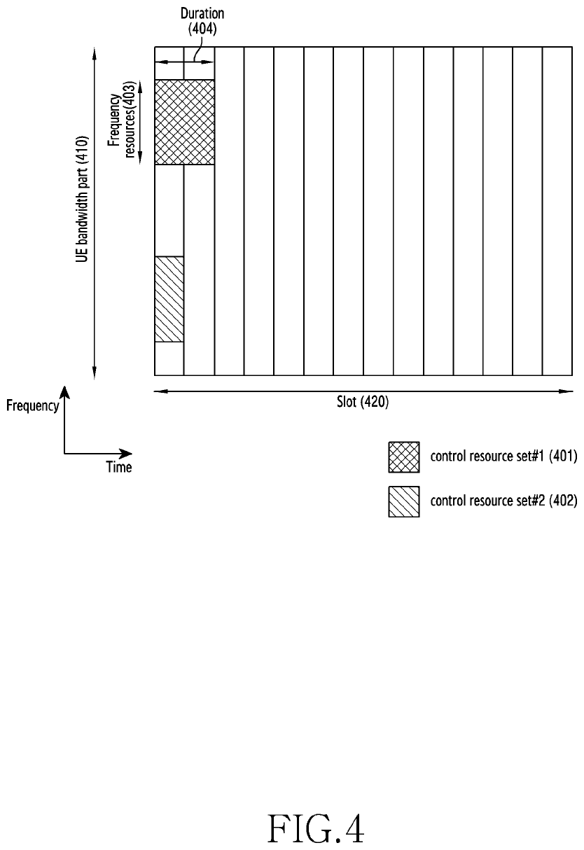

FIG. 4 illustrates an example of a control resource set (CORESET) used to transmit a downlink control channel in a 5G wireless communication system. FIG. 4 illustrates an example in which a UE bandwidth part 410 is configured along the frequency axis, and two control resource sets (control resource set #1 420 and control resource set #2 401) are configured within one slot 402 along the time axis. The control resource sets 401 and 402 may be configured in a specific frequency resource 410 within the entire UE bandwidth part 403 along the frequency axis. The control resource sets 401 and 402 may be each configured as one or multiple OFDM symbols along the time domain, and the number of the OFDM symbols may be defined as a control resource set duration 404. Referring to the example illustrated in FIG. 4, control resource set #1 401 is configured to have a control resource set duration corresponding to two symbols, and control resource set #2 402 is configured to have a control resource set duration corresponding to one symbol.

A control resource set in 5G described above may be configured for a UE by a base station through upper layer signaling (for example, system information, master information block (MIB), radio resource control (RRC) signaling). The description that a control resource set is configured for a UE means that information such as a control resource set identity, the control resource set's frequency location, and the control resource set's symbol duration is provided. For example, the following pieces of information may be included.

TABLE 8

| | |
|---|---|
| ConControlResourceSet ::= | SEQUENCE { |

-- Corresponds to L1 parameter ‘CORESET-ID’

| | |
|---|---|
| controlResourceSetId | ControlResourceSetId, |

(control resource set identity)

| | |
|---|---|
| frequencyDomainResources | BIT STRING (SIZE (45)), |

(frequency domain resource assignment information)

| | |
|---|---|
| duration | INTEGER (1..maxCoReSetDuration), |

(time domain resource assignment information)

| | |
|---|---|
| cce-REG-MappingType | CHOICE { |

(CCE-to-REG mapping type)

| | |
|---|---|
| interleaved | SEQUENCE { |
| reg-BundleSize | ENUMERATED {n2, n3, n6}, |

(REG bundle size)

| | |
|---|---|
| precoderGranularity | ENUMERATED {sameAsREG-bun |

dle, allContiguousRBs},

| | |
|---|---|
| interleaverSize | ENUMERATED {n2, n3, n6} |

(interleaver size)

| | |
|---|---|
| shiftIndex | INTEGER(0..maxNrofPhysicalResou |
| rceBlocks-1) | OPTIONAL |

```
        (interleaver shift)
        },
```

| | |
|---|---|
| nonInterleaved | NULL |

},

| | |
|---|---|
| tci-StatesPDCCH | SEQUENCE(SIZE (1..maxNrofTCI- |
| StatesPDCCH)) OF TCI-StateId | OPTIONAL, |

(QCL configuration information)

| | |
|---|---|
| tci-PresentInDCI | ENUMERATED {enabled} |
| | OPTIONAL, ... Need S |

}

In Table 8, tci-SIaIesPDCCH (simply referred to as transmission configuration indication (TCI) state) configuration information may include information of one or multiple SS/PBCH block indexes or channel state information reference signal (CSI-RS) indexes, which are quasi-co-located (OCLed) with a DMRS transmitted in a corresponding control resource set. Obviously, the example given above is not limiting.

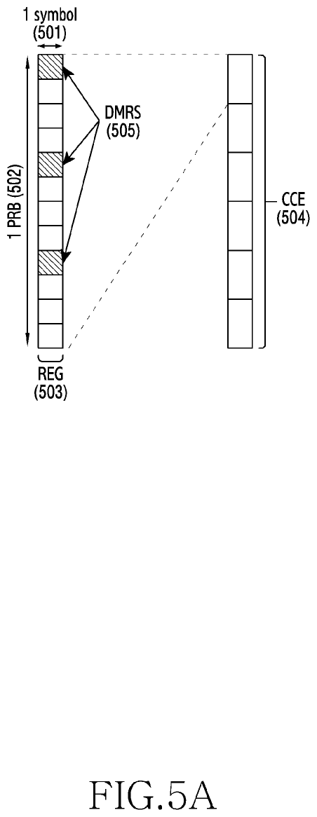

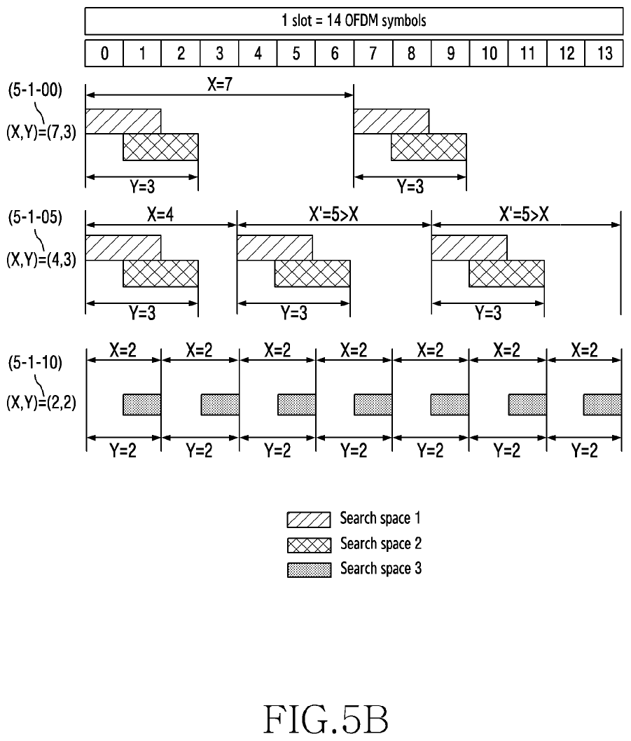

FIG. 5A illustrates an example of abasic unit of time and frequency resources constituting a downlink control channel available in a 5G system. According to FIG. 5A, the basic unit of time and frequency resources constituting a control channel may be referred to as a resource element group (REG) 503, and the REG 503 may be defined by one OFDM symbol 501 along the time axis and one physical resource block (PRB) 502, that is, 12 subcarriers, along the frequency axis. The base station may configure a downlink control channel allocation unit by concatenating the REGs 503.

Provided that the basic unit of downlink control channel allocation in 5G is a control channel element (CCE) 504 as illustrated in FIG. 5A, one CCE 504 may include multiple REGs 503. To describe the REG 503 illustrated in FIG. 5A, for example, the REG 503 may include 12 REs, and if one CCE 504 includes six REGs 503, one CCE 504 may then include 72 REs. A downlink control resource set, once configured, may include multiple CCEs 504, and a specific downlink control channel may be mapped to one or multiple CCEs 504 and then transmitted according to the aggregation level (AL) in the control resource set. The CCEs 504 in the control resource set are distinguished by numbers, and the numbers of CCEs 504 may be allocated according to a logical mapping scheme.

The basic unit of the downlink control channel illustrated in FIG. 5A, that is, the REG 503, may include both REs to which DCI is mapped, and an area to which a reference signal (DMRS 505) for decoding the same is mapped. As in FIG. 5A, three DRMSs 503 may be transmitted inside one REG 505. The number of CCEs necessary to transmit a PDCCH may be 1, 2, 4, 8, or 16 according to the aggregation level (AL), and different number of CCEs may be used to implement link adaption of the downlink control channel. For example, in the case of AL=L, one downlink control channel may be transmitted through L CCEs. The UE needs to detect a signal while being no information regarding the downlink control channel, and thus a search space indicating a set of CCEs has been defined for blind decoding. The search space is a set of downlink control channel candidates including CCEs which the UE needs to attempt to decode at a given AL, and since 1, 2, 4, 8, or 16 CCEs may constitute a bundle at various ALs, the UE may have multiple search spaces. A search space set may be defined as a set of search spaces at all configured aggregation levels.

Search spaces may be classified into common search spaces and UE-specific search spaces. A group of UEs or all UEs may search a common search space of the PDCCH in order to receive cell-common control information such as dynamic scheduling regarding system information or a paging message. For example, PDSCH scheduling allocation information for transmitting an SIB including a cell operator information or the like may be received by searching the common search space of the PDCCH. In the case of a common search space, a group of UEs or all UEs need to receive the PDCCH, and the common search space may thus be defined as a predetermined set of CCEs. Scheduling allocation information regarding a UE-specific PDSCH or PUSCH may be received by searching the UE-specific search space of the PDCCH. The UE-specific search space may be defined UE-specifically as a function of various system parameters and the identity of the UE.

In 5G, parameters for a search space regarding a PDCCH may be configured for the UE by the base station through upper layer signaling (for example, SIB, MIB, or RRC signaling). For example, the base station may provide the UE with configurations such as the number of PDCCH candidates at each aggregation level L, the monitoring cycle regarding the search space, the monitoring occasion with regard to each symbol in a slot regarding the search space, the search space type (common search space or UE-specific search space), a combination of an RNTI and a DCI format to be monitored in the corresponding search space, a control resource set index for monitoring the search space, and the like. For example, the following pieces of information may be included.

TABLE 9

| | |
|---|---|
| SearchSpace ::= | SEQUENCE { |

-- Identity of the search space. SearchSpaceId = 0 identifies the SearchSpace
configured via PBCH (MIB) or ServingCellConfigCommon.

| | |
|---|---|
| searchSpaceId | SearchSpaceId, |

(search space identity)

| | |
|---|---|
| controlResourceSetId | ControlResourceSetId, |

(control resource set identity)

| | |
|---|---|
| monitoringSlotPeriodicityAndOffset | CHOICE { |

(monitoring slot level periodicity)

| | |
|---|---|
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19) |

}

| | |
|---|---|
| | OPTIONAL, |
| duration (monitoringduration) | INTEGER (2..2559) |
| monitoringSymbolsWithinSlot | BIT STRING (SIZE (14)) |
| | OPTIONAL, |

(monitoring symbols within slot)

| | |
|---|---|
| nrofCandidates | SEQUENCE { |

(number of PDCCH candidates for each aggregation level)

| | |
|---|---|
| aggregationLevel1 | ENUMERATED {n0, n1, n2, n3, n4, |

n5, n6, n8},

| | |
|---|---|
| aggregationLevel2 | ENUMERATED {n0, n1, n2, n3, n4, |

n5, n6, n8},

| | |
|---|---|
| aggregationLevel4 | ENUMERATED {n0, n1, n2, n3, n4, |

n5, n6, n8},

| | |
|---|---|
| aggregationLevel8 | ENUMERATED {n0, n1, n2, n3, n4, |

n5, n6, n8},

| | |
|---|---|
| aggregationLevel16 | ENUMERATED {n0, n1, n2, n3, n4, |

n5, n6, n8}
},

| | |
|---|---|
| searchSpaceType | CHOICE { |

```
  (search space type)
      -- Configures this search space as common search space (CSS) and DCI formats
to monitor.
```

| | |
|---|---|
| common | SEQUENCE { |

```
  (common search space)
    }
```

| | |
|---|---|
| ue-Specific | SEQUENCE { |

```
  (UE-specific search space)
        -- Indicates whether the UE monitors in this USS for DCI formats 0-0 and 1-0 or
for formats 0-1 and 1-1.
```

| | |
|---|---|
| formats | ENUMERATED {formats0-0-And-1 |

-0, formats0-1-And-1-1},
...
}

According to configuration information, the base station may configure one or multiple search space sets for the UE. According to some embodiments, the base station may configure search space set 1 and search space set 2 for the UE, may configure DCI format A scrambled by an X-RNTI to be monitored in a common search space in search space set 1, and may configure DCI format B scrambled by a Y-RNTI to be monitored in a UE-specific search space in search space set 2.

According to configuration information, one or multiple search space sets may exist in a common search space or a UE-specific search space. For example, search space set #1 and search space set #2 may be configured as a common search space, and search space set #3 and search space set #4 may be configured as a UE-specific search space.

Combinations of DCI formats and RNTIs given below may be monitored in a common search space. Obviously, the examples given below are not limiting.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

Combinations of DCI formats and RNTIs given below may be monitored in a UE-specific search space. Obviously, the examples given below are not limiting.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

Enumerated RNTIs may follow the definition and usage given below.

Cell RNTI (C-RNTI): used to schedule a UE-specific PDSCH

Temporary cell RNTI (TC-RNTI): used to schedule a UE-specific PDSCH

Configured scheduling RNTI (CS-RNTI): used to schedule a semi-statically configured UE-specific PDSCH

Random access RNTI (RA-RNTI): used to schedule a PDSCH in a random access step

Paging RNTI (P-RNTI): used to schedule a PDSCH in which paging is transmitted
System information RNTI (SI-RNTI): used to schedule a PDSCH in which system information is transmitted

Interruption RNTI (INT-RNTI): used to indicate whether a PDSCH is punctured

Transmit power control for PUSCH RNTI (TPC-PUSCH-RNTI): used to indicate a power control command regarding a PUSCH

Transmit power control for PUCCH RNTI (TPC-PUCCH-RNTI): used to indicate a power control command regarding a PUCCH

Transmit power control for SRS RNTI (TPC-SRS-RNTI): used to indicate a power control command regarding an SRS

The DCI formats enumerated above may follow the definitions given below.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission is |
| | intended for the UE |
| 2_2 | Transmission of TPC commands for PUCCH and |
| | PUSCH |
| 2_3 | Transmission of a group of TPC commands for SRS |
| | transmissions by one or more UEs |

In a 5G system, the search space at aggregation level L in connection with CORESET p and search space set s may be expressed by Equation 1 below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i \qquad [ Equation 2 ]$$

L: aggregation level
n_{CI}: carrier index
   N_{CCE,p}: total number of CCEs existing in control resource set p

$${n}_{s , f}^{μ} :$$

slot index

$${M}_{s , max}^{( L )} :$$

number of PDCCH candidates at aggregation level L

$${m}_{s , {n}_{CI}} = 0 , ... , {M}_{s , max}^{( L )} \text{-1:}$$

PDCCH candidate index at aggregation level L
i=0, . . . , L−1

$${Y}_{p , {n}_{s , f}^{μ}} = ( {A}_{p} \cdot {Y}_{p , {n}_{s , {f}^{- 1}}^{μ}} ) mod D ,$$

Y_{p,-1}=n_{RNTI}≠0, Aₚ=39827 for pmod3=, A, =39829 for pmod3=1, Aₚ=39839 for pmod3=2, D=65537
n_{RNTI}: UE identity
The

$${Y}_{p , {n}_{s , f}^{μ}}$$

value may correspond to 0 in the case of a common search space.
The

$${Y}_{p , {n}_{s , f}^{μ}}$$

value may correspond to a value changed by the UE's identity (C-RNTI or ID configured for the UE by the base station) and the time index in the case of a UE-specific search space.

In 5G, multiple search space sets may be configured by different parameters (for example, parameters in Table 9), and the group of search space sets monitored by the UE at each timepoint may differ accordingly. For example, if search space set #1 is configured at by X-slot cycle, if search space set #2 is configured at by Y-slot cycle, and if X and Y are different, the UE may monitor search space set #1 and search space set #2 both in a specific slot, and may monitor one of search space set #1 and search space set #2 both in another specific slot.

### [PDCCH: Span]

The UE may perform UE capability reporting at each subcarrier spacing with regard to a case in which the same has multiple PDCCH monitoring occasions inside a slot, and the concept “span” may be used in this regard. A span refers to consecutive symbols configured such that the UE can monitor the PDCCH inside the slot, and each PDCCH monitoring occasion is inside one span. A span may be described by (X,Y) wherein X refers to the minimum number of symbols by which the first symbols of two consecutive spans are spaced apart from each other, and Y refers to the number of consecutive symbols configured such that the PDCCH can be monitored inside one span. Here, a UE may monitor a PDCCH in a range of Y symbols from the first symbol of the span within the span.

FIG. 5B illustrates, in terms of spans, a case in which a UE may have multiple PDCCH monitoring occasions inside a slot in a wireless communication system. Possible spans are (X,Y)=(7,3), (4,3), (2,2), and the three cases may be indicated by “5-1-00”, “5-1-05”, and “5-1-10” in FIG. 5B, respectively. As an example, “5-1-00” may describe a case in which there are two spans described by (7,4) inside a slot. The spacing between the first symbols of two spans is described as X=7, a PDCCH monitoring occasion may exist inside a total of Y=3 symbols from the first symbol of each span, and search spaces 1 and 2 may exist inside Y=3 symbols, respectively. As another example, “5-1-05” may describe a case in which there are a total of three spans described by (4,3) inside a slot, and the second and third spans are spaced apart by X′=5 symbols which are larger than X=4.

### [PDCCH: UE Capability Report]

The slot location at which the above-described common search space and the UE-specific search space are positioned is indicated by parameter “monitoringSymbolsWitninSlot” in Table 11-1, and the symbol location inside the slot is indicated as a bitmap through parameter “monitoringSymbolsWithinSlot” in Table 9. Meanwhile, the symbol location inside a slot at which the UE can monitor search spaces may be reported to the base station through the following UE capabilities.
UE capability 1 (hereinafter interchangeably used with FG 3-1) has the following meaning: if there is one monitoring occasion (MO) regarding type 1 and type 3 common search spaces or UE-specific search spaces inside a slot, as in the following Table 11-1, the UE can monitor the corresponding MO when the corresponding MO is located inside the first three symbols inside the slot. UE capability 1 is a mandatory capability which is to be supported by all UEs that support NR, and whether or not UE capability 1 is supported may not be explicitly reported to the base station. Obviously, the example given above is not limiting.

TABLE 11-1

| | | | Field name |
|---|---|---|---|
| | Feature | | in TS 38.331 |
| Index | group | Components | [2] |
| 3-1 | Basic DL | 1) One configured CORESET per BWP per cell | n/a |
| | control | in addition to CORESET0 | |
| | channel | CORESET resource allocation of 6RB bit-map | |
| | | and duration of 1-3 OFDM symbols for FR1 | |
| | | For type 1 CSS without dedicated RRC | |
| | | configuration and for type 0, 0A, and 2 CSSs, | |
| | | CORESET resource allocation of 6RB bit-map | |
| | | and duration 1-3 OFDM symbols for FR2 | |
| | | For type 1 CSS with dedicated RRC | |
| | | configuration and for type 3 CSS, UE specific | |
| | | SS, CORESET resource allocation of 6RB bit- | |
| | | map and duration 1-2 OFDM symbols for FR2 | |
| | | REG-bundle sizes of 2/3 RBs or 6 RBs | |
| | | Interleaved and non-interleaved CCE-to-REG | |
| | | mapping | |
| | | Precoder-granularity of REG-bundle size | |
| | | PDCCH DMRS scrambling determination | |
| | | TCI state(s) for a CORESET configuration | |
| | | 2) CSS and UE-SS configurations for unicast | |
| | | PDCCH transmission per BWP per cell | |
| | | PDCCH aggregation levels 1, 2, 4, 8, 16 | |
| | | UP to 3 search space sets in a slot for a | |
| | | scheduled SCell per BWP | |
| | | This search space limit is before applying all | |
| | | dropping rules. | |
| | | For type 1 CSS with dedicated RRC | |
| | | configuration, type 3 CSS, and UE-SS, the | |
| | | monitoring occasion is within the first 3 OFDM | |
| | | symbols of a slot | |
| | | For type 1 CSS without dedicated RRC | |
| | | configuration and for type 0, 0A, and 2 CSS, the | |
| | | monitoring occasion can be any OFDM | |
| | | symbol(s) of a slot, with the monitoring | |
| | | occasions for any of Type 1- CSS without | |
| | | dedicated RRC configuration, or Types 0, 0A, or | |
| | | 2 CSS configurations within a single span of | |
| | | three consecutive OFDM symbols within a slot | |
| | | 3) Monitoring DCI formats 0_0, 1_0, 0_1, 1_1 | |
| | | 4) Number of PDCCH blind decodes per slot | |
| | | with a given SCS follows Case 1-1 table | |
| | | 5) Processing one unicast DCI scheduling DL | |
| | | and one unicast DCI scheduling UL per slot per | |
| | | scheduled CC for FDD | |
| | | 6) Processing one unicast DCI scheduling DL | |
| | | and 2 unicast DCI scheduling UL per slot per | |
| | | scheduled CC for TDD | |

UE capability 2 (hereinafter interchangeably used with FG 3-2) has the following meaning: if there is one monitoring occasion (MO) regarding a common search space or a UE-specific search space inside a slot, as in the following Table 1-2, the UE can monitor the corresponding MO no matter what of the start symbol location of the corresponding MO may be. UE capability 2 is optionally supported by the UE, and whether or not UE capability 2 is supported may be explicitly reported to the base station. Obviously, the examples given below are not limiting.

TABLE 11-2

| | Feature | | |
|---|---|---|---|
| Index | group | Components | Field name in TS 38.331 [2] |
| 3-2 | PDCCH | For a given UE, all search | pdcchMonitoringSingleOccasion |
| | monitoring | space configurations are within | |
| | on any span | the same span of 3 consecutive | |
| | of up to 3 | OFDM symbols in the slot | |
| | consecutive | | |
| | OFDM | | |
| | symbols of | | |
| | a slot | | |

UE capability 3 (hereinafter interchangeably used with FG 3-5, 3-5a, or 3-5b) has the following meaning: if there are multiple monitoring occasions (MO) regarding a common search space or a UE-specific search space inside a slot, as in the following Table 11-3, the pattern of the MO which the UE can monitor is indicated. The above-mentioned pattern includes the spacing X between start symbols of different MOs, and the maximum symbol length Y regarding one MO. The combination of (X,Y) supported by the UE may be one or multiple among {(2,2), (4,3), (7,3)}. UE capability 3 is optionally supported by the UE, and whether or not UE capability 3 is supported and the above-mentioned combination of (X,Y) are explicitly reported to the base station. Obviously, the examples given below are not limiting.

TABLE 11-3

| | | | Field name in TS 38.331 |
|---|---|---|---|
| Index | Feature group | Components | [2] |
| 3-5 | For type 1 | For type 1 CSS with dedicated | pdcch- |
| | CSS with | RRC configuration, type 3 CSS, | MonitoringAnyOccasions |
| | dedicated | and UE-SS, monitoring occasion | {3-5. withoutDCI-Gap |
| | RRC | can be any OFDM symbol(s) of a | 3-5a. withDCI-Gap} |
| | configuration, | slot for Case 2 | |
| | type 3 CSS, | | |
| | and UE-SS, | | |
| | monitoring | | |
| | occasion can | | |
| | be any OFDM | | |
| | symbol(s) of a | | |
| | slot for Case 2 | | |
| 3-5a | For type 1 | For type 1 CSS with dedicated | |
| | CSS with | RRC configuration, type 3 CSS | |
| | dedicated | and UE-SS, monitoring occasion | |
| | RRC | can be any OFDM symbol(s) of a | |
| | configuration, | slot for Case 2, with minimum | |
| | type 3 CSS, | time separation (including the | |
| | and UE-SS, | cross-slot boundary case) between | |
| | monitoring | two DL unicast DCIs, between two | |
| | occasion can | UL unicast DCIs, or between a DL | |
| | be any OFDM | and an UL unicast DCI in different | |
| | symbol(s) of a | monitoring occasions where at | |
| | slot for Case 2 | least one of them is not the | |
| | with a DCI | monitoring occasions of FG-3-1, | |
| | gap | for a same UE as | |
| | | 2OFDM symbols for | |
| | | 15 kHz | |
| | | 4OFDM symbols for | |
| | | 30 kHz | |
| | | 7OFDM symbols for | |
| | | 60 kHz with NCP | |
| | | 11OFDM symbols for | |
| | | 120 kHz | |
| | | Up to one unicast DL DCI and up | |
| | | to one unicast UL DCI in a | |
| | | monitoring occasion except for the | |
| | | monitoring occasions of FG 3-1. | |
| | | In addition for TDD the minimum | |
| | | separation between the first two | |
| | | UL unicast DCIs within the first 3 | |
| | | OFDM symbols of a slot can be | |
| | | zero OFDM symbols. | |
| 3-5b | All PDCCH | PDCCH monitoring occasions of | |
| | monitoring | FG-3-1, plus additional PDCCH | |
| | occasion can | monitoring occasion(s) can be any | |
| | be any OFDM | OFDM symbol(s) of a slot for | |
| | symbol(s) of a | Case 2, and for any two PDCCH | |
| | slot for Case 2 | monitoring occasions belonging to | |
| | with a span | different spans, where at least one | |
| | gap | of them is not the monitoring | |
| | | occasions of FG-3-1, in same or | |
| | | different search spaces, there is a | |
| | | minimum time separation of X | |
| | | OFDM symbols (including the | |
| | | cross-slot boundary case) between | |
| | | the start of two spans, where each | |
| | | span is of length up to Y | |
| | | consecutive OFDM symbols of a | |
| | | slot. Spans do not overlap. Every | |
| | | span is contained in a single slot. | |
| | | The same span pattern repeats in | |
| | | every slot. The separation between | |
| | | consecutive spans within and | |
| | | across slots may be unequal but | |
| | | the same (X, Y) limit must be | |
| | | satisfied by all spans. Every | |
| | | monitoring occasion is fully | |
| | | contained in one span. In order to | |
| | | determine a suitable span pattern, | |
| | | first a bitmap b(l), 0 <= l <= 13 is | |
| | | generated, where b(l) = 1 if symbol | |
| | | 1 of any slot is part of a monitoring | |
| | | occasion, b(l) = 0 otherwise. The | |
| | | first span in the span pattern | |
| | | begins at the smallest l for which | |
| | | b(l) = 1. The next span in the span | |
| | | pattern begins at the smallest l not | |
| | | included in the previous span(s) | |
| | | for which b(l) = 1. The span | |
| | | duration is max {maximum value | |
| | | of all CORESET durations, | |
| | | minimum value of Y in the UE | |
| | | reported candidate value} except | |
| | | possibly the last span in a slot | |
| | | which can be of shorter duration. A | |
| | | particular PDCCH monitoring | |
| | | configuration meets the UE | |
| | | capability limitation if the span | |
| | | arrangement satisfies the gap | |
| | | separation for at least one (X, Y) | |
| | | in the UE reported candidate value | |
| | | set in every slot, including cross | |
| | | slot boundary. | |
| | | For the set of monitoring | |
| | | occasions which are within the | |
| | | same span: | |
| | | Processing one unicast | |
| | | DCI scheduling DL and one | |
| | | unicast DCI scheduling UL per | |
| | | scheduled CC across this set of | |
| | | monitoring occasions for FDD | |
| | | Processing one unicast | |
| | | DCI scheduling DL and two | |
| | | unicast DCI scheduling UL per | |
| | | scheduled CC across this set of | |
| | | monitoring occasions for TDD | |
| | | Processing two unicast | |
| | | DCI scheduling DL and one | |
| | | unicast DCI scheduling UL per | |
| | | scheduled CC across this set of | |
| | | monitoring occasions for TDD | |
| | | The number of different start | |
| | | symbol indices of spans for all | |
| | | PDCCH monitoring occasions per | |
| | | slot, including PDCCH monitoring | |
| | | occasions of FG-3-1, is no more | |
| | | than floor(14/X) (X is minimum | |
| | | among values reported by UE). | |
| | | The number of different start | |
| | | symbol indices of PDCCH | |
| | | monitoring occasions per slot | |
| | | including PDCCH monitoring | |
| | | occasions of FG-3-1, is no more | |
| | | than 7. | |
| | | The number of different start | |
| | | symbol indices of PDCCH | |
| | | monitoring occasions per half-slot | |
| | | including PDCCH monitoring | |
| | | occasions of FG-3-1 is no more | |
| | | than 4 in SCell. | |

The UE may report whether the above-described capability 2 and/or capability 3 are supported and relevant parameters to the base station. The base station may allocate time-domain resources to the common search space and the UE-specific search space, based on the UE capability report. During the resource allocation, the base station may ensure that the MO is not positioned not at a location at which the UE cannot monitor the same.

### [PDCCH: BD/CCE Limit]

If there are multiple search space sets configured for a UE, the following conditions may be considered in connection with a method for determining a search space set to be monitored by the UE.

If the value of “monitoringCapabilityConfig-r16” (upper layer signaling) has been configured to be “r15monitoringcapability” for the UE, the UE defines maximum values regarding the number of PDCCH candidates that can be monitored and the number of CCEs constituting the entire search space (as used herein, the entire search space refers to the entire CCE set corresponding to a union domain of multiple search space sets) with regard to each slot. If the value of “monitoringCapabilityConfig-r16” has been configured to be “r16monitoringcapability”, the UE defines maximum values regarding the number of PDCCH candidates that can be monitored and the number of CCEs constituting the entire search space (as used herein, the entire search space refers to the entire CCE set corresponding to a union domain of multiple search space sets) with regard to each span.

### [Condition 1: Maximum Number of PDCCH Candidates Limited]

According to the above-mentioned upper layer signaling configuration value, the maximum number Mu of PDCCH candidates that the UE can monitor may follow Table 12-1 given below if the same is defined with reference to a slot in a cell configured to have a subcarrier spacing of 1542 kHz, and may follow Table 12-2 given below if the same is defined with reference to a span.

TABLE 12-1

| | Maximum number of PDCCH candidates |
|---|---|
| μ | per slot and per serving cell (M^{μ}) |
| 0 | 44 |
| 1 | 36 |
| 2 | 22 |
| 3 | 20 |

TABLE 12-2

| | Maximum number M^{μ} of monitored PDCCH | | |
|---|---|---|---|
| | candidates per span for combination | | |
| | (X, Y) and per serving cell | | |
| μ | (2, 2) | (4, 3) | (7, 3) |
| 0 | 14 | 28 | 44 |
| 1 | 12 | 24 | 36 |

### [Condition 2: Maximum Number of CCEs Limited]

According to the above-mentioned upper layer signaling configuration value, the maximumnumber Cμ of CCEs constituting the entire search space (as used herein, the entire search space refers to the entire CCE set corresponding to a union domain of multiple search space sets) may follow Table 12-3 given below if the same is defined with reference to a slot in a cell configured to have a subcarrier spacing of 15~2 μkHz, and may follow Table 12-4 given below if the same is defined with reference to a span.

TABLE 12-3

| | Maximum number of non-overlapped CCEs |
|---|---|
| μ | per slot and per serving cell (C^{μ}) |
| 0 | 56 |
| 1 | 56 |
| 2 | 48 |
| 3 | 32 |

TABLE 12-4

| | Maximum number C^{μ} of non-overlapped CCEs per span | | |
|---|---|---|---|
| | for combination (X, Y) and per serving cell | | |
| μ | (2, 2) | (4, 3) | (7, 3) |
| 0 | 18 | 36 | 56 |
| 1 | 18 | 36 | 56 |

For the sake of descriptive convenience, a situation satisfying both conditions 1 and 2 above at a specific timepoint may be defined as “condition A”. Therefore, the description that condition A is not satisfied may mean that at least one of conditions 1 and 2 above is not satisfied.

### [PDCCH: Overbooking]

According to the configuration of search space sets of the base station, a case in which condition A is not satisfied may occur at a specific timepoint. If condition A is not satisfied at a specific timepoint, the UE may select and monitor only some of search space sets configured to satisfy condition A at the corresponding timepoint, and the base station may transmit a PDCCH to the selected search space set.

A method for selecting some search spaces from all configured search space sets may follow methods given below.

If condition A regarding a PDCCH fails to be satisfied at a specific timepoint (slot), the UE (or the base station) may preferentially select a search space set having a search space type configured as a common search space, among search space sets existing at the corresponding timepoint, over a search space set configured as a UE-specific search space.

If all search space sets configured as common search spaces have been selected (that is, if condition A is satisfied even after all search spaces configured as common search spaces have been selected), the UE (or the bae station) may select search space sets configured as UE-specific search spaces. If there are multiple search space sets configured as UE-specific search spaces, a search space set having a lower search space set index may have a higher priority. UE-specific search space sets may be selected as long as condition A is satisfied, in consideration of the priority.

[QCL, TCI state]

In a wireless communication system, one or more different antenna ports (which may be replaced with one or more channels, signals, and combinations thereof, but in the following description of the disclosure, will be referred to as different antenna ports, as a whole, for the sake of convenience) may be associated with each other by a quasi-co-location (QCL) configuration as in Table 10 below. A TCI state is for announcing the QCL relation between a PDCCH (or a PDCCH DRMS) and another RS or channel, and the description that a reference antenna port A (reference RS #A) and another target antenna port B (target RS #B) are QCLed with each other means that the UE is allowed to apply some or all of large-scale channel parameters estimated in the antenna port A to channel measurement form the antenna port B. The QCL needs to be associated with different parameters according to the situation such as 1) time tracking influenced by average delay and delay spread, 2) frequency tracking influenced by Doppler shift and Doppler spread, 3) radio resource management (RRM) influenced by average gain, or 4) beam management (BM) influenced by a spatial parameter. Accordingly, four types of QCL relations are supported in NR as in Table 10 below.

TABLE 13

| QCL type | Large-scale characteristics |
|---|---|
| A | Doppler shift, Doppler spread, average delay, delay spread |
| B | Doppler shift, Doppler spread |
| C | Doppler shift, average delay |
| D | Spatial Rx parameter |

The spatial RX parameter may refer to some or all of various parameters as a whole, such as angle of arrival (AoA), power angular spectrum (PAS) of AoA, angle of departure (AoD), PAS of AoD, transmit/receive channel correlation, transmit/receive beamforming, and spatial channel correlation.

The QCL relations may be configured for the UE through RRC parameter TCI-state and QCL-info as in Table 14 below. Referring to Table 14, the base station may configure one or more TCI states for the UE, thereby informing of a maximum of two kinds of QCL relations (qcl-Type1, qcl-Type2) regarding the RS that refers to the ID of the TCI state, that is, the target RS. Each piece of QCL information (QCL-Info) that each TCI state may include the serving cell index and the BWP index of the reference RS indicated by the corresponding QCL information, the type and ID of the reference BS, and a QCL type as in Table 13 above. Obviously, the example given above is not limiting.

TABLE 14

| | |
|---|---|
| TCI-State ::= | SEQUENCE { |
| tci-StateId | TCI-StateId, |

(ID of corresponding TCI state)

| | |
|---|---|
| qcl-Type1 | QCL-Info, |

(QCL information of first refernece RS of RS (target RS) referring to corresponding
TCI state ID)

| | | |
|---|---|---|
| qcl-Type2 | QCL-Info | OPTIONAL, |

```
  -- Need R
  (QCL information of second refernece RS of RS (target RS) referring to
corresponding TCI state ID)
  ...
}
```

| QCL-Info ::= | SEQUENCE { | |
|---|---|---|
| cell | ServCellIndex | OPTIONAL, -- |

Need R
(serving cell index of reference RS indicated by corresponding QCL information)

| | | |
|---|---|---|
| bwp-Id | BWP-Id | OPTIONAL, - |

- Cond CSI-RS-Indicated
(BWP index of reference RS indicated by corresponding QCL information)

| | |
|---|---|
| referenceSignal | CHOICE { |
| csi-rs | NZP-CSI-RS-ResourceId, |
| ssb | SSB-Index |

```
    (one of CSI-RS ID or SSB ID indicated by corresponding QCL information)
  },
```

| | |
|---|---|
| qcl-Type | ENUMERATED {typeA, typeB, typeC, |

typeD},
...
}

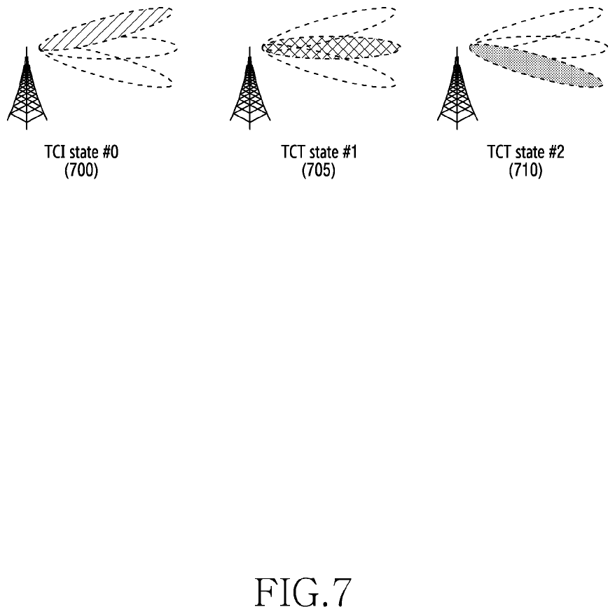

FIG. 7 illustrates an example of base station beam allocation according to TCI state configuration. Referring to FIG. 7, the base station may transfer information regarding N different beams to the UE through N different TCI states. For example, in the case of N=3 as in FIG. 7, the base station may configure qcl-Type2 parameters included in three TCI states 700, 705, and 710 in QCL type D while being associated with CSI-RSs or SSBs corresponding to different beams, thereby notifying that antenna ports referring to the different TCI states 700, 705, and 710 are associated with different spatial Rx parameters (that is, different beams).

Tables 15-1 to 15-5 below enumerate valid TCI state configurations according to the target antenna port type.

Table 15-1 enumerates valid TCI state configurations when the target antenna port is a CSI-RS for tracking (TRS) The TRS refers to an NZP CSI-RS which has no repetition parameter configured therefor, and trs-Info of which is configured as “true”, among CRI-RSs. In Table 15-1, configuration no. 3 may be used for an aperiodic TRS. Obviously, the examples given below are not limiting.

TABLE 15-1
Valid TCI state configurations when the target antenna port is
a CSI-RS for tracking (TRS)

| Valid TCI | | | DL RS 2 | qcl-Type2 |
|---|---|---|---|---|
| state | | | (If | (If |
| Configuration | DL RS 1 | qcl-Type1 | configured) | configured) |
| 1 | SSB | QCL-TypeC | SSB | QCL-TypeD |
| 2 | SSB | QCL-TypeC | CSI-RS (BM) | QCL-TypeD |
| 3 | TRS | QCL-TypeA | TRS (same as | QCL-TypeD |
| | (periodic) | | DL RS 1) | |

Table 15-2 enumerates valid TCI state configurations when the target antenna port is a CSI-RS for CSI. The CSI-RS for CSI may refer to an NZP CSI-RS which has no parameter indicating repetition (for example, repetition parameter) configured therefor, and trs-Info of which is not configured as “true”, among CR-RSs. Obviously, the example given below is not limiting.

TABLE 15-2
Valid TCI state configurations when the target antenna port is a
CSI-RS for CSI

| Valid TCI | | | | |
|---|---|---|---|---|
| state | | | DL RS 2 | qcl-Type2 |
| Configuration | DL RS 1 | qcl-Type1 | (If configured) | (If configured) |
| 1 | TRS | QCL-TypeA | SSB | QCL-TypeD |
| 2 | TRS | QCL-TypeA | CSI-RS for BM | QCL-TypeD |
| 3 | TRS | QCL-TypeA | TRS (same as DL | QCL-TypeD |
| | | | RS 1) | |
| 4 | TRS | QCL-TypeB | | |

TABLE 15-3
Valid TCI state configurations when the target antenna port is a
CSI-RS for BM (for L1 RSRP reporting)

| Valid TCI | | | | |
|---|---|---|---|---|
| state | | | DL RS 2 | qcl-Type2 |
| Configuration | DL RS 1 | qcl-Type1 | (If configured) | (If configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | SS/PBCH | QCL-TypeC | SS/PBCH Block | QCL-TypeD |
| | Block | | | |

Table 15-4 enumerates valid TCI state configurations when the target antenna port is a PDCCH DMRS. Obviously, the example given below is not limiting.

TABLE 15-4
Valid TCI state configurations when the target
antenna port is a PDCCH DMRS

| Valid TCI | | | | |
|---|---|---|---|---|
| state | | | DL RS 2 | qcl-Type2 |
| Configuration | DL RS 1 | qcl-Type1 | (If configured) | (If configured) |
| 1 | TRS | QCL-TypeA | TRS (same as DL | QCL-TypeD |
| | | | RS 1) | |
| 2 | TRS | QCL-TypeA | CSI-RS (BM) | QCL-TypeD |
| 3 | CSI-RS | QCL-TypeA | CSI-RS (same as | QCL-TypeD |
| | (CSI) | | DL RS 1) | |

Table 15-5 enumerates valid TCI state configurations when the target antenna port is a PDSCH DMRS. Obviously, the example given below is not limiting.

TABLE 15-5
Valid TCI state configurations when the target antenna port is a
PDSCH DMRS

| Valid TCI | | | | |
|---|---|---|---|---|
| state | | | DL RS 2 | qcl-Type2 |
| Configuration | DL RS 1 | qcl-Type1 | (If configured) | (If configured) |
| 1 | TRS | QCL-TypeA | TRS | QCL-TypeD |
| 2 | TRS | QCL-TypeA | CSI-RS (BM) | QCL-TypeD |
| 3 | CSI-RS | QCL-TypeA | CSI-RS (CSI) | QCL-TypeD |
| | (CSI) | | | |

According to a representative QCL configuration method based on Tables 15-1 to 15-5 above, the target antenna port and reference antenna port for each step are configured and operated such as “SSB”->“TRS”->“CSI-RS for CSI, or CSI-RS for BM, or PDCCH DMRS, or PDSCH DMRS”. Accordingly, it may be possible to help the UE's receiving operation by associating statistical characteristics that can be measured from the SSB and TRS with respective antenna ports.

### [PDCCH: Regarding TCI State]

Specific TCI state combinations applicable to a PDCCH DMRS antenna port may be given in Table 16 below. The fourth row in Table 16 corresponds to a combination assumed by the UE before RRC configuration, and no configuration is possible after the RRC.

TABLE 16

| Valid TCI | | | | |
|---|---|---|---|---|
| state | | | DL RS 2 | qcl-Type2 |
| Configuration | DL RS 1 | qcl-Type1 | (if configured) | (if configured) |
| 1 | TRS | QCL-TypeA | TRS | QCL-TypeD |
| 2 | TRS | QCL-TypeA | CSI-RS (BM) | QCL-TypeD |
| 3 | CSI-RS (CSI) | QCL-TypeA | | |
| 4 | SS/PBCH | QCL-TypeA | SS/PBCH Block | QCL-TypeD |
| | Block | | | |

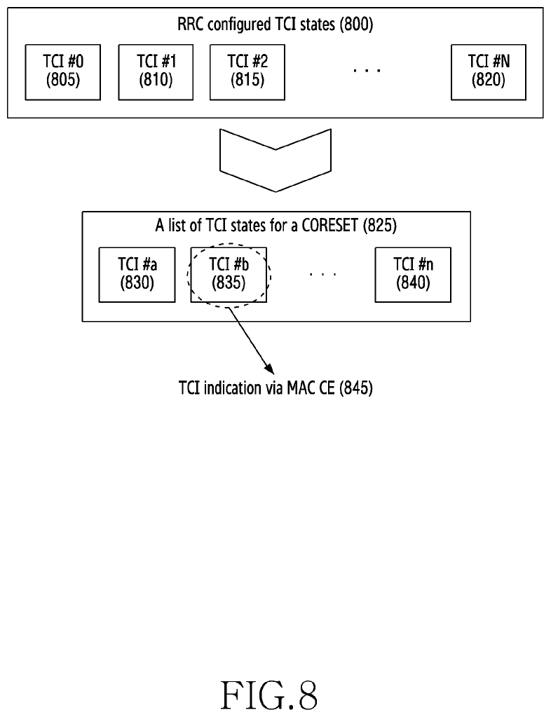

In NR, a hierarchical signaling method as illustrated in FIG. 8 is supported for dynamic allocation regarding a PDCCH beam. Referring to FIG. 8, the base station may configure N TCI states 805, 810, . . . , 820 for the UE through RRC signaling 800, and may configure some of the states as TCI states for a CORESET (825). The base station may then indicate one of the TCI states 830, 835, and 840 for the CORESET to the UE through MAC CE signaling (845). The UE may then receive a PDCCH, based on beam information included in the TCI state indicated by the MAC CE signaling.

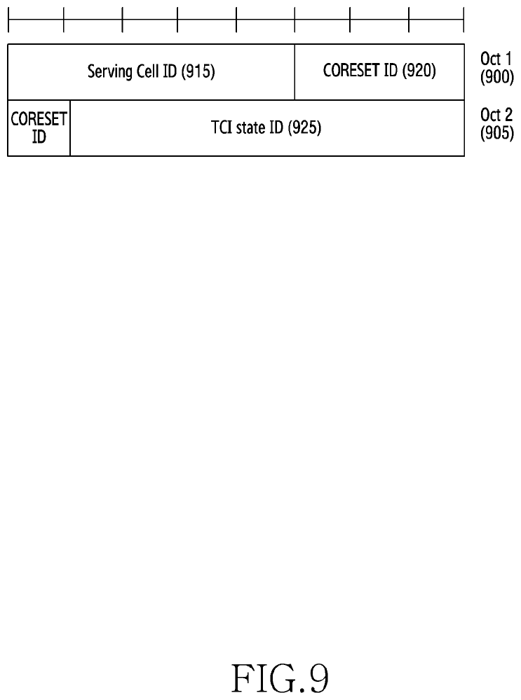

FIG. 9 illustrates a TCI indication MAC CE signaling structure for the PDCCH DMRS. Referring to FIG. 9, the TCI indication MAC CE signaling for the PDCCH DMRS may be configured by 2 bytes (16 bits), and include a 5-bit serving cell ID 915, a 4-bit CORESET ID 920, and a 7-bit TCI state ID 925.

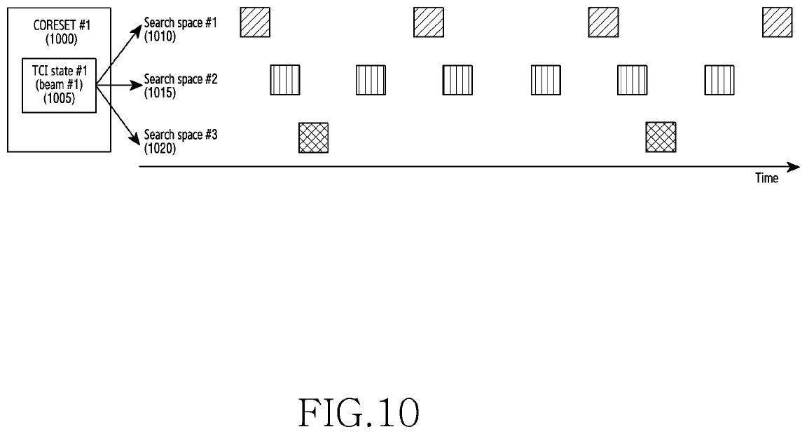

FIG. 10 illustrates an example of beam configuration with regard to a control resource set (CORESET) and a search space according to the above description. Referring to FIG. 10, the base station may indicate one of TCI state lists included in CORESET 1000 configuration through MAC CE signaling (1005). Until a different TCI state is indicated for the corresponding CORESET through different MAC CE signaling, the UE may consider that identical QCL information (beam #1) 1005 is all applied to one or more search spaces 1010, 1015, and 1020 connected to the CORESET. The above-described PDCCH beam allocation method may have a problem in that it is difficult to indicate a beam change faster than MAC CE signaling delay, and the same beam is unilaterally applied to each CORESET regardless of search space characteristics, thereby making flexible PDCCH beam operation difficult. In the following embodiments of the disclosure, more flexible PDCCH beam configuration and operation methods will be provided. Although multiple distinctive examples will be provided for convenience of description of embodiments of the disclosure, they are not mutually exclusive, and can be combined and applied appropriately for each situation.

The base station may configure one or multiple TCI states for the UE with regard to a specific control resource set, and may activate one of the configured TCI states through a MAC CE activation command. For example, if {TCI state #0, TCI state #1, TCI state #2} are configured as TCI states for control resource set #1, the base station may transmit an activation command to the UE through a MAC CE such that TCI state #0 is assumed as the TCI state regarding control resource set #1. Based on the activation command regarding the TCI state received through the MAC CE, the UE may correctly receive the DMRS of the corresponding CORESET, based on QCL information in the activated TCI state.

With regard to a control resource set having a configured index of 0 (CORESET #0), if the UE has failed to receive a MAC CE activation command regarding the TCI state of CORESET #0, the UE may assume that the DMRS transmitted in CORESET #0 has been QCL-ed with a SS/PBCH block identified in the initial access process, or in a non-contention-based random access process not triggered by a PDCCH command.

With regard to a control resource set having a configured index value other than 0 (CORESET #X), if the UE has no TCI state configured regarding CORESET #X, or if the UE has one or more TCI states configured therefor but has failed to receive a MAC CE activation command for activating one thereof, the UE may assume that the DMRS transmitted in CORESET #X has been QCL-ed with a SS/PBCH block identified in the initial access process.

### [PDCCH: Regarding QCL Prioritization Rule]

Hereinafter, operations for determining QCL priority regarding a PDCCH will be described in detail.

If multiple control resource sets which operate according to carrier aggregation inside a single cell or band and which exist inside a single or multiple in-cell activated bandwidth parts overlap temporally while having identical or different QCL-TypeD characteristics in a specific PDCCH monitoring occasion, the UE may select a specific control resource set according to a QCL priority determining operation and may monitor control resource sets having the same QCL-TypeD characteristics as the corresponding control resource set. That is, if multiple control resource sets overlap temporally, only one QCL-TypeD characteristic can be received. The QCL priority may be determined by the following criteria.
Criterion 1: A control resource set connected to a common search space having the lowest index inside a cell corresponding to the lowest index among cells including a common search space
Criterion 2: A control resource set connected to a UE-specific search space having the lowest index inside a cell corresponding to the lowest index among cells including a UE-specific search space

As described above, if one criterion among the criteria is not satisfied, the next criterion may be applied. For example, if control resource sets overlap temporally in a specific PDCCH monitoring occasion, and if all control resource sets are not connected to a common search space but connected to a UE-specific search space (for example, if criterion 1 is not satisfied), the UE may omit application of criterion 1 and apply criterion 2. Obviously, the example given above is not limiting.

If selecting control resource set according to the above-mentioned criteria, the UE may additionally consider the two aspects with regard to QCL information configured for the control resource set. Firstly, if control resource set 1 has CSI-RS 1 as a reference signal having a relation of QCL-TypeD, if this CSI-RS 1 has a relation of QCL-TypeD with reference signal SSB 1, and if another control resource set 2 has a relation of QCL-TypeD with reference signal SSB 1, the UE may consider that the two control resource sets 1 and 2 have different QCL-TypeD characteristics. Secondly, if control resource set 1 has CSI-RS 1 configured for cell 1 as a reference signal having a relation of QCL-TypeD, if this CSI-RS 1 has a relation of QCL-TypeD with reference signal SSB 1, if control resource set 2 has a relation of QCL-TypeD with reference signal CSI-RS 2 configured for cell 2, and if this CSI-RS 2 has a relation of QCL-TypeD with the same reference signal SSB 1, the UE may consider that the two control resource sets have the same QCL-TypeD characteristics.

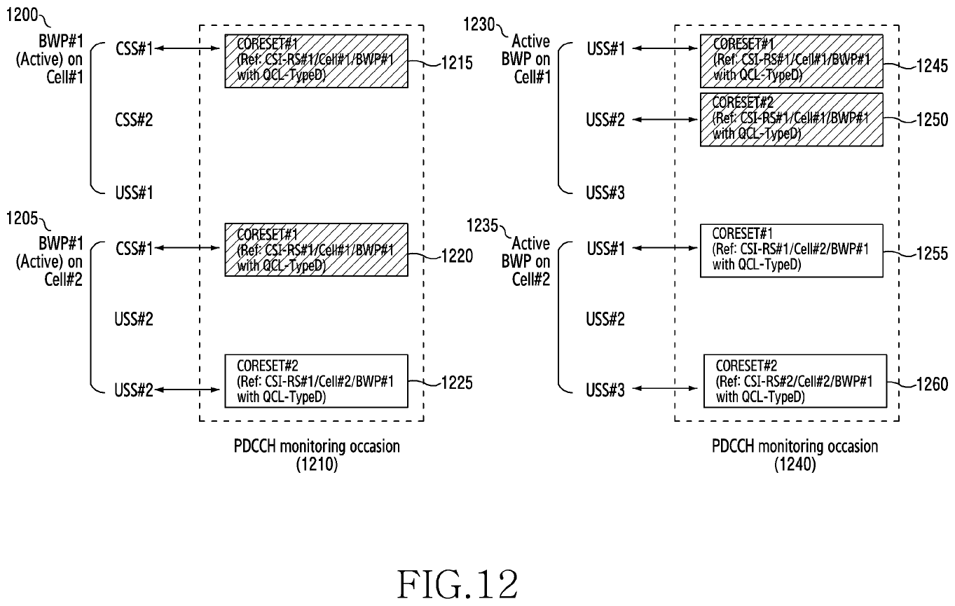

FIG. 12 illustrates a method in which, upon receiving a downlink control channel, a UE selects a receivable control resource set in consideration of priority in a wireless communication system according to an embodiment of the disclosure. As an example, the UE may be configured to receive multiple control resource sets overlapping temporally in a specific PDCCH monitoring occasion 1210, and such multiple control resource sets may be connected to a common search space or a UE-specific search space with regard to multiple cells. In the corresponding PDCCH monitoring occasion, control resource set no. 1 1200 connected to common search space no. 1 may exist in bandwidth part no. 1 1215 of cell no. 1, and control resource set no. 1 1205 connected to common search space no. 1 and control resource set no. 2 1220 connected to UE-specific search space no. 2 may exist in bandwidth part no. 1 1225 of cell no. 2. The control resource sets 1215 and 1220 may have a relation of QCL-TypeD with CSI-RS resource no. 1 configured in bandwidth part no. 1 of cell no. 1, and the control resource set 1225 may have a relation of QCL-TypeD with CSI-RS resource no. 1 configured in bandwidth part no. 1 of cell no. 2. If criterion 1 is applied to the corresponding PDCCH monitoring occasion 1210, all other control resource sets having the same reference signal of QCL-TypeD as control resource set no. 1 1215 may be received. Therefore, the UE may receive the control resource sets 1210 and 1215 in the corresponding PDCCH monitoring occasion 1220.

As another example, the UE may be configured to receive multiple control resource sets overlapping temporally in a specific PDCCH monitoring occasion 1240, and such multiple control resource sets may be connected to a common search space or a UE-specific search space with regard to multiple cells. In the corresponding PDCCH monitoring occasion, control resource set no. 1 1230 connected to UE-specific search space no. 1 and control resource set no. 2 1245 connected to UE-specific search space no. 2 may exist in bandwidth part no. 1 1250 of cell no. 1, and control resource set no. 1 1235 connected to UE-specific search space no. 1 and control resource set no. 2 1255 connected to UE-specific search space no. 3 may exist in bandwidth part no. 1 1260 of cell no. 2. The control resource sets 1245 and 1250 may have a relation of QCL-TypeD with CSI-RS resource no. 1 configured in bandwidth part no. 1 of cell no. 1, the control resource set 1255 may have a relation of QCL-TypeD with CSI-RS resource no. 1 configured in bandwidth part no. 1 of cell no. 2, and the control resource set 1260 may have a relation of QCL-TypeD with CSI-RS resource no. 2 configured in bandwidth part no. 1 of cell no. 2. If criterion 1 is applied to the corresponding PDCCH monitoring occasion 1240, there is no common search space, and the next criterion, that is, criterion 2, may thus be applied. If criterion 2 is applied to the corresponding PDCCH monitoring occasion 1240, all other control resource sets having the same reference signal of QCL-TypeD as control resource set no. 1 1245 may be received. Therefore, the UE may receive the control resource sets 1240 and 1245 in the corresponding PDCCH monitoring occasion 1250.

### [Regarding Rate Matching/Puncturing]

Hereinafter, a rate matching operation and a puncturing operation will be described in detail.

If time and frequency resource A to transmit symbol sequence A overlaps time and frequency resource B, a rate matching or puncturing operation may be considered as an operation of transmitting/receiving channel A in consideration of resource C (region in which resource A and resource B overlap). Specific operations may follow the following description.

### Rate Matching Operation

The base station may transmit channel A after mapping the same only to remaining resource domains other than resource C (area overlapping resource B) among the entire resource A which is to be used to transmit symbol sequence A to the UE. For example, if symbol sequence A is configured as {symbol #1, symbol #2, symbol #3, symbol4}, if resource A is {resource #1, resource #2, resource #3, resource #4}, and if resource B is {resource #3, resource #5}, the UE may receive symbol sequence A based on an assumption that the same has been successively mapped to remaining resources {resource #1, resource #2, resource #4}other than {resource #3}(corresponding to resource C) among resource A. Consequently, the base station may transmit symbol sequence {symbol #1, symbol #2, symbol #3} after mapping the same to {resource #1, resource #2, resource #4}, respectively.

The UE may assess resource A and resource B from scheduling information regarding symbol sequence A from the base station, thereby assessing resource C (region in which resource A and resource B overlap). The UE may receive symbol sequence A based on an assumption that symbol sequence A has been mapped and transmitted in the remaining area other than resource C among the entire resource A. For example, if symbol sequence A is configured as {symbol #1, symbol #2, symbol #3, symbol4}, if resource A is {resource #1, resource #2, resource #3, resource #4}, and if resource B is {resource #3, resource #5}, the UE may receive symbol sequence A based on an assumption that the same has been successively mapped to remaining resources {resource #1, resource #2, resource #4}other than {resource #3}(corresponding to resource C) among resource A. Consequently, the UE may perform a series of following receiving operations based on an assumption that symbol sequence {symbol #1, symbol #2, symbol #3} has been transmitted after being mapped to {resource #1, resource #2, resource #4}, respectively. Of course, the examples given above are not limiting.

### Puncturing Operation

If there is resource C (region overlapping resource B) among the entire resource A which is to be used to transmit symbol sequence A to the UE, the base station may map symbol sequence A to the entire resource A, but may not perform transmission in the resource area corresponding to resource C, and may perform transmission with regard to only the remaining resource area other than resource C among resource A. For example, if symbol sequence A is configured as {symbol #1, symbol #2, symbol #3, symbol4}, if resource A is {resource #1, resource #2, resource #3, resource #4}, and if resource B is {resource #3, resource #5}, the UE may assume that symbol sequence A {symbol #1, symbol #2, symbol #3, symbol4} is mapped to resource A {resource #1, resource #2, resource #3, resource #4}, respectively, but {symbol #3}mapped to {resource #3}(corresponding to resource C) is not transmitted, and based on the assumption that symbol sequence {symbol #1, symbol #2, symbol #4}corresponding to remaining resources {resource #1, resource #2, resource #4}other than {resource #3}(corresponding to resource C) among resource A has been mapped and transmitted, the UE may receive the same. Consequently, the base station may transmit symbol sequence {symbol #1, symbol #2, symbol #4} after mapping the same to {resource #1, resource #2, resource #4}, respectively.

The UE may assess resource A and resource B from scheduling information regarding symbol sequence A from the base station, thereby assessing resource C (region in which resource A and resource B overlap). The UE may receive symbol sequence A, based on an assumption that symbol sequence A has been mapped to the entire resource A but transmitted only in the remaining area other than resource C among the resource area A. For example, if symbol sequence A is configured as {symbol #1, symbol #2, symbol #3, symbol4}, if resource A is {resource #1, resource #2, resource #3, resource #4}, and if resource B is {resource #3, resource #5}, the UE may assume that symbol sequence A {symbol #1, symbol #2, symbol #3, symbol4} is mapped to resource A {resource #1, resource #2, resource #3, resource #4}, respectively, but {symbol #3}mapped to {resource #3}(corresponding to resource C) is not transmitted, and based on the assumption that symbol sequence {symbol #1, symbol #2, symbol #4}corresponding to remaining resources {resource #1, resource #2, resource #4}other than {resource #3}(corresponding to resource C) among resource A has been mapped and transmitted, the UE may receive the same. Consequently, the UE may perform a series of following receiving operations based on an assumption that symbol sequence {symbol #1, symbol #2, symbol #4} has been transmitted after being mapped to {resource #1, resource #2, resource #4}, respectively.

Hereinafter, a method for configuring a rate matching resource for the purpose of rate matching in a 5G communication system will be described. Rate matching refers to adjusting the size of a signal in consideration of the amount of resources that can be used to transmit the signal. For example, data channel rate matching may mean that a data channel is not mapped and transmitted with regard to specific time and frequency resource domains, and the size of data is adjusted accordingly.

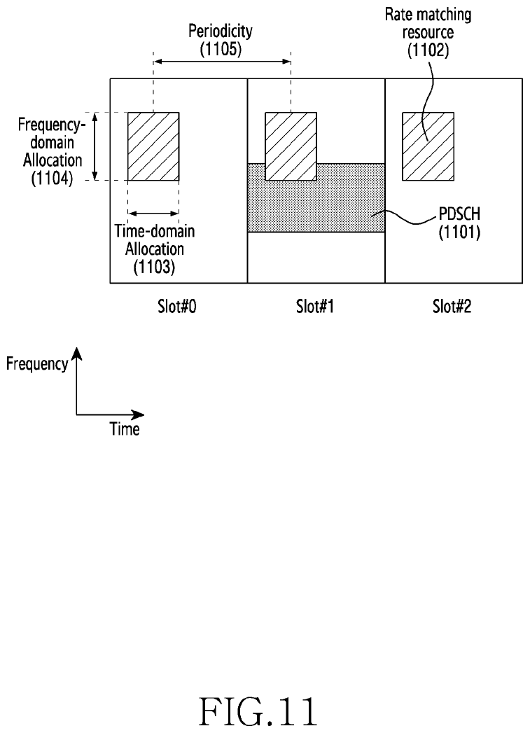

FIG. 11 illustrates a method in which a base station and a UE transmit/receive data in consideration of a downlink data channel and a rate matching resource.

FIG. 11 illustrates a downlink data channel (PDSCH) 1101 and a rate matching resource 1102. The base station may configure one or multiple rate matching resources 1102 for the UE through upper layer signaling (for example, RRC signaling). Rate matching resource 1102 configuration information may include time-domain resource allocation information 1103, frequency-domain resource allocation information 1104, and periodicity information 1105. A bitmap corresponding to the frequency-domain resource allocation information 1104 will hereinafter be referred to as “first bitmap”, a bitmap corresponding to the time-domain resource allocation information 1103 will be referred to as “second bitmap”, and a bitmap corresponding to the periodicity information 1105 will be referred to as “third bitmap”. If all or some of time and frequency resources of the scheduled PDSCH 1101 overlap a configured rate matching resource 1102, the base station may rate-match and transmit the PDSCH 1101 in a rate matching resource 1102 part, and the UE may perform reception and decoding after assuming that the PDSCH 1101 has been rate-matched in a rate matching resource 1102 part.

The base station may dynamically notify the UE, through DCI, of whether the PDSCH will be rate-matched in the configured rate matching resource part through an additional configuration (for example, corresponding to “rate matching indicator” inside DCI format described above). Specifically, the base station may select some from the configured rate matching resources and group them into a rate matching resource group, and may indicate, to the UE, whether the PDSCH is rate-matched with regard to each rate matching resource group through DCI by using a bitmap type. For example, if four rate matching resources RMR #1, RMR #2, RMR #3, and RMR #4 are configured, the base station may configure a rate matching groups RMG #1={RMR #1, RMR #2}, RMG #2={RMR #3, RMR #4}, and may indicate, to the UE, whether rate matching occurs in RMG #1 and RMG #2, respectively, through a bitmap by using two bits inside the DCI field. For example, in a case where rate matching is to be conducted, the base station may indicate this case by “1”, and in a case where rate matching is not to be conducted, the base station may indicate this case by “0”.

5G supports granularity of “RB symbol level” and “RE level” as a method for configuring the above-described rate matching resources for a UE. More specifically, the following configuration method may be followed.

### RB Symbol Level

The UE may have a maximum of four RateMatchPattems configured per each bandwidth part through upper layer signaling, and one RateMatchPattern may include the following contents. Obviously, the examples given below are not limiting.
may include, in connection with a reserved resource inside a bandwidth part, a resource having time and frequency resource domains of the corresponding reserved resource configured as a combination of an RB-level bitmap and a symbol-level bitmap in the frequency domain. The reserved resource may span one or two slots. A time domain pattern (periodicityAndPattem) may be additionally configured wherein time and frequency domains including respective RB-level and symbol-level bitmap pairs are repeated.
may include a resource area corresponding to a time domain pattern configured by time and frequency domain resource areas configured by a CORESET inside a bandwidth part and a search space configuration in which corresponding resource areas are repeated.

### RE Level

The UE may have the following contents configured through upper layer signaling. Obviously, the examples given below are not limiting.
configuration information (lte-CRS-ToMatchAround) regarding a RE corresponding to a LTE CRS (Cell-specific Reference Signal or common reference signal) pattern, which may include LTE CRS's port number (nrofCRS-Ports) and LTE-CRS-vshift(s) value (v-shift), location information (carrierFreqDL) of a center subcarrier of a LTE carrier from a reference frequency point (for example, reference point A), the LTE carrier's bandwidth size (carrierBandwidthDL) information, subframe configuration information (mbsfn-SubframConfigList) corresponding to a multicast-broadcast single-frequency network (MBSFN), and the like. The UE may determine the position of the CRS inside the NR slot corresponding to the LTE subframe, based on the above-mentioned pieces of information.
may include configuration information regarding a resource set corresponding to one or multiple zero power (ZP) CSI-RSs inside a bandwidth part.

### [Regarding LTE CRS Rate Match]

Next, a rate matching process regarding the above-mentioned LTE CRS will be described in detail. In NR, for coexistence between long term evolution (LTE) and new RAT (NR) (LTE-NR coexistence), the pattern of cell-specific reference signal (CRS) of LTE may be configured for an NR UE. More specifically, the CRS pattern may be provided by RRC signaling including at least one parameter inside ServingCellConfig IE (information element) or ServingCellConfigCommon IE. Examples of the parameter may include lte-CRS-ToMatchAround, lte-CRS-PattemList1-r16, lte-CRS-PattemList2-r16, crs-RateMatch-PerCORESETPoolIndex-r16, and the like.

Rel-15 NR may provide a function by which one CRS pattern can be configured per serving cell through parameter lte-CRS-ToMatchAround. In Rel-16 NR, the above function has been expanded such that multiple CRS patterns can be configured per serving cell. More specifically, a UE having a single-TRP (transmission and reception point) configuration may now have one CRS pattern configured per one LTE carrier, and a UE having a multi-TRP configuration may now have two CRS patterns configured per one LTE carrier. For example, the UE having a single-TRP configuration may have a maximum of three CRS patterns configured per serving cell through parameter lte-CRS-PatternList1-r16. As another example, the UE having a multi-TRP configuration may have a CRS configured for each TRP.

That is, the CRS pattern regarding TRP1 may be configured through parameter lte-CRS-PatternList1-r16, and the CRS pattern regarding TRP2 may be configured through parameter lte-CRS-PatternList2-r16. If two TRPs are configured as above, whether the CRS patterns of TRP1 and TRP2 are both to be applied to a specific physical downlink shared channel (PDSCH) or only the CRS pattern regarding one TRP is to be applied is determined through parameter crs-RateMatch-PerCORESETPoolIndex-r16, wherein if parameter crs-RateMatch-PerCORESETPoolIndex-r16 is configured “enabled”, only the CRS pattern of one TRP is applied, and both CRS patterns of the two TRPs are applied in other cases.

Table 17 shows a ServingCellConfig IE including the CRS patterns, and Table 18 shows a RateMatchPattemnLTE-CRS IE including at least one parameter regarding CRS patterns.

TABLE 17

| | |
|---|---|
| ServingCellConfig ::= | SEQUENCE { |
| tdd-UL-DL-ConfigurationDedicated | TDD-UL-DL-ConfigDedicated |

OPTIONAL, -- Cond TDD

| | |
|---|---|
| initialDownlinkBWP | BWP-DownlinkDedicated |

OPTIONAL, -- Need M

| | |
|---|---|
| downlinkBWP-ToReleaseList | SEQUENCE (SIZE (1..maxNrofBWPs)) OF |
| BWP-Id | OPTIONAL, -- Need N |
| downlinkBWP-ToAddModList | SEQUENCE (SIZE (1..maxNrofBWPs)) OF |
| BWP-Downlink | OPTIONAL, -- Need N |
| firstActiveDownlinkBWP-Id | BWP-Id |

OPTIONAL, -- Cond SyncAndCellAdd

| | |
|---|---|
| bwp-InactivityTimer | ENUMERATED {ms2, ms3, ms4, |

ms5, ms6, ms8, ms10, ms20, ms30,
ms40,ms50, ms60, ms80,ms100, ms200,ms300, ms500,
ms750, ms1280, ms1920, ms2560, spare10, spare9, spare8,

| | |
|---|---|
| spare7, spare6, spare5, spare4, spare3, spare2, spare1 } | OPTIONAL, --Need R |
| defaultDownlinkBWP-Id | BWP-Id |

OPTIONAL, -- Need S

| | |
|---|---|
| uplinkConfig | UplinkConfig |

OPTIONAL, -- Need M

| | |
|---|---|
| supplementaryUplink | UplinkConfig |

OPTIONAL, -- Need M

| | |
|---|---|
| pdcch-ServingCellConfig | SetupRelease { PDCCH- |
| ServingCellConfig } | OPTIONAL, -- Need M |
| pdsch-ServingCellConfig | SetupRelease { PDSCH- |
| ServingCellConfig } | OPTIONAL, -- Need M |
| csi-MeasConfig | SetupRelease { CSI- |
| MeasConfig } | OPTIONAL, -- Need M |
| sCellDeactivationTimer | ENUMERATED {ms20, ms40, ms80, |

ms160, ms200, ms240,
ms320, ms400, ms480, ms520, ms640, ms720,

| | |
|---|---|
| ms840, ms1280, spare2,spare1} | OPTIONAL, -- Cond |

ServingCellWithoutPUCCH

| | |
|---|---|
| crossCarrierSchedulingConfig | CrossCarrierSchedulingConfig |

OPTIONAL, -- Need M

| | |
|---|---|
| tag-Id | TAG-Id, |
| dummy | ENUMERATED |
| {enabled} | OPTIONAL, -- |

Need R

| | |
|---|---|
| pathlossReferenceLinking | ENUMERATED {spCell, sCell} |

OPTIONAL, -- Cond SCellOnly

| | |
|---|---|
| servingCellMO | MeasObjectId |

```
OPTIONAL, -- Cond MeasObject
  ...,
  [[
```

| | |
|---|---|
| lte-CRS-ToMatchAround | SetupRelease { |
| RateMatchPatternLTE-CRS } | OPTIONAL, -- Need M |
| rateMatchPatternToAddModList | SEQUENCE (SIZE |
| (1..maxNrofRateMatchPatterns)) OF RateMatchPattern | OPTIONAL, -- Need N |
| rateMatchPatternToReleaseList | SEQUENCE (SIZE |
| (1..maxNrofRateMatchPatterns)) OF RateMatchPatternId | OPTIONAL, -- Need N |
| downlinkChannelBW-PerSCS-List | SEQUENCE (SIZE (1..maxSCSs)) OF |
| SCS-SpecificCarrier | OPTIONAL -- Need S |

```
  ]],
  [[
```

| | |
|---|---|
| supplementaryUplinkRelease | ENUMERATED {true} |

OPTIONAL, -- Need N

| | |
|---|---|
| tdd-UL-DL-ConfigurationDedicated-IAB-MT-r16 | TDD-UL-DL-ConfigDedicated-IAB- |
| MT-r16 | OPTIONAL, -- Cond TDD_IAB |
| dormantBWP-Config-r16 | SetupRelease { DormantBWP- |
| Config-r16 } | OPTIONAL, -- Need M |
| ca-SlotOffset-r16 | CHOICE { |
| refSCS15kHz | INTEGER (−2..2), |
| refSCS30KHz | INTEGER (−5..5), |
| refSCS60KHz | INTEGER (−10..10), |
| refSCS120KHz | INTEGER (−20..20) |

}
OPTIONAL, -- Cond AsyncCA

| | |
|---|---|
| channelAccessConfig-r16 | SetupRelease { |
| ChannelAccessConfig-r16 } | OPTIONAL, -- Need M |
| intraCellGuardBandsDL-List-r16 | SEQUENCE (SIZE (1..maxSCSs)) OF |
| IntraCellGuardBandsPerSCS-r16 | OPTIONAL, -- Need S |
| intraCellGuardBandsUL-List-r16 | SEQUENCE (SIZE (1..maxSCSs)) OF |
| IntraCellGuardBandsPerSCS-r16 | OPTIONAL, -- Need S |
| csi-RS-ValidationWith-DCI-r16 | ENUMERATED {enabled} |

OPTIONAL, -- Need R

| | |
|---|---|
| lte-CRS-PatternList1-r16 | SetupRelease { LTE-CRS- |
| PatternList-r16 } | OPTIONAL, -- Need M |
| lte-CRS-PatternList2-r16 | SetupRelease { LTE-CRS- |
| PatternList-r16 } | OPTIONAL, -- Need M |
| crs-RateMatch-PerCORESETPoolIndex-r16 | ENUMERATED {enabled} |

OPTIONAL, -- Need R

| | |
|---|---|
| enableTwoDefaultTCI-States-r16 | ENUMERATED {enabled} |

OPTIONAL, -- Need R

| | |
|---|---|
| enableDefaultTCI-StatePerCoresetPoolIndex-r16 | ENUMERATED {enabled} |

OPTIONAL, -- Need R

| | |
|---|---|
| enableBeamSwitchTiming-r16 | ENUMERATED {true} |

OPTIONAL, -- Need R

| | |
|---|---|
| cbg-TxDiffTBsProcessingType1-r16 | ENUMERATED {enabled} |

OPTIONAL, -- Need R

| | |
|---|---|
| cbg-TxDiffTBsProcessingType2-r16 | ENUMERATED {enabled} |

OPTIONAL -- Need R
]]
}

```
TABLE 18
    - RateMatchPatternLTE-CRS
The IE RateMatchPatternLTE-CRS is used to configure a pattern to rate match
around LTE CRS. See TS 38.214 [19], clause 5.1.4.2.
      RateMatchPatternLTE-CRS information element
-- ASN1START
-- TAG-RATEMATCHPATTERNLTE-CRS-START
```

| | |
|---|---|
| RateMatchPatternLTE-CRS ::= | SEQUENCE { |
| carrierFreqDL | INTEGER (0..16383), |
| carrierBandwidthDL | ENUMERATED {n6, n15, n25, n50, |

n75, n100, spare2, spare1},

| | |
|---|---|
| mbsfn-SubframeConfigList | EUTRA-MBSFN-SubframeConfigList |

OPTIONAL, -- Need M

| | |
|---|---|
| nrofCRS-Ports | ENUMERATED {n1, n2, n4}, |
| v-Shift | ENUMERATED {n0, n1, |

n2, n3, n4, n5}
}

| | |
|---|---|
| LTE-CRS-PatternList-r16 ::= | SEQUENCE (SIZE (1..maxLTE-CRS-Patterns- |

r16)) OF RateMatchPatternLTE-CRS
-- TAG-RATEMATCHPATTERNLTE-CRS-STOP
-- ASN1STOP
RateMatchPatternLTE-CRS field descriptions
carrierBandwidthDL
BW of the LTE carrier in number of PRBs (see TS 38.214 [19], clause 5.1.4.2).
carrierFreqDL
Center of the LTE carrier (see TS 38.214 [19], clause 5.1.4.2).
mbsfn-SubframeConfigList
LTE MBSFN subframe configuration (see TS 38.214 [19], clause 5.1.4.2).
nrofCRS-Ports
Number of LTE CRS antenna port to rate-match around (see TS 38.214 [19], clause 5.1.4.2).
v-Shift
Shifting value v-shift in LTE to rate match around LTE CRS (see TS 38.214 [19], clause 5.1.4.2).

### [PDSCH: Regarding Frequency Resource Allocation]

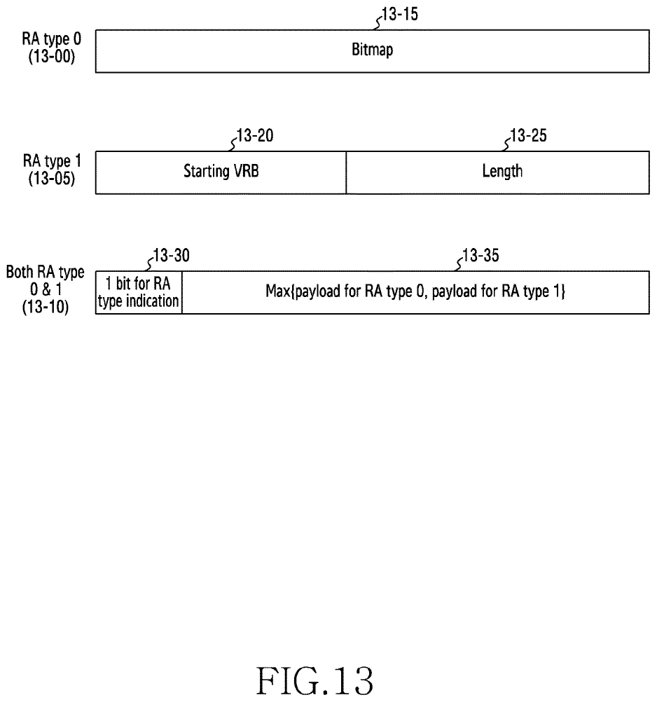

FIG. 13 illustrates an example of frequency domain resource allocation with regard to a physical downlink shared channel (PDSCH) in a wireless communication system according to an embodiment of the disclosure.

FIG. 13 illustrates three frequency domain resource allocation methods of type 0 13-00, type 1 13-01, and dynamic switch 13-10 which can be configured through an upper layer in an NR wireless communication system.

Referring to FIG. 13, in the case in which a UE is configured to use only resource type 0 through upper layer signaling (1300), partial downlink control information (DCI) for allocating a PDSCH to the UE include a bitmap including NRBG bits. The conditions for this will be described again later. As used herein, N_{RBG} refers to the number of resource block groups (RBGs) determined according to the BWP size allocated by a BWP indicator and upper layer parameter rbg-Size, as in Table 19 below, and data is transmitted in RBGs indicated as “1” by the bitmap.

TABLE 19

| Bandwidth Part Size | Configuration 1 | Configuration 2 |
|---|---|---|
| 1-36 | 3 | 4 |
| 37-72 | 4 | 8 |
| 73-144 | 8 | 16 |
| 145-275 | 16 | 16 |

In the case in which the UE is configured to use only resource type 1 through upper layer signaling (1305), partial DCI includes frequency domain resource allocation information including

$$[ {log}_{2} ( {N}_{RB}^{DL , BWP} ( {N}_{RB}^{DL , BWP} + 1 ) / 2 ] bits .$$

The conditions for this will be described again later. The base station may thereby configure a starting virtual resource block (starting VRB) 1320 and the length 1325 of a frequency domain resource allocated continuously therefrom.

In the case in which the UE is configured to use both resource type 0 and resource type 1 through upper layer signaling (1310), partial DCI for allocating a PDSCH to the corresponding UE includes frequency domain resource allocation information including as many bits as the larger value 1335 between the payload 1315 for configuring resource type 0 and the payload 1320 and 1325 for configuring resource type 1. The conditions for this will be described again later. One bit may be added to the foremost part (MSB) of the frequency domain resource allocation information inside the DCI. If the bit has the value of “0”, use of resource type 0 may be indicated, and if the bit has the value of “1”, use of resource type 1 may be indicated.

### [PDSCH/PUSCH: Regarding Time Resource Allocation]

Hereinafter, a time domain resource allocation method regarding a data channel in a next-generation mobile communication system (5G or NR system) will be described.

A base station may configure a table for time domain resource allocation information regarding a physical downlink shared channel (PDSCH) and a physical uplink shared channel (PUSCH) for a UE through upper layer signaling (for example, RRC signaling). A table including a maximum of maxNrofDL-Allocations=16 entries may be configured for the PDSCH, and a table including a maximum of maxNroflJL-Allocations=16 entries may be configured for the PUSCH. In an embodiment, the time domain resource allocation information may include PDCCH-to-PDSCH slot timing (for example, corresponding to a slot-unit time interval between a timepoint at which a PDCCH is received and a timepoint at which a PDSCH scheduled by the received PDCCH is transmitted; labeled K0), PDCCH-to-PUSCH slot timing (for example, corresponding to a slot-unit time interval between a timepoint at which a PDCCH is received and a timepoint at which a PUSCH scheduled by the received PDCCH is transmitted; hereinafter, labeled 2), information regarding the location and length of the start symbol by which a PDSCH or PUSCH is scheduled inside a slot, the mapping type of a PDSCH or PUSCH, and the like. For example, information such as in Table 20 or Table 21 below may be transmitted from the base station to the UE. Obviously, the example given above is not limiting.

TABLE 20
PDSCH-TimeDomainResourceAllocationList information element

| | |
|---|---|
| PDSCH-TimeDomainResourceAllocationList ::= | SEQUENCE (SIZE(1..maxNrofDL- |

Allocations)) OF
PDSCH-TimeDomainResourceAllocation

| | |
|---|---|
| PDSCH-TimeDomainResourceAllocation ::= | SEQUENCE { |

```
                k0
INTEGER(0..32)
      OPTIONAL, -- Need S
              (PDCCH-to-PDSCH timing, slot unit)
```

| | |
|---|---|
| mappingType | ENUMERATED |

{typeA, typeB},
(PDSCH mapping type)

| | |
|---|---|
| startSymbolAndLength | INTEGER (0..127) |

```
        (start symbol and length of PDSCH)
  }
```

TABLE 21
PUSCH-TimeDomainResourceAllocationList information element

| | |
|---|---|
| PUSCH-TimeDomainResourceAllocationList ::= | SEQUENCE (SIZE(1..maxNrofUL- |

Allocations)) OF
PUSCH-TimeDomainResourceAllocation

| | |
|---|---|
| PUSCH-TimeDomainResourceAllocation ::= | SEQUENCE { |

k2

| | |
|---|---|
| INTEGER(0..32) | OPTIONAL, -- Need S |

(PDCCH-to-PUSCH timing, slot unit)

| | |
|---|---|
| mappingType | ENUMERATED |

{typeA, typeB},
(PUSCH mapping type)

| | |
|---|---|
| startSymbolAndLength | INTEGER (0..127) |

```
            (start symbol and length of PUSCH)
  }
```

The base station may notify the UF of one of the entries of the table regarding time domain resource allocation information described above through L1 signaling (for example, DCI) (for example, “time domain resource allocation” field in DCI may indicate the same). The UE may acquire time domain resource allocation information regarding a PDSCH or PUSCH, based on the DCI acquired from the base station.

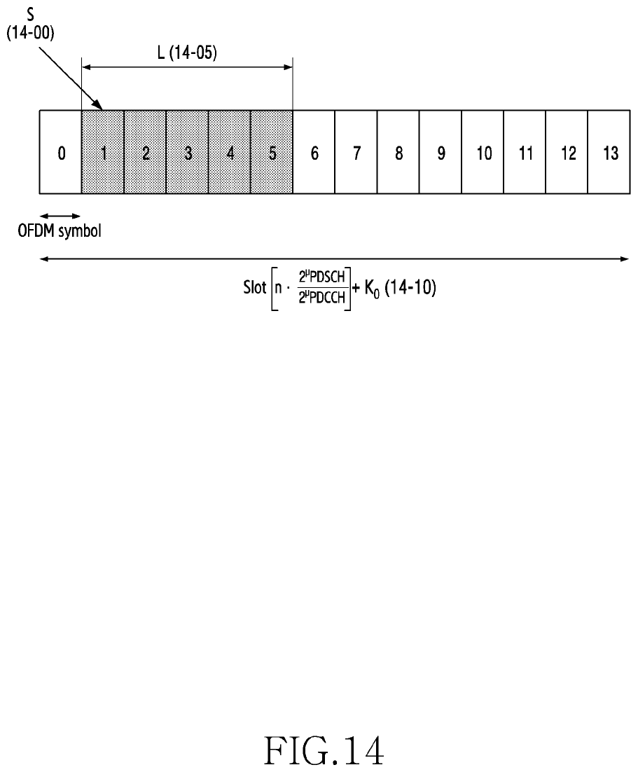

FIG. 14 illustrates an example of time domain resource allocation with regard to a PDSCH in a wireless communication system according to an embodiment of the disclosure.

Referring to FIG. 14, the base station may indicate the time domain location of a PDSCH resource according to the subcarrier spacing (SCS) (μ_{PDSCH}, μ_{PDCCH}) of a data channel and a control channel configured by using an upper layer, the scheduling offset (K0) value, and the OFDM symbol start location 14-00 and length 14-05 within one slot dynamically indicated through DCI.

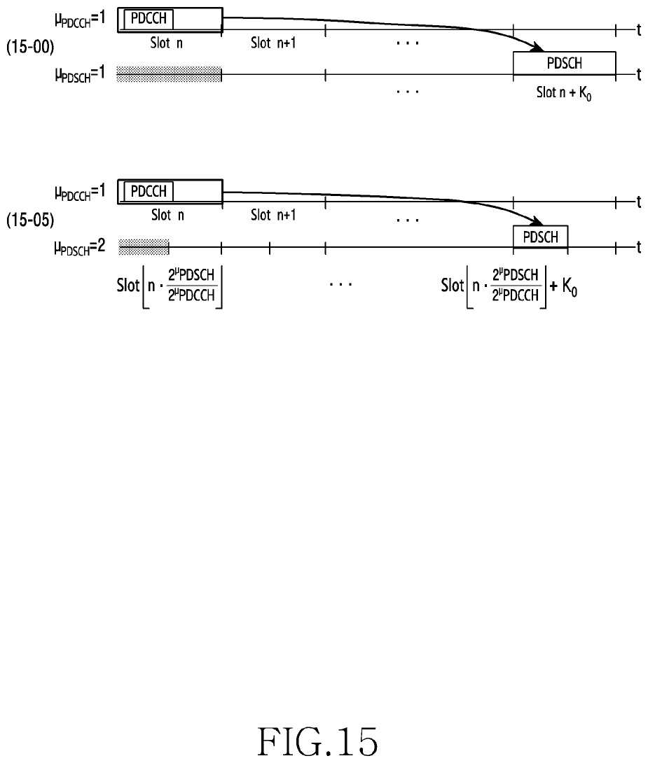

FIG. 15 illustrates an example of time domain resource allocation according to a subcarrier spacing with regard to a data channel and a control channel in a wireless communication system according to an embodiment of the disclosure.

Referring to FIG. 15, if the data channel and the control channel have the same subcarrier spacing (15-00, μ_{PDSCH}=μ_{PDCCH}), the slot number for data and that for control are identical, and the base station and the UE may accordingly generate a scheduling offset in conformity with a predetermined slot offset K0. On the other hand, if the data channel and the control channel have different subcarrier spacings (15-05, μ_{PDSCH}≠μ_{PDCCH}), the slot number for data and that for control are different, and the base station and the UE may accordingly generate a scheduling offset in conformity with a predetermined slot offset K0 with reference to the subcarrier spacing of the PDCCH.

### [PDSCH: Processing Time]

Next, a PDSCH processing time (PDSCH processing procedure time) will be described. If the base station schedules the UE to transmit a PDSCH by using DCI format 1_0, 1_1 or 1_2, the UE may need a PDSCH processing time for receiving a PDSCH by applying a transmission method (modulation/demodulation and coding indication index (MCS), demodulation reference signal-related information, time and frequency resource allocation information, and the like) indicated through DCI. The PUSCH preparation procedure time is defined in NR in consideration thereof. The PUSCH preparation procedure time of the UE may follow Equation 3 given below.

$${T}_{p roc , 1} = ( {N}_{1} + {d}_{1 , 1} + {d}_{2} ) ( 2048 + 144 ) κ {2}^{- μ} {T}_{c} + {T}_{e x t} \qquad [ Equation 3 ]$$

Each parameter in T_{proc,1} described above in Equation 3 may have the following meaning.
N₁: the number of symbols determined according to UE processing capability 1 or 2 based on the UE's capability and numerology μ. N₁ may have a value in Table 22 if UE processing capability 1 is reported according to the UE's capability report, and may have a value in Table 23 if UE processing capability 2 is reported, and if availability of UE processing capability 2 is configured through upper layer signaling. The numerology μ may correspond to the minimum value among μ_{PDCCH}, μ_{PDSCH}, μ_{UL} so as to maximize T_{proc,1}, and μ_{PDCCH}, μ_{PDSCH}, μ_{UL} may refer to the numerology of a PDCCH that scheduled a PDSCH, the numerology of the scheduled PDSCH, and numerology of an uplink channel in which a HARQ-ACK is to be transmitted.

TABLE 22
PDSCH processing time in the
case of PDSCH processing capability 1

| | PDSCH decoding time N₁ [symbols] | |
|---|---|---|
| | If PDSCH | If PDSCH mapping type A and B |
| | mapping type A and B | both do not correspond to dmrs- |
| | both correspond to dmrs- | AdditionalPosition = pos0 inside |
| | AdditionalPosition = | DMRS-DownlinkConfig which is |
| | pos0 inside DMRS- | upper layer signaling, or |
| | DownlinkConfig which | if no upper layer parameter |
| μ | is upper layer signaling | is configured |
| 0 | 8 | N_{1, 0} |
| 1 | 10 | 13 |
| 2 | 17 | 20 |
| 3 | 20 | 24 |

TABLE 23
PDSCH processing time in the
case of PDSCH processing capability 2

| | PDSCH decoding time N₁ [symbols] |
|---|---|
| | If PDSCH mapping type A and B both correspond |
| | to dmrs-AdditionalPosition = pos0 inside DMRS- |
| μ | DownlinkConfig which is upper layer signaling |
| 0 | 3 |
| 1 | 4.5 |
| 2 | 9 for frequency range 1 |

κ: 64
Tₑₓₜ: if the UE uses a shared spectrum channel access scheme, the UE may calculate Tₑₓₜ and apply the same to the PDSCH processing time. Otherwise, Tₑₓₜ is assumed to be 0.
If l₁ which represents the PDSCH DMRS location value is 12, N_{1,0} in [table 22] above has the value of 14, and otherwise has the value of 13.
With regard to PDSCH mapping type A, if the last symbol of the PDSCH is the i^{th} symbol in the slot in which the PDSCH is transmitted, and if i<7, d_{1,1} is then 7-i, and d_{1,1} is otherwise 0.
d₂: if a PUCCH having a high priority index temporally overlaps another PUCCH or a PUSCH having a low priority index, d₂ of the PUCCH having a high priority index may be configured as a value reported from the UE. Otherwise, d₂ is 0.
If PDSCH mapping type B is used with regard to UE processing capability 1, the d_{1,1} value may be determined by the number (L) of symbols of a scheduled PDSCH and the number of overlapping symbols between the PDCCH that schedules the PDSCH and the scheduled PDSCH, as follows.
If L≥7, then d_{1,1}=0.
If—L≥4 and L≤6, then d_{1,1}=7-L.
If L=3, then d_{1,1}=min (d, 1).
If L=2, then d_{1,1}=3+d.
If PDSCH mapping type B is used with regard to UE processing capability 2, the d_{1,1} value may be determined by the number (L) of symbols of a scheduled PDSCH and the number of overlapping symbols between the PDCCH that schedules the PDSCH and the scheduled PDSCH, as follows.
If L≥7, then d_{1,1}=0.
If—L≥4 and L≤6, then d_{1,1}=7−L.
If L=2,
If the scheduling PDCCH exists inside a CORESET including three symbols, and if the CORESET and the scheduled PDSCH have the same start symbol, then d_{1,1}=3.
Otherwise, d_{1,1}=d.
In the case of a UE supporting capability 2 inside a given serving cell, the PDSCH processing time based on UE processing capability 2 may be applied by the UE if processingType2Enabled (upper layer signaling) is configured as “enable” with regard to the corresponding cell.

If the location of the first uplink transmission symbol of a PUCCH including HARQ-ACK information (in connection with the corresponding location, K1 defined as the HARQ-ACK transmission timepoint, a PUCCH resource used to transmit the HARQ-ACK, and the timing advance effect may be considered) does not start earlier than the first uplink transmission symbol that comes after the last symbol of the PDSCH over a time of Tproc,1, the UE needs to transmit a valid HARQ-ACK message. That is, the UE needs to transmit a PUCCH including a HARQ-ACK only if the PDSCH processing time is sufficient. The UE cannot otherwise provide the base station with valid HARQ-ACK information corresponding to the scheduled PDSCH. The Tproc,1 may be used in the case of both a normal and an extended CP. In the case of a PDSCH having two PDSCH transmission locations configured inside one slot, d1,1 is calculated with reference to the first PDSCH transmission location inside the corresponding slot.

### [PDSCH: Reception Preparation Time During Cross-Carrier Scheduling]

Next, in the case of cross-carrier scheduling in which the numerology (μ_{PDCCH}) by which a scheduling PDCCH is transmitted and the numerology (μ_{PDSCH}) by which a PDSCH scheduled by the corresponding PDCCH is transmitted are different from each other, the PDSCH reception reparation time (N_{pdsch}) of the UE defined with regard to the time interval between the PDCCH and PDSCH will be described.

If μ_{PDCCH}<μ_{PDSCH}, the scheduled PDSCH cannot be transmitted before the first symbol of the slot coming after N_{pdsch} symbols from the last symbol of the PDCCH that scheduled the corresponding PDSCH. The transmission symbol of the corresponding PDSCH may include a DM-RS.

If μ_{PDCCH}>μ_{PDSCH}, the scheduled PDSCH may be transmitted after N_{pdsch} symbols from the last symbol of the PDCCH that scheduled the corresponding PDSCH. The transmission symbol of the corresponding PDSCH may include a DM-RS.

TABLE 24
N_{pdsch} according to scheduled PDCCH
subcarrier spacing [symbols]

| μ_{PDCCH} | N_{pdsch} [symbols] |
|---|---|
| 0 | 4 |
| 1 | 5 |
| 2 | 10 |
| 3 | 14 |

### [PDSCH: TCI State Activation MAC-CE]

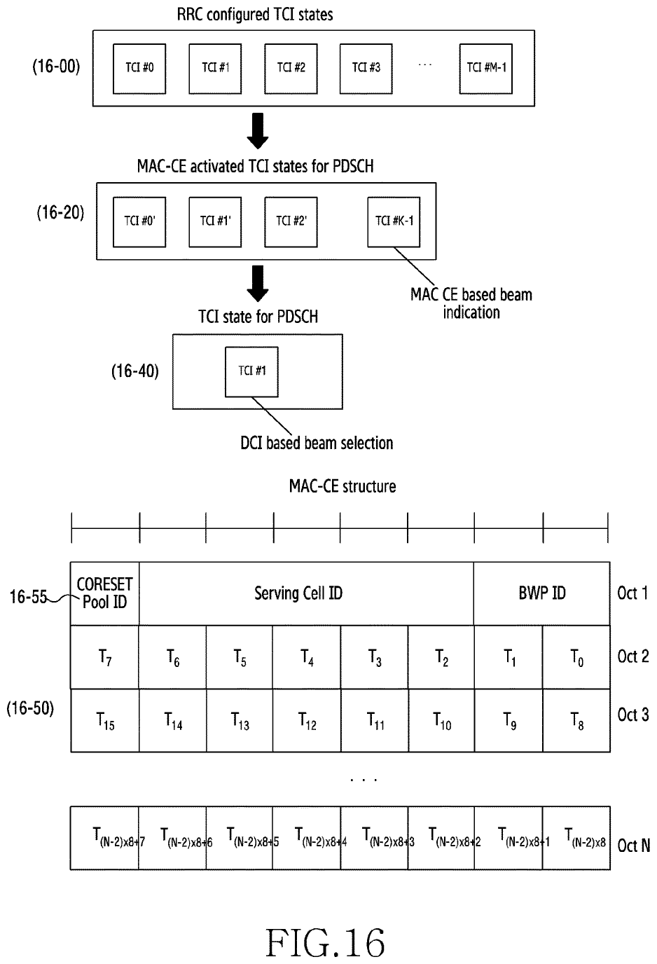

Next, a method for beam configuration with regard to a PDSCH will be described. FIG. 16 illustrates a process for beam configuration and activation with regard to a PDSCH. A list of TCI states regarding a PDSCH may be indicated through an upper layer list such as RRC (16-00). The list of TCI states may be indicated by tci-StatesToAddModList and/or tci-StatesToReleaseList inside a BWP-specific PDSCH-Config IE, for example. Next, a part of the list of TCI states may be activated through a MAC-CE (16-20). The maximum number of activated TCI states may be determined by the capability reported by the UE. (16-50) illustrates an example of an MAC-CE structure for PDSCH TCI state activation/deactivation.

The meaning of respective fields inside the MAC CE and values configurable for respective fields are as follows.
Serving Cell ID (serving cell identity): This field indicates the identity of the Serving Cell for which the MAC CE applies. The length of the field is 5 bits. If the indicated Serving Cell is configured as part of a simultaneousTCI-UpdateList1 or simultaneousTCI-UpdateList2 as specified in TS 38.331 [5], this MAC CE applies to all the Serving Cells configured in the set simultaneousTCI-UpdateList1 or simultaneousTCI-UpdateList2, respectively;
BWP ID (bandwidth part identity): This field indicates a DL BWP for which the MAC CE applies as the codepoint of the DCI bandwidth part indicator field as specified in TS 38.212 [9]. The length of the BWP ID field is 2 bits. This field is ignored if this MAC CE applies to a set of Serving Cells;
Ti (TCI state identity): If there is a TCI state with TCI-StateId i as specified in TS 38.331 [5], this field indicates the activation/deactivation status of the TCI state with TCI-StateId i, otherwise MAC entity shall ignore the Ti field. The Ti field is set to 1 to indicate that the TCI state with TCI-StateId i shall be activated and mapped to the codepoint of the DCI Transmission Configuration Indication field, as specified in TS 38.214 [7]. The Ti field is set to 0 to indicate that the TCI state with TCI-StateId i shall be deactivated and is not mapped to the codepoint of the DCI Transmission Configuration Indication field. The codepoint to which the TCI State is mapped is determined by its ordinal position among all the TCI States with Ti field set to 1, i.e. the first TCI State with Ti field set to 1 shall be mapped to the codepoint value 0, second TCI State with Ti field set to 1 shall be mapped to the codepoint value 1 and so on. The maximum number of activated TCI states is 8;
CORESET Pool ID (CORESET pool identity): This field indicates that mapping between the activated TCI states and the codepoint of the DCI Transmission Configuration Indication set by field Ti is specific to the ControlResourceSetId configured with CORESET Pool ID as specified in TS 38.331 [5]. This field set to 1 indicates that this MAC CE shall be applied for the DL transmission scheduled by CORESET with the CORESET pool ID equal to 1, otherwise, this MAC CE shall be applied for the DL transmission scheduled by CORESET pool ID equal to 0. If the coresetPoolIndex is not configured for any CORESET, MAC entity shall ignore the CORESET Pool ID field in this MAC CE when receiving the MAC CE. If the Serving Cell in the MAC CE is configured in a cell list that contains more than one Serving Cell, the CORESET Pool ID field shall be ignored when receiving the MAC CE.

### [PUSCH: Regarding Transmission Scheme]

Next, a PUSCH transmission scheduling scheme will be described. PUSCH transmission may be dynamically scheduled by a UL grant inside DCI, or operated by means of configured grant Type 1 or Type 2. Dynamic scheduling indication regarding PUSCH transmission may be made by DCI format 0_0 or 0_1.

Configured grant Type 1 PUSCH transmission may be configured semi-statically by receiving configuredGrantConfig including rrc-ConfiguredUplinkGrant in Table 25 through upper signaling, without receiving a UL grant inside DCI. Configured grant Type 2 PUSCH transmission may be scheduled semi-persistently by a UL grant inside DCI after receiving configuredGrantConfig not including rrc-ConfiguredUplinkGrant in Table 25 through upper signaling. If PUSCH transmission is operated by a configured grant, parameters applied to the PUSCH transmission are applied through configuredGrantConfig (upper signaling) in Table 25 except for dataScramblingdentityPUSCH, txConfig, codebookSubset, maxRank, and scaling of UCI-OnPUSCH, which are provided by pusch-Config (uppersignaling) in Table 26. If provided with transformPrecoder inside configuredGrantConfig (upper signaling) in Table 25, the UE applies tp-pi2BPSK inside pusch-Config in Table 19 to PUSCH transmission operated by a configured grant. Obviously, the example given above is not limiting.

TABLE 25

| | |
|---|---|
| ConfiguredGrantConfig ::= | SEQUENCE { |
| frequencyHopping | ENUMERATED {intraSlot, interSlot} |

OPTIONAL, -- Need S,

| | |
|---|---|
| cg-DMRS-Configuration | DMRS-UplinkConfig, |
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| uci-OnPUSCH | SetupRelease { CG-UCI-OnPUSCH } |

OPTIONAL, -- Need M

| | |
|---|---|
| resourceAllocation | ENUMERATED { resourceAllocationType0, |

resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

OPTIONAL, -- Need S

| | |
|---|---|
| nrofHARQ-Processes | INTEGER(1..16), |
| repK | ENUMERATED {n1, n2, n4, n8}, |
| repK-RV | ENUMERATED {s1-0231, s2-0303, s3-0000} |

OPTIONAL, -- Need R

| | |
|---|---|
| periodicity | ENUMERATED { |
| | sym2, sym7, sym1x14, sym2x14, sym4x14, |

sym5x14, sym8x14, sym10x14, sym16x14, sym20x14,

sym32x14, sym40x14, sym64x14,

sym80x14, sym128x14, sym160x14, sym256x14, sym320x14, sym512x14,

sym640x14, sym1024x14, sym1280x14,

sym2560x14, sym5120x14,

sym6, sym1x12, sym2x12, sym4x12,

sym5x12, sym8x12, sym10x12, sym16x12, sym20x12, sym32x12,

sym40x12, sym64x12, sym80x12,

sym128x12, sym160x12, sym256x12, sym320x12, sym512x12, sym640x12,

sym1280x12, sym2560x12

},

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER (0..1) |

OPTIONAL, -- Need R

| | |
|---|---|
| precodingAndNumberOfLayers | INTEGER (0..63), |
| srs-ResourceIndicator | INTEGER (0..15) |

OPTIONAL, -- Need R

| | |
|---|---|
| mcsAndTBS | INTEGER (0..31), |
| frequencyHoppingOffset | INTEGER (1..maxNrofPhysicalResourceBlocks-1) |

OPTIONAL, -- Need R

| | |
|---|---|
| pathlossReference Index | INTEGER (0..maxNrofPUSCH- |

```
PathlossReferenceRSs-1),
    ...
  }
OPTIONAL, -- Need R
  ...
}
```

Next, a PUSCH transmission method will be described. The DMRS antenna port for PUSCH transmission is identical to an antenna port for SRS transmission. PUSCH transmission may follow a codebook-based transmission method and a non-codebook-based transmission method according to whether the value of txConfig inside pusch-Config in Table 26, which is upper signaling, is “codebook” or “nonCodebook”.

As described above, PUSCH transmission may be dynamically scheduled through DCI format 0_0 or 0_1, and may be semi-statically configured by a configured grant. Upon receiving indication of scheduling regarding PUSCH transmission through DCI format 0_0, the UE performs beam configuration for PUSCH transmission by using pucch-spatialRelationInfoID corresponding to a UE-specific PUCCH resource corresponding to the minimum ID inside an activated uplink BWP inside a serving cell, and the PUSCH transmission is based on a single antenna port. The UE does not expect scheduling regarding PUSCH transmission through DCI format 0_0 inside a BWP having no configured PUCCH resource including pucch-spatialRelationInfo. If the UE has no configured txConfig inside pusch-Config in Table 26, the UE does not expect scheduling through DCI format 0_1.

TABLE 26

| | |
|---|---|
| PUSCH-Config ::= | SEQUENCE { |
| dataScramblingIdentityPUSCH | INTEGER (0..1023) |

OPTIONAL, -- Need S

| | |
|---|---|
| txConfig | ENUMERATED {codebook, nonCodebook} |

OPTIONAL, -- Need S

| | |
|---|---|
| dmrs-UplinkForPUSCH-MappingTypeA | SetupRelease { DMRS-UplinkConfig } |

OPTIONAL, -- Need M

| | |
|---|---|
| dmrs-UplinkForPUSCH-MappingTypeB | SetupRelease { DMRS-UplinkConfig } |

OPTIONAL, -- Need M

| | |
|---|---|
| pusch-PowerControl | PUSCH-PowerControl |

OPTIONAL, -- Need M

| | |
|---|---|
| frequencyHopping | ENUMERATED {intraSlot, interSlot} |

OPTIONAL, -- Need S

| | |
|---|---|
| frequencyHoppingOffsetLists | SEQUENCE (SIZE (1..4)) OF INTEGER |

(1.. maxNrofPhysicalResourceBlocks-1)
OPTIONAL, -- Need M

| | |
|---|---|
| resourceAllocation | ENUMERATED { resourceAllocationType0, |

resourceAllocationType1, dynamicSwitch},

| | |
|---|---|
| pusch-TimeDomainAllocationList | SetupRelease { PUSCH- |
| TimeDomainResourceAllocationList | } |

OPTIONAL, -- Need M

| | |
|---|---|
| pusch-AggregationFactor | ENUMERATED { n2, n4, n8 } |

OPTIONAL, -- Need S

| | |
|---|---|
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| transformPrecoder | ENUMERATED {enabled, disabled} |

OPTIONAL, -- Need S

| | |
|---|---|
| codebookSubset | ENUMERATED {fullyAndPartialAndNonCoherent, |

partialAndNonCoherent,nonCoherent}
OPTIONAL, -- Cond codebookBased

| | |
|---|---|
| maxRank | INTEGER (1..4) |

OPTIONAL, -- Cond codebookBased

| | |
|---|---|
| rbg-Size | ENUMERATED { config2} |

OPTIONAL, -- Need S

| | |
|---|---|
| uci-OnPUSCH | SetupRelease { UCI-OnPUSCH} |

OPTIONAL, -- Need M

| | |
|---|---|
| tp-pi2BPSK | ENUMERATED {enabled} |

OPTIONAL, -- Need S
...
}

Next, codebook-based PUSCH transmission will be described. The codebook-based PUSCH transmission may be dynamically scheduled through DCI format 0_0 or 0_1, and may be operated semi-statically by a configured grant. If a codebook-based PUSCH is dynamically scheduled through DCI format 0_1 or configured semi-statically by a configured grant, the UE determines a precoder for PUSCH transmission, based on an SRS resource indicator (SRI), a transmission precoding matrix indicator (TPMI), and a transmission rank (the number of PUSCH transmission layers).

The SRI may be indicated through the SRS resource indicator (a field inside DCI) or configured through srs-ResourceIndicator (upper signaling). During codebook-based PUSCH transmission, the UE has at least one SRS resource configured therefor, and may have a maximum of two SRS resources configured therefor. If the UE is provided with the SRI through DCI, the SRS resource indicated by the corresponding SRI refers to the SRS resource corresponding to the SRI, among SRS resources transmitted prior to the PDCCH including the corresponding SRI. In addition, the TPMI and the transmission rank may be given through “precoding information and number of layers” (a field inside DCI) or configured through precodingAndNumberOfLayers (upper signaling). The TPMI may be used to indicate a precoder to be applied to PUSCH transmission. If one SRS resource is configured for the UE, the TPMI may be used to indicate a precoder to be applied in the configured one SRS resource. If multiple SRS resources are configured for the UE, the TPMI is used to indicate a precoder to be applied in an SRS resource indicated through the SRI.

The precoder to be used for PUSCH transmission may be selected from an uplink codebook having the same number of antenna ports as the value of nrofSRS-Ports inside SRS-Config (upper signaling). In connection with codebook-based PUSCH transmission, the UE may determine a codebook subset, based on codebookSubset inside pusch-Config (upper signaling) and TPMI. The codebookSubset inside pusch-Config (upper signaling) may be configured to be one of “fullyAndPartialAndNonCoherent”, “partialAndNonCoherent”, or “noncoherent”, based on UE capability reported by the UE to the base station. If the UE reported “partialAndNonCoherent’” as UE capability, the UE may not expect that the value of codebookSubset (upper signaling) will be configured as “fullyAndPartialAndNonCoherent”. In addition, if the UE reported “nonCoherent” as UE capability, UE may not expect that the value of codebookSubset (upper signaling) will be configured as “fullyAndPartialAndNonCoherent” or “partialAndNonCoherent”. If nrofSRS-Ports inside SRS-ResourceSet (upper signaling) indicates two SRS antenna ports, the UE does not expect that the value of codebookSubset (upper signaling) will be configured as “partialAndNonCoherent”.

The UE may have one SRS resource set configured therefor, wherein the value of usage inside SRS-ResourceSet (upper signaling) is “codebook”, and one SRS resource may be indicated through an SRI inside the corresponding SRS resource set. If multiple SRS resources are configured inside the SRS resource set wherein the value of usage inside SRS-ResourceSet (upper signaling) is “codebook”, the UE may expect that the value of nrofSRS-Ports inside SRS-Resource (upper signaling) is identical for all SRS resources.

The UE may transmit, to the base station, one or multiple SRS resources included in the SRS resource set wherein the value of usage is configured as “codebook” according to upper signaling, and the base station may select one from the SRS resources transmitted by the UE and indicate the UE to be able to transmit a PUSCH by using transmission beam information of the corresponding SRS resource. In connection with the codebook-based PUSCH transmission, the SRI may be used as information for selecting the index of one SRS resource, and may be included in DCI. Additionally, the base station may add information indicating the rank and TPMI to be used by the UE for PUSCH transmission to the DCI. Using the SRS resource indicated by the SRI, the UE may apply, in performing PUSCH transmission, the precoder indicated by the rank and TPMI indicated based on the transmission beam of the corresponding SRS resource, thereby performing PUSCH transmission.

Next, non-codebook-based PUSCH transmission will be described. The non-codebook-based PUSCH transmission may be dynamically scheduled through DCI format 0_0 or 0_1, and may be operated semi-statically by a configured grant. If at least one SRS resource is configured inside an SRS resource set wherein the value of usage inside SRS-ResourceSet (upper signaling) is “nonCodebook”, non-codebook-based PUSCH transmission may be scheduled for the UE through DCI format 0_1.

With regard to the SRS resource set wherein the value of usage inside SRS-ResourceSet (upper signaling) is “nonCodebook”, one connected NZP CSI-RS resource (non-zero power CSI-RS) may be configured for the UE. The UE may calculate a precoder for SRS transmission by measuring the NZP CSI-RS resource connected to the SRS resource set. If the difference between the last received symbol of an aperiodic NZP CSI-RS resource connected to the SRS resource set and the first symbol of aperiodic SRS transmission in the UE is less than 42 symbols, the UE does not expect that information regarding the precoder for SRS transmission will be updated.

If the configured value of resourceType inside SRS-ResourceSet (upper signaling) is “aperiodic”, the connected NZP CSI-RS may be indicated by an SRS request which is a field inside DCI format 0_1 or 1_1. If the connected NZP CSI-RS resource is an aperiodicNZP CSI-RS resource, the existence of the connectedNZP CSI-RS may be indicated with regard to the case in which the value of SRS request (a field inside DCI format 0_1 or 1_1) is not “00”. The corresponding DCI should not indicate cross carrier or cross BWP scheduling. In addition, if the value of SRS request indicates the existence of a NZP CSI-RS, the NZP CSI-RS may be positioned in the slot used to transmit the PDCCH including the SRS request field. In this case, TCI states configured for the scheduled subcarrier may not be configured as QCL-TypeD.

If there is a periodic or semi-persistent SRS resource set configured, the connected NZP CSI-RS may be indicated through associated CSI-RS inside SRS-ResourceSet (upper signaling). With regard to non-codebook-based transmission, the UE may not expect that spatialRelationInfo which is upper signaling regarding the SRS resource and associated CSI-RS inside SRS-ResourceSet (upper signaling) will be configured together.

If multiple SRS resources are configured for the UE, the UE may determine a precoder to be applied to PUSCH transmission and the transmission rank, based on an SRI indicated by the base station. The SRI may be indicated through the SRS resource indicator (a field inside DCI) or configured through srs-ResourceIndicator (upper signaling). Similarly to the above-described codebook-based PUSCH transmission, if the UE is provided with the SRI through DCI, the SRS resource indicated by the corresponding SRI refers to the SRS resource corresponding to the SRI, among SRS resources transmitted prior to the PDCCH including the corresponding SRI. The UE may use one or multiple SRS resources for SRS transmission, and the maximum number of SRS resources that can be transmitted simultaneously in the same symbol inside one SRS resource set and the maximum number of SRS resources are determined by UE capability reported to the base station by the UE. SRS resources simultaneously transmitted by the UE occupy the same RB. The UE configures one SRS port for each SRS resource. There may be only one configured SRS resource set wherein the value of usage inside SRS-ResourceSet (upper signaling) is “nonCodebook”, and a maximum of four SRS resources may be configured for non-codebook-based PUSCH transmission.

The base station may transmit one NZP-CSI-RS connected to the SRS resource set to the UE, and the UE may calculate the precoder to be used when transmitting one or multiple SRS resources inside the corresponding SRS resource set, based on the result of measurement when the corresponding NZP-CSI-RS is received. The UE may apply the calculated precoder when transmitting, to the base station, one or multiple SRS resources inside the SRS resource set wherein the configured usage is “nonCodebook”, and the base station may select one or multiple SRS resources from the received one or multiple SRS resources. In connection with the non-codebook-based PUSCH transmission, the SRI may indicate an index that may express one SRS resource or a combination of multiple SRS resources. The number of SRS resources indicated by the SRI transmitted by the base station may be the number of transmission layers of the PUSCH, and the UE may transmit the PUSCH by applying the precoder applied to SRS resource transmission to each layer.

### [PUSCH: Preparation Procedure Time]

Next, a PUSCH preparation procedure time will be described. If a base station schedules a UE so as to transmit a PUSCH by using DCI format 0_0, 0_1, or 0_2, the UE may require a PUSCH preparation procedure time such that a PUSCH is transmitted by applying a transmission method (SRS resource transmission precoding method, the number of transmission layers, spatial domain transmission filter) indicated through DCI. The PUSCH preparation procedure time is defined in NR in consideration thereof. The PUSCH preparation procedure time of the UE may follow Equation 4 given below.

$${T}_{proc , 2} = max ( ( {N}_{2} + {d}_{2 , 1} + {d}_{2} ) ( 2048 + 144 ) κ {2}^{- μ} {T}_{c} + {T}_{ext} + {T}_{switch} , {d}_{2 , 2} ) \qquad [ Equation 4 ]$$

Each parameter in T_{proc,2} described above in Equation 4 may have the following meaning.
N₂: the number of symbols determined according to UE processing capability 1 or 2, based on the UE's capability, and numerology μ. N₂ may have a value in Table 40 if UE processing capability 1 is reported according to the UE's capability report, and may have a value in Table 41 if UE processing capability 2 is reported, and if availability of UE processing capability 2 is configured through upper layer signaling.

TABLE 27

| μ | PUSCH preparation time N₂ [symbols] |
|---|---|
| 0 | 10 |
| 1 | 12 |
| 2 | 23 |
| 3 | 36 |

TABLE 28

| μ | PUSCH preparation time N₂ [symbols] |
|---|---|
| 0 | 5 |
| 1 | 5.5 |
| 2 | 11 for frequency range 1 |

d_{2,1}: the number of symbols determined to be 0 if all resource elements of the first OFDM symbol of PUSCH transmission include DM-RSs, and to be 1 otherwise.
κ: 64
μ: follows a value, among μ_{DL} and μ_{UL}, which makes T_{proc,2} larger. μ_{DL} refers to the numerology of a downlink used to transmit a PDCCH including DCI that schedules a PUSCH, and μ_{UL} refers to the numerology of an uplink used to transmit a PUSCH.
T_{c}: has 1/(Δfₘₐₓ·N_{f}), Δfₘₐₓ=480·b 10³ Hz, N_{f}=4096.
d_{2,2}: follows a BWP switching time if DCI that schedules a PUSCH indicates BWP switching, and has 0 otherwise.
d₂: if OFDM symbols overlap temporally between a PUSCH having a high priority index and a PUCCH having a low priority index, the d₂ value of the PUSCH having a high priority index is used. Otherwise, d₂ is 0.
Tₑₓₜ: if the UE uses a shared spectrum channel access scheme, the UE may calculate Tₑₓₜ and apply the same to a PUSCH preparation procedure time. Otherwise, Tₑₓₜ is assumed to be 0.
T_{switch}: if an uplink switching spacing has been triggered, T_{switch} is assumed to be the switching spacing time. Otherwise, T_{switch} is assumed to be 0.

The base station and the UE may determine that the PUSCH preparation procedure time is insufficient if the first symbol of a PUSCH starts earlier than the first uplink symbol in which a CP starts after T_{proc,2} from the last symbol of a PDCCH including DCI that schedules the PUSCH, in view of the influence of timing advance between the uplink and the downlink and time domain resource mapping information of the PUSCH scheduled through the DCI. Otherwise, the base station and the UE determine that the PUSCH preparation procedure time is sufficient. The UE may transmit the PUSCH only if the PUSCH preparation procedure time is sufficient, and may ignore the DCI that schedules the PUSCH if the PUSCH preparation procedure time is insufficient.

### [PUSCH: Regarding Repetition Transmission]

Hereinafter, repetition transmission of an uplink data channel in a 5G system will be described in detail. A 5G system supports two types of uplink data channel repetition transmission methods, PUSCH repetition type A transmission and PUSCH repetition type B transmission. One of PUSCH repetition type A transmission and PUSCH repetition type B transmission may be configured for a UE through upper layer signaling.

### PUSCH Repetition Type a Transmission

As described above, the symbol length of an uplink data channel and the location of the start symbol may be determined by a time domain resource allocation method in one slot, and a base station may notify a UE of the number of repetition transmissions through upper layer signaling (for example, RRC signaling) or L1 signaling (for example, DCI).
Based on the number of repetition transmissions received from the base station, the UE may repetitively transmit an uplink data channel having the same length and start symbol as the configured uplink data channel, in a continuous slot. If the base station configured a slot as a downlink for the UE, or if at least one of symbols of the uplink data channel configured for the UE is configured as a downlink, the UE may omit uplink data channel transmission, but may count the number of repeated transmissions of the uplink data channel.

### PUSCH Repetition Type B Transmission

As described above, the symbol length of an uplink data channel and the location of the start symbol may be determined by a time domain resource allocation method in one slot, and a base station may notify a UE of the number of repetition transmissions through upper layer signaling (for example, RRC signaling) or L1 signaling (for example, DCI).
The nominal repetition of the uplink data channel is determined as follows, based on the previously configured start symbol and length of the uplink data channel. The slot in which the n^{th} nominal repetition starts is given by

$${K}_{s} + ⌊ \frac{S + n \cdot L}{{N}_{symb}^{slot}} ⌋ ,$$

and the symbol starting in that slot is given by

$$mod ( S + n \cdot L , {N}_{symb}^{slot} ) .$$

The slot in which the n^{th} nominal repetition ends is given by

$${K}_{s} + ⌊ \frac{S + ( n + 1 ) \cdot L - 1}{{N}_{symb}^{slot}} ⌋ ,$$

and the symbol ending in that slot is given by

$$mod ( S + ( n + 1 ) \cdot L - 1 , {N}_{symb}^{slot} ) .$$

In this regard, n=0, . . . , numberofrepetitions-1, S refers to the start symbol of the configured uplink data channel, and L refers to the symbol length of the configured uplink data channel. Kₛ refers to the slot in which PUSCH transmission starts, and

$${N}_{symb}^{slot}$$

refers to the number of symbols per slot.
The UE may determine an invalid symbol for PUSCH repetition type B transmission. A symbol configured as a downlink by tdd-UL-DL-ConfigurationCommon or tdd-UL-DL-ConfigurationDedicated may be determined as the invalid symbol for PUSCH repeated transmission type B. Additionally, the invalid symbol may be configured in an upper layer parameter (for example, InvalidSymbolPattern). The upper layer parameter (for example, InvalidSymbolPattern) may provide a symbol level bitmap across one or two slots, thereby configuring the invalid symbol. In the bitmap, 1 may represent the invalid symbol. Additionally, the periodicity and pattern of the bitmap may be configured through the upper layer parameter (for example, InvalidSymbolPattern). If an upper layer parameter (for example, InvalidSymbolPattern) is configured, and if parameter InvalidSymbolPatternIndicator-ForDCIFormat0_1 or InvalidSymbolPatternIndicator-ForDCIFormat0_2 is not configured, the UE may apply the invalid symbol pattern. If an upper layer parameter (for example, InvalidSymbolPattern) is configured, and if parameter InvalidSymbolPattemIndicator-ForDCIFormat0_1 or InvalidSymbolPattemIndicator-ForDCIFormat0_2 is not configured, the UE may apply the invalid symbol pattern.

After an invalid symbol is determined, the UE may consider, with regard to each nominal repetition, that symbols other than the invalid symbol are valid symbols. If one or more valid symbols are included in each nominal repetition, the nominal repetition may include one or more actual repetitions. Each actual repetition may include a set of consecutive valid symbols available for PUSCH repeated transmission type B in one slot.

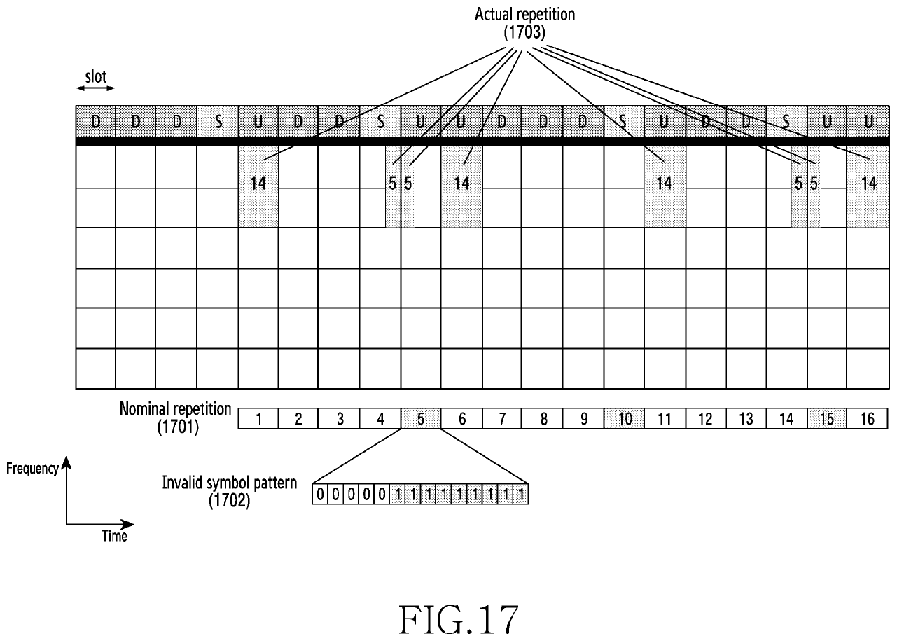

FIG. 17 illustrates PUSCH repetition type B transmission in a wireless communication system according to an embodiment of the disclosure. The UE may receive the following configurations: the start symbol S of an uplink data channel is 0, the length L of the uplink data channel is 14, and the number of repeated transmissions is 16. In this case, nominal repetitions may appear in 16 consecutive slots (% n). Thereafter, the UE may determine that the symbol configured as a downlink symbol in each nominal repetition 1701 is an invalid symbol. The UE may determine that symbols configured as 1 in the invalid symbol pattern 1702 are invalid symbols. If valid symbols other than invalid symbols in respective nominal repetitions constitute one or more consecutive symbols in one slot, they may be configured and transmitted as actual repetitions (1703).

In addition, with regard to PUSCH repeated transmission, additional methods may be defined in NR Release 16 with regard to UL grant-based PUSCH transmission and configured grant-based PUSCH transmission, across slot boundaries, as follows:
Method 1 (mini-slot level repetition): through one UL grant, two or more PUSCH repetition transmissions are scheduled inside one slot or across the boundary of consecutive slots. In connection with method 1, time domain resource allocation information inside DCI indicates resources of the first repetition transmission. In addition, time domain resource information of remaining repetition transmissions may be determined according to time domain resource information of the first repetition transmission, and the uplink or downlink direction determined with regard to each symbol of each slot. Each repetition transmission occupies consecutive symbols.
Method 2 (multi-segment transmission): through one UL grant, two or more PUSCH repetition transmissions are scheduled in consecutive slots. Transmission no. 1 is designated for each slot, and the start point or repetition length differs between respective transmissions. In method 2, time domain resource allocation information inside DCI indicates the start point and repetition length of all repetition transmissions. In the case of performing repetition transmissions inside a single slot through method 2, if there are multiple bundles of consecutive uplink symbols in the corresponding slot, respective repetition transmissions may be performed with regard to respective uplink symbol bundles. If there is a single bundle of consecutive uplink symbols in the corresponding slot, PUSCH repetition transmission is performed once according to the method of NR Release 15.
Method 3: two or more PUSCH repetition transmissions are scheduled in consecutive slots through two or more UL grants. Transmission no. 1 may be designated with regard to each slot, and the nth UL grant may be received before PUSCH transmission scheduled by the (n−1)th UL grant is over.
Method 4: through one UL grant or one configured grant, one or multiple PUSCH repetition transmissions inside a single slot, or two or more PUSCH repetition transmissions across the boundary of consecutive slots may be supported. The number of repetitions indicated to the UE by the base station is only a nominal value, and the UE may actually perform a larger number of PUSCH repetition transmissions than the nominal number of repetitions. Time domain resource allocation information inside DCI or configured grant may refer to resources of the first repeated transmission indicated by the base station. Time domain resource information of remaining repetition transmissions may be determined with reference to resource information of the first repetition transmission and the uplink or downlink direction of symbols. If time domain resource information of repetition transmission indicated by the base station spans a slot boundary or includes an uplink/downlink switching point, the corresponding repetition transmission may be divided into multiple repeated transmissions. One repetition transmission may be included in one slot with regard to each uplink period.

### [PUSCH: Frequency Hopping Process]

Hereinafter, frequency hopping of a physical uplink shared channel (PUSCH) in a 5G system will be described in detail.

5G may support two kinds of PUSCH frequency hopping methods with regard to each PUSCH repeated transmission type. First of all, in PUSCH repeated transmission type A, intra-slot frequency hopping and inter-slot frequency hopping are supported, and in PUSCH repeated transmission type B, inter-repetition frequency hopping and inter-slot frequency hopping are supported. Obviously, the example given above is not limiting.

The intra-slot frequency hopping method supported in PUSCH repetition type A transmission may include a method in which a UE transmits allocated resources in the frequency domain, after changing the same by a configured frequency offset, by two hops in one slot. The start RB of each hop in connection with intra-slot frequency hopping may be expressed by Equation 5 below:

$${RB}_{start} = \{ \begin{matrix}{RB}_{start} & i = 0 \\ ( {RB}_{start} + {RB}_{offset} ) mod {N}_{BWP}^{size} & i = 1\end{matrix} \qquad [ Equation 5 ]$$

In Equation 5, i=0 and i=1 may denote the first and second hops, respectively, and RBₛₜₐᵣₜ may denote the start RB in a UL BWP and may be calculated from a frequency resource allocation method. RB_{offset} denotes a frequency offset between two hops through an upper layer parameter. The number of symbols of the first hop may be represented by

$$⌊ {N}_{symb}^{PUSCH , s} / 2 ⌋ ,$$

and number of symbols of the second hop may be represented by

$${N}_{symb}^{PUSCH , s} - ⌊ {N}_{symb}^{PUSCH , s} / 2 ⌋ . {N}_{symb}^{PUSCH , s}$$

is the length of PUSCH transmission in one slot and is expressed by the number of OFDM symbols. Next, the inter-slot frequency hopping method supported in PUSCH repetition type A and type B transmissions is a method in which the UE transmits allocated resources in the frequency domain, after changing the same by a configured frequency offset, in each slot. The start RB during slot

$${n}_{s}^{μ}$$

in connection with inter-slot frequency hopping may be expressed by Equation 6 below.

$${RB}_{start} ( {n}_{s}^{μ} ) = \{ \begin{matrix}{RB}_{start} & {n}_{s}^{μ} mod 2 = 0 \\ ( {RB}_{start} + {RB}_{offset} ) mod {N}_{BWP}^{size} & {n}_{s}^{μ} mod 2 = 1\end{matrix} \qquad [ Equation 6 ]$$

In Equation 6,

$${n}_{s}^{μ}$$

denotes the current slot number during multi-slot PUSCH transmission, and RBₛₜₐᵣₜ denotes the start RB inside a UL BWP and is calculated from a frequency resource allocation method. RB_{offset} denotes a frequency offset between two hops through an upper layer parameter.

The inter-repetition frequency hopping method supported in PUSCH repeated transmission type B may be a method in which resources allocated in the frequency domain regarding one or multiple actual repetitions in each nominal repetition are moved by a configured frequency offset and then transmitted. The index RBₛₜₐᵣₜ₍ₙ₎ of the start RB in the frequency domain regarding one or multiple actual repetitions in the nth nominal repetition may follow Equation 7 given below.

$${RB}_{start} ( {n}_{s}^{μ} ) = \{ \begin{matrix}{RB}_{start} & n mod 2 = 0 \\ ( {RB}_{start} + {RB}_{offset} ) mod {N}_{BWP}^{size} & n mod 2 = 1\end{matrix} \qquad [ Equation 7 ]$$

In Equation 7, n denotes the index of nominal repetition, and RB_{offset} denotes an RB offset between two hops through an upper layer parameter.

### [Regarding UE Capability Report]

In LTE and NR, a UE may perform a procedure in which, while being connected to a serving base station, the UE may report capability supported by the UE to the corresponding base station. In the following description, the above-described procedure will be referred to as a UE capability report.

The base station may transfer a UE capability enquiry message to a UE in a connected state so as to request a capability report. The message may include a UE capability request with regard to each radio access technology (RAT) type of the base station. The RAT type-specific request may include supported frequency band combination information and the like. In addition, in the case of the UE capability enquiry message, UE capability with regard to multiple RAT types may be requested through one RRC message container transmitted by the base station, or the base station may transfer a UE capability enquiry message including multiple UE capability requests with regard to respective RAT types. That is, a capability enquiry may be repeated multiple times in one message, and the UE may configure a UE capability information message corresponding thereto and report the same multiple times. In next-generation mobile communication systems, a UE capability request may be made regarding multi-RAT dual connectivity (MR-DC), such as NR, LTE, E-UTRA-NR dual connectivity (EN-DC). The UE capability enquiry message may be transmitted initially after the UE is connected to the base station, in general, but may be requested in any condition if needed by the base station.

According to an embodiment, upon receiving the UE capability report request from the base station, the UE may configure UE capability according to band information and RAT type requested by the base station. The method in which the UE configures UE capability in an NR system is summarized below:

1. If the UE receives a list regarding LTE and/or NR bands from the base station at a UE capability request, the UE may construct band combinations (BCs) regarding EN-DC and NR standalone (SA). That is, the UE may configure a candidate list of BCs regarding EN-DC and NR SA, based on bands received from the base station at a request through FreqBandList. In addition, bands may have priority in the order described in FreqBandList.

2. If the base station has set “eutra-nr-only” flag or “eutra” flag and requested a UE capability report, the UE may remove everything related to NR SA BCs from the configured BC candidate list. Such an operation may occur only if an LTE base station (eNB) requests “eutra” capability.

3. The UE may then remove fallback BCs from the BC candidate list configured in the above step. As used herein, a fallback BC refers to a BC that can be obtained by removing a band corresponding to at least one SCell from a specific BC, and since a BC before removal of the band corresponding to at least one SCell can already cover a fallback BC, the same can be omitted. This step may be applied in MR-DC as well, that is, LTE bands may also be applied. BCs remaining after the above step may constitute the final “candidate BC list”.

4. The UE may select BCs appropriate for the requested RAT type from the final “candidate BC list” and select BCs to report. In this step, the UE may configure supportedBandCombinationList in a determined order. That is, the UE may configure BCs and UE capability to report according to a preconfigured rat-Type order. (nr->eutra-nr->eutra). In addition, the UE may configure featureSetCombination regarding the configured supportedBandCombinationList and configures a list of “candidate feature set combinations” from a candidate BC list from which a list regarding fallback BCs (including capability of the same or lower step) is removed. The “candidate feature set combinations” may include all feature set combinations regarding NR and EUTRA-NR BCs, and may be obtained from feature set combinations of containers of UE-NR-Capabilities and UE-MRDC-Capabilities.

5. If the requested RAT type is eutra-nr and has an influence, featureSetCombinations may be included on both containers of UE-MRDC-Capabilities and UE-NR-Capabilities. However, the feature set of NR may be included only in UE-NR-Capabilities.

After the UE capability is configured, the UE may transfer a UE capability information message including the UE capability to the base station. The base station may perform scheduling and transmission/reception management appropriate for the UE, based on the UE capability received from the UE.

### [Regarding CA/DC]

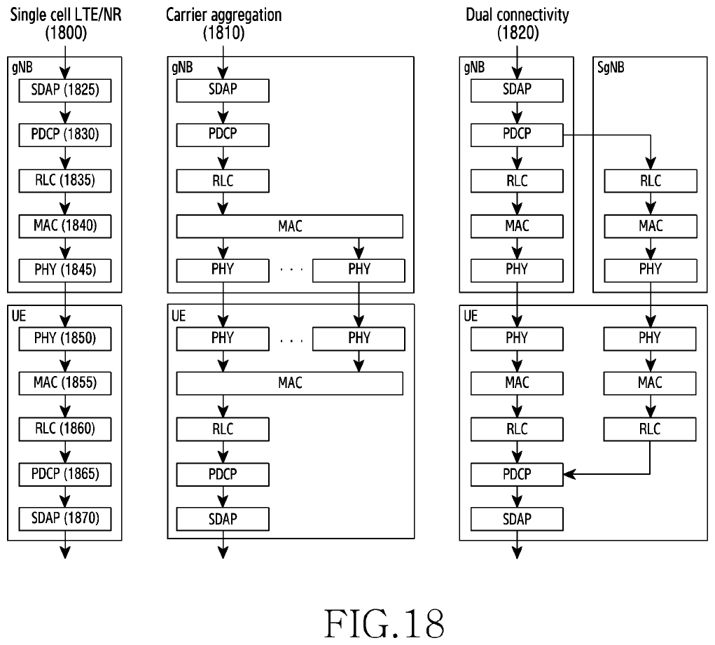

FIG. 18 illustrates radio protocol structures of a base station and a UE in single cell, carrier aggregation, and dual connectivity situations according to an embodiment of the disclosure.

Referring to FIG. 18, the radio protocol of a next-generation mobile communication system includes an NR service data adaptation protocol (SDAP) 1825 or 1870, an NR packet data convergence protocol (PDCP) 1830 or 1865, an NR radio link control (RLC) 1835 or 1860, and an NR medium access controls (MAC) 1840 or 1855, on each of UE and NR base station sides. Obviously, the above example is not limiting, and the radio protocol may include a larger or smaller number of layers.

The main functions of the NR SDAP 1825 or 1870 may include some of functions below. Obviously, the examples given below are not limiting.
Transfer of user plane data
Mapping between a QoS flow and a DRB for both DL and UL
Marking QoS flow ID in both DL and UL packets
Reflective QoS flow to DRB mapping for the UL SDAP PDUs

With regard to the SDAP layer device 1825 or 1875, whether to use the header of the SDAP layer device or whether to use functions of the SDAP layer device may be configured for the UE through an RRC message according to PDCP layer devices or according to bearers or according to logical channels. If an SDAP header is configured, the non-access stratum (NAS) quality of service (QoS) reflection configuration 1-bit indicator (NAS reflective QoS) of the SDAP header and the access stratum (AS) QoS reflection configuration 1-bit indicator (AS reflective QoS) may indicate, to the UE, that the UE can update or reconfigure mapping information regarding the QoS flow and data bearer of the uplink and downlink. The SDAP header may include QoS flow ID information indicating the QoS. The QoS information may be used as data processing priority, scheduling information, etc. for smoothly supporting services.

The main functions of the NR PDCP 1830 or 1865 may include some of the following functions: below. Obviously, the examples given below are not limiting.
Header compression and decompression: robust header compression (ROHC) only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

The reordering of the NR PDCP device 1830 or 1865 refers to a function of reordering PDCP PDUs received from a lower layer in an order based on the PDCP sequence number (SN), and may include a function of transferring data to an upper layer in the reordered sequence. Alternatively, the reordering of the NR PDCP device 1830 or 1865 may include a function of instantly transferring data without considering the order, may include a function of recording PDCP PDUs lost as a result of reordering, may include a function of reporting the state of the lost PDCP PDUs to the transmitting side, and may include a function of requesting retransmission of the lost PDCP PDUs.

The main functions of the NR RLC 1835 or 1860 may include some of functions below. Obviously, the examples given below are not limiting.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The in-sequence delivery of the NR RLC device 1835 or 1860 may refer to a function of successively delivering RLC SDUs, received from the lower layer, to the upper layer. The in-sequence delivery of the NR RLC device may include at least one of a function of, if one original RLC SDU is segmented into multiple RLC SDUs and the segmented RLC SDUs are received, reassembling the RLC SDUs and delivering the reassembled RLC SDUs, a function of reordering the received RLC PDUs with reference to the RLC sequence number (SN) or PDCP sequence number (SN), a function of recording RLC PDUs lost as a result of reordering, a function of reporting the state of the lost RLC PDUs to the transmitting side, and a function of requesting retransmission of the lost RLC PDUs. The in-sequence delivery function of the NR RLC device 1835 or 1860 may include at least one of a function of, if there is a lost RLC SDU, successively delivering only RLC SDUs before the lost RLC SDU to the upper layer, and a function of, if a predetermined timer has expired although there is a lost RLC SDU, successively delivering all RLC SDUs received before the timer was started to the upper layer. Alternatively, the in-sequence delivery of the NR RLC device may include a function of, if a predetermined timer has expired although there is a lost RLC SDU, successively delivering all currently received RLC SDUs to the upper layer.

In addition, the in-sequence delivery of the NR RLC device 1835 or 1860 may include a function of processing RLC PDUs in the received order (regardless of the sequence number order, in the order of arrival) and delivering same to the PDCP device regardless of the order (out-of-sequence delivery), and may include a function of, in the case of segments, receiving segments which are stored in a buffer or which are to be received later, reconfiguring same into one complete RLC PDU, processing, and delivering same to the PDCP device.

The NR RLC device (or NR RLC layer) 1835 or 1860 may include no concatenation function, which may be performed in the NR MAC layer or replaced with a multiplexing function of the NR MAC layer.

The out-of-sequence delivery of the NR RLC device 1835 or 1860 refers to a function of instantly delivering RLC SDUs received from the lower layer to the upper layer regardless of the order, may include a function of reassembling and delivering multiple RLC SDUs received, into which one original RLC SDU has been segmented, and may include a function of storing the RLC SN or PDCP SN of received RLC PDUs, and recording RLC PDUs lost as a result of reordering.

The NR MAC 1840 or 1855 may be connected to multiple NR RLC layer devices configured in one UE, and the main functions of the NR MAC may include some of functions below. Obviously, the examples given below are not limiting.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

An NR PHY layer 1845 or 1850 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer. Obviously, the example given above is not limiting.

The detailed structure of the radio protocol structure may be variously changed according to the carrier (or cell) operating scheme. For example, in case that the base station transmits data to the UE, based on a single carrier (or cell), the base station and the UE may use a protocol structure having a single structure with regard to each layer, such as 400. On the other hand, in case that the base station transmits data to the UE, based on carrier aggregation (CA) which uses multiple carriers in a single TRP, the base station and the UE may use a protocol structure which has a single structure up to the RLC, but multiplexes the PHY layer through a MAC layer, such as 410. As another example, in case that the base station transmits data to the UE, based on dual connectivity (DC) which uses multiple carriers in multiple TRPs, the base station and the UE may use a protocol structure which has a single structure up to the RLC, but multiplexes the PHY layer through a MAC layer, such as 420.

### [Regarding SRS]

Next, an uplink channel estimation method using sounding reference signal (SRS) transmission of a UE will be described. The base station may configure at least one SRS configuration with regard to each uplink BWP in order to transfer configuration information for SRS transmission to the UE, and may also configure as least one SRS resource set with regard to each SRS configuration. As an example, the base station and the UE may exchange upper signaling information as follows, in order to transfer information regarding the SRS resource set.
srs-ResourceSetId: an SRS resource set index
srs-ResourceIdList: a set of SRS resource indices referred to by SRS resource sets
resourceType: time domain transmission configuration of SRS resources referred to by SRS resource sets, and may be configured as one of “periodic”, “semi-persistent”, and “aperiodic”. If configured as “periodic” or “semi-persistent”, associated CSI-RS information may be provided according to the place of use of SRS resource sets. If configured as “aperiodic”, an aperiodic SRS resource trigger list/slot offset information may be provided, and associated CSI-RS information may be provided according to the place of use of SRS resource sets.
usage: a configuration regarding the place of use of SRS resources referred to by SRS resource sets, and may be configured as one of “beamManagement”, “codebook”, “nonCodebook”,and “antennaSwitching”.
alpha, p0, pathlossReferenceRS, srs-PowerControlAdjustmentStates: provides a parameter configuration for adjusting the transmission power of SRS resources referred to by SRS resource sets.

The UE may understand that an SRS resource included in a set of SRS resource indices referred to by an SRS resource set follows the information configured for the SRS resource set.

In addition, the base station and the UE may transmit/receive upper layer signaling information in order to transfer individual configuration information regarding SRS resources. As an example, the individual configuration information regarding SRS resources may include time-frequency domain mapping information inside slots of the SRS resources, and this may include information regarding intra-slot or inter-slot frequency hopping of the SRS resources. In addition, the individual configuration information regarding SRS resources may include time domain transmission configuration of SRS resources, and may be configured as one of “periodic”, “semi-persistent”, and “aperiodic” The time domain transmission configuration of SRS resources may be limited to have the same time domain transmission configuration as the SRS resource set including the SRS resources. If the time domain transmission configuration of SRS resources is configured as “periodic” or “semi-persistent”, the time domain transmission configuration may further include an SRS resource transmission cycle and a slot offset (for example, periodicityAndOffset).

The base station may activate or deactivate SRS transmission for the UE through upper layer signaling including RRC signaling or MAC CE signaling, or L1 signaling (for example, DCI). For example, the base station may activate or deactivate periodic SRS transmission for the UE through upper layer signaling. The base station may indicate activation of an SRS resource set having resourceType configured as “periodic” through upper layer signaling, and the UE may transmit the SRS resource referred to by the activated SRS resource set. Intra-slot time-frequency domain resource mapping of the transmitted SRS resource follows resource mapping information configured for the SRS resource, and slot mapping, including the transmission cycle and slot offset, follows periodicityAndOffset configured for the SRS resource. In addition, the spatial domain transmission filter applied to the transmitted SRS resource may refer to spatial relation info configured for the SRS resource, or may refer to associated CSI-RS information configured for the SRS resource set including the SRS resource. The UE may transmit the SRS resource inside the uplink BWP activated with regard to the periodic SRS resource activated through upper layer signaling.

For example, the base station may activate or deactivate semi-persistent SRS transmission for the UE through upper layer signaling. The base station may indicate activation of an SRS resource set through MAC CE signaling, and the UE may transmit the SRS resource referred to by the activated SRS resource set. The SRS resource set activated through MAC CE signaling may be limited to an SRS resource set having resourceType configured as “semi-persistent”. Intra-slot time-frequency domain resource mapping of the transmitted SRS resource follows resource mapping information configured for the SRS resource, and slot mapping, including the transmission cycle and slot offset, follows periodicityAndOffset configured for the SRS resource.

In addition, the spatial domain transmission filter applied to the transmitted SRS resource may refer to spatial relation info configured for the SRS resource, or may refer to associated CSI-RS information configured for the SRS resource set including the SRS resource. If the SRS resource has spatial relation info configured therefor, the spatial domain transmission filter may be determined, without following the same, by referring to configuration information regarding spatial relation info transferred through MAC CE signaling that activates semi-persistent SRS transmission. The UE may transmit the SRS resource inside the uplink BWP activated with regard to the semi-persistent SRS resource activated through upper layer signaling.

For example, the base station may trigger aperiodic SRS transmission by the UE through DCI. The base station may indicate one of aperiodic SRS triggers (aperiodicSRS-ResourceTrigger) through the SRS request field of DCI. The UE may understand that the SRS resource set including the aperiodic SRS resource trigger indicated through DCI in the aperiodic SRS resource trigger list, among configuration information of the SRS resource set, has been triggered. The UE may transmit the SRS resource referred to by the triggered SRS resource set. Intra-slot time-frequency domain resource mapping of the transmitted SRS resource may follow resource mapping information configured for the SRS resource. Slot mapping of the transmitted SRS resource may be determined by the slot offset between the SRS resource and a PDCCH including DCI, and this may refer to value(s) included in the slot offset set configured for the SRS resource set.

Specifically, as the slot offset between the SRS resource and the PDCCH including DCI, a value indicated in the time domain resource assignment field of DCI, among offset value(s) included in the slot offset set configured for the SRS resource set, may be applied. In addition, the spatial domain transmission filter applied to the transmitted SRS resource may refer to spatial relation info configured for the SRS resource, or may refer to associated CSI-RS information configured for the SRS resource set including the SRS resource. The UE may transmit the SRS resource inside the uplink BWP activated with regard to the aperiodic SRS resource triggered through DCI.

If the base station triggers aperiodic SRS transmission by the UE through DCI, a minimum time interval may be necessary between the transmitted SRS and the PDCCH including the DCI that triggers aperiodic SRS transmission, in order for the UE to transmit the SRS by applying configuration information regarding the SRS resource. The time interval for SRS transmission by the UE may be defined as the number of symbols between the last symbol of the PDCCH including the DCI that triggers aperiodic SRS transmission and the first symbol mapped to the first transmitted SRS resource among transmitted SRS resource(s). The minimum time interval may be determined with reference to the PUSCH preparation procedure time needed by the UE to prepare PUSCH transmission. In addition, the minimum time interval may have a different value depending on the place of use of the SRS resource set including the transmitted SRS resource. For example, the minimum time interval may be determined as N2 symbols defined in consideration of UE processing capability that follows the UE's capability with reference to the UE's PUSCH preparation procedure time. In addition, if the place of use of the SRS resource set is configured as “codebook” or “antennaSwitching” in view of the place of use of the SRS resource set including the transmitted SRS resource, the minimum time interval may be determined as N2 symbols, and if the place of use of the SRS resource set is configured as “nonCodebook” or “‘beamManagement”, the minimum time interval may be determined as N₂₊₁₄ symbols. The UE may transmit an aperiodic SRS if the time interval for aperiodic SRS transmission is larger than or equal to the minimum time interval, and may ignore the DCI that triggers the aperiodic SRS if the time interval for aperiodic SRS transmission is smaller than the minimum time interval.

TABLE 29

| | |
|---|---|
| SRS-Resource ::= | SEQUENCE { |
| srs-ResourceId | SRS-ResourceId, |
| nrofSRS-Ports | ENUMERATED {port1, ports2, ports4}, |
| ptrs-PortIndex | ENUMERATED {n0, n1 } |

OPTIONAL, -- Need R

| | |
|---|---|
| transmissionComb | CHOICE { |
| n2 | SEQUENCE { |
| combOffset-n2 | INTEGER (0..1), |
| cyclicShift-n2 | INTEGER (0..7) |

},

| | |
|---|---|
| n4 | SEQUENCE { |
| combOffset-n4 | INTEGER (0..3), |
| cyclicShift-n4 | INTEGER (0..11) |

```
        }
    },
```

| | |
|---|---|
| resourceMapping | SEQUENCE { |
| startPosition | INTEGER (0..5), |
| nrofSymbols | ENUMERATED {n1, n2, n4}, |
| repetitionFactor | ENUMERATED {n1, n2, n4} |

},

| | |
|---|---|
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |

},

| | |
|---|---|
| groupOrSequenceHopping | ENUMERATED { neither, groupHopping, |

quenceHopping },

| | |
|---|---|
| resourceType | CHOICE { |
| aperiodic | SEQUENCE { |

```
            ...
        },
```

| | |
|---|---|
| semi-persistent | SEQUENCE { |
| periodicityAndOffset-sp | SRS-PeriodicityAndOffset, |

```
            ...
        },
```

| | |
|---|---|
| periodic | SEQUENCE { |
| periodicityAndOffset-p | SRS-PeriodicityAndOffset, |

```
            ...
        }
    },
```

| | |
|---|---|
| sequenceId | INTEGER (0..1023), |
| spatialRelationInfo | SRS-SpatialRelationInfo |

```
  OPTIONAL, -- Need R
      ...
      [[
```

| | |
|---|---|
| resourceMapping-r16 | SEQUENCE { |
| startPosition-r16 | INTEGER (0, 13), |
| nrofSymbols-r16 | ENUMERATED {n1, n2, n4} |
| repetitionFactor-r16 | ENUMERATED {n1, n2, n4} |

```
        } OPTIONAL, -- Need R
      ]],
      [[
```

| | |
|---|---|
| spatialRelationInfo-PDC-r17 | SetRelease {SpatialRelationInfo=PDC-r17} |

OPTINAL, -- Need M

| | |
|---|---|
| resourceMapping-r17 | SEQUENCE { |
| startPosition-r17 | INTEGER (0, 13), |
| nrofSymbols-r17 | ENUMERATED {n1, n2, n4, n8, n10, n12, n14} |
| repetitionFactor-r17 | ENUMERATED {n1, n2, n4, n5, n6, n7, n8, n10, n12, n14}} |

} OPTIONAL, -- Need R

| | |
|---|---|
| partialFreqSounding-r17 | SEQUENCE { |
| startRBIndexFScaling-r17 | CHOICE { |

```
              startRBIndexAndFreqScalingFactor2-r17 INTEGER (0..1)
              startRBIndexAndFreqScalingFactor4-r17 INTEGER (0..3)
          },
          enableStartRBHopping-r17 ENUMERATED {enable} OPTIONAL, -- Need R
        } OPTIONAL, -- Need R
        transmissionComb-n8-r17 SEQUENCE {
            combOffset-n8-r17 INTEGER (0..7),
            cyclicShift-n8-r17 INTEGER (0..5)
        } OPTIONAL, -- Need R
        srs-TCIState-r17 CHOICE {
            srs-UL-TCIState-r17 TCI-UL-State-Id-r17,
            srs-DLorJoint-TCIState-r17 TCI-StateId
        } OPTIONAL, -- Need R
        ]]
      }
}
```

The following SRS parameters may be semi-statically configured by the higher layer parameter SRS-Resource.
srs-ResourceId determines an SRS resource configuration identifier.
The number of SRS ports may be configured by the higher layer parameter nrofSRS-Ports and may be configured to be 1, 2, or 4. If nrofSRS-Ports is not configured, nrofSRS-Ports is 1.
A time domain operation of SRS resource placement indicated by the higher layer parameter resourceType may be one of “periodic,” “semi-persistent,” and “aperiodic” SRS transmission.
If an SRS resource type is periodic or semi-persistent, a slot level period and a slot level offset are determined by the higher layer parameter periodicityAndOffset-p or periodicityAndOffset-sp. The UE expects that SRS resources in the same SRS resource set SRS-ResourceSet are not to configured according to different slot level periods. When the higher layer parameter resourceType is configured to be “aperiodic” for SRS-ResourceSet, a slot level offset is defined by the higher layer parameter slotOffset.
The number of OFDM symbols of an SRS resource, a start OFDM symbol in a slot, and repetition factor R are configured by the higher layer parameter resourceMapping. If R is not configured, R is the same as the number of OFDM symbols in an SRS resource.
The SRS bandwidths B_SRS and C_SRS are configured by the higher layer parameter freaHopping. If the parameter is not configured. B_SRS is 0.
The frequency hopping bandwidth b_hop is configured by the higher layer parameter freqHopping. If the parameter is configured, b_hop is 0.
A frequency domain position and a configurable shift are configured by the higher layer parameters freqDomainPosition and freqDomainShift, respectively. If freqDomainPosition is not configured, the value thereof is 0.
A cyclic prefix is configured for transmission comb values of 2, 4, and 8 by the higher layer parameters cyclicShift-n2, cyclicShift-n4, or cyclicShift-n8, respectively.
A transmission comb value is configured by the higher layer parameter transmissionComb.
A transmission comb offset is configured for transmission comb values of 2, 4, and 8 by the higher layer parameters combOffset-n2, combOffset-n4, or combOffset-n8, respectively.
An SRS sequence ID is configured by the higher layer parameter sequenceID.
Nₛ adjacent symbols (Nₛ=1, 2, or 4) in the last 6 symbols of a slot may be configured as an SRS resource of the UE through the higher layer parameter resourceMapping in SRS-Resource. Each symbol of the resource is mapped to all SRS antenna ports.
Nₛ adjacent symbols (Nₛ=1, 2, or 4) in all symbol positions in a slot may be configured, as an SRS time resource of the UE, for the UE by the base station through the higher layer parameter resourceMapping-r16 in SRS resource. In addition, one value of R (R=1, 2, or 4) is possible as repetitionFactor-r16, and R may be a divisor of N.
Nₛ adjacent symbols (Nₛ=1, 2, 4, 8, 10, 12, 14) in all symbol positions in a slot may be configured, as an SRS time resource of the UE, for the UE by the base station through the higher layer parameter resourceMapping-r17 in SRS resource. In addition, one value of 1, 2, 4, 5, 6, 7, 8, 10, 12, and 14, is possible as repetitionFactor-r17, and R may be a divisor of Nₛ.

spatialRelationInfo configuration information of [Table 29] may refer to one reference signal to allow beam information of the reference signal to be applied to a beam used for a corresponding SRS transmission. For example, a configuration of spatialRelationInfo may include information as shown [Table 30] below. However, the disclosure is not limited to the example below.

TABLE 30

| SRS-SpatialRelationInfo ::= | SEQUENCE { | |
|---|---|---|
| servingCellId | ServCellIndex | OPTIONAL, -- |

Need S

| | |
|---|---|
| referenceSignal | CHOICE { |
| ssb-Index | SSB-Index, |
| csi-RS-Index | NZP-CSI-RS-ResourceId, |
| srs | SEQUENCE { |
| resourceId | SRS-ResourceId, |
| uplinkBWP | BWP-Id |

```
    }
  }
}
```

When referring to a spatialRelationInfo configuration, an SS/PBCH block index, a CSI-RS index, or an SRS index may be configured for the UE by the base station as an index of a particular reference signal to be referenced for using beam information of the reference signal. The higher signaling referenceSignal is configuration information indicating a reference signal, beam information of which is to be referenced for a corresponding SRS transmission, and ssb-Index, csi-RS-Index, and srs may indicate an index of an SS/PBCH block, an index of a CSI-RS, and an index of an SRS, respectively. If a value of the higher signaling referenceSignal is configured to be “ssb-Index”, the UE may apply a reception beam having been used to receive an SS/PBCH block corresponding to ssb-Index as a transmission beam of a corresponding SRS transmission. If a value of the higher signaling referenceSignal is configured to be “csi-RS-Index”, the UE may apply a reception beam having been used to receive a CSI-RS corresponding to csi-RS-Index as a transmission beam of a corresponding SRS transmission. If a value of the higher signaling referenceSignal is configured to be “srs”, the UE may apply a transmission beam having been used to transmit an SRS corresponding to srs as a transmission beam of a corresponding SRS transmission.

A TCI state being used for a beam indication of a downlink channel (an indication of a reception space filter value/type of the UE) and SpatialRelationInfo being used for a beam indication of an uplink channel (an indication of a transmission space filter value/type of the UE) have been illustrated, but this does not imply a restriction based on an uplink or downlink type and it should be noted that mutual expansion is possible in the future. For example, the conventional downlink TCI state (DL TCI state) may be extended to uplink TCI state (UL TCI state) through a method of adding an uplink channel or signal to a type of a target RS capable of referencing TCI state or adding an uplink channel or signal to a type of referenceSignal (reference RS) included in TCI state or QCL-Info. According to an embodiment, the base station may configure, for the UE, a higher layer signaling parameter, such as srs-TCIState-r17 in [Table 29] described above, to notify of information of an SRS transmission beam by using a TCI state rather than spatialrelationinfo. There are various other expansion methods, such as DL-UL joint TCI state, but not all methods are described in order to avoid obscuring the main point of the explanation.

An SRS may be configured by a constant amplitude zero auto correlation (CAZAC) sequence. CAZAC sequences configuring respective SRSs transmitted from multiple UEs have different cyclic shift values. Additionally, each of the CAZAC sequences generated from a single CAZAC sequence through cyclic shift has the characteristic of having a zero correlation with sequences having cyclic shift values different from that of the sequence itself. Utilizing this characteristic, SRSs allocated to the same frequency region simultaneously may be distinguished according to a CAZAC sequence cyclic shift value configured for each SRS by the base station.

SRSs of multiple UEs may be distinguished not only by cyclic shift values but also by frequency positions. The frequency location may be distinguished based on SRS subband unit allocation or Comb. In 5G or NR systems, Comb2, Comb4, and Comb8 may be supported. In a case of Comb2, a single SRS may be allocated only to even-numbered or odd-numbered subcarriers within an SRS subband. In this case, the even-numbered subcarriers and the odd-numbered subcarriers may each configure a Comb.

Each UE may be allocated an SRS subband, based on a tree structure. Then, the UE may perform hopping for an SRS allocated to each subband at every SRS transmission time point. Accordingly, all transmission antennas of the UE may utilize the entire uplink data transmission bandwidth to transmit the SRS.

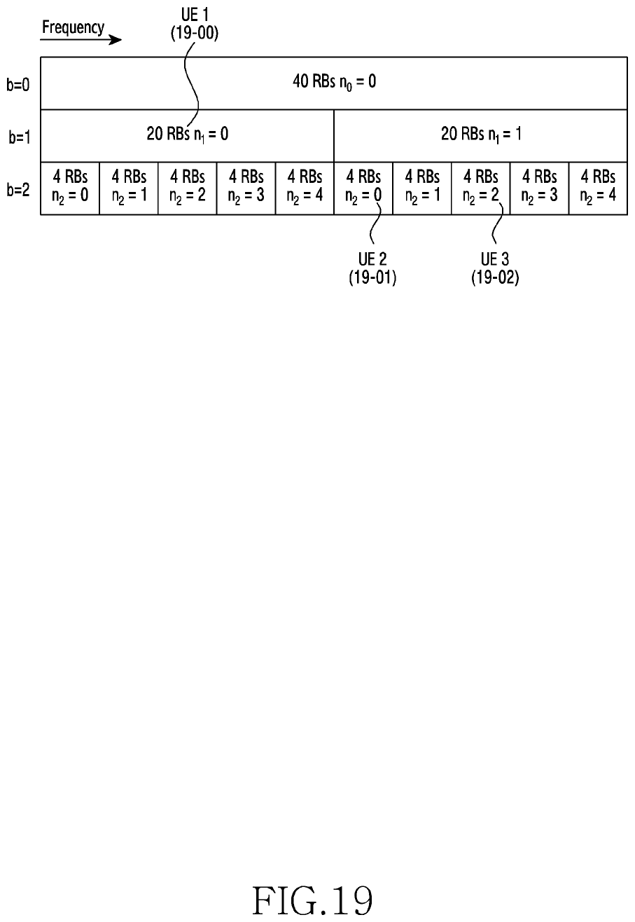

FIG. 19 is a diagram illustrating a structure in which an SRS is allocated for each subband.

Referring to FIG. 19, an example where, when a data transmission band corresponding to 40 RBs in frequency is provided, an SRS is allocated to each UE by a tree structure configured by the base station is illustrated.

In FIG. 19, when a level index of the tree structure is denoted as b, the topmost level (b=0) of the tree structure may be configured by a single SRS subband having a 40-RB bandwidth. At the second level (b=1), two SRS subbands having a bandwidth of 20 RBs each may be generated from the SRS subband at the b=0 level. Therefore, two SRS subbands may exist within the entire data transmission band of the second level (b=1). At the third level (b=2), five SRS subbands with a bandwidth of 4 RBs each may be generated from a single 20 RB-SRS subband at the level directly above (b=1), and thus a structure where 10 4-RB SRS subbands may exist within a single level may be provided.

Based on the configuration of the aforementioned tree structure, the base station may configure various numbers of levels, SRS subband sizes, and the number of SRS subbands per level for the UE. Here, the number of SRS subbands at level b generated from a single SRS subband at a higher level may be defined as N_{b}, and the indexes of N_{b} SRS subbands may be defined as n_{b} (n_{b}={0, . . . , Nb−1}). As the number of subbands per level varies, a UE may be allocated to each subband at each level, as illustrated in FIG. 19. For example, UE 1 19-00 may be allocated to a first SRS subband (n₁=0) among the two SRS subbands with a 20-RB bandwidth at the b=1 level, and UE 2 19-01 and UE 3 19-02 may be allocated to the positions of first (n₂=0) and third (n₂=2) SRS subbands under a second 20-RB SRS subband, respectively. Through this process, the UE is able to perform simultaneous SRS transmission through multiple component carriers (CCs), and may transmit SRSs to multiple SRS subbands within a single CC at the same time.

Specifically, in order to configure SRS subbands described above, NR supports SRS bandwidth configurations as shown in [Table 31] below.

TABLE 31

| | | | |
|---|---|---|---|
| [symbol] | [symbol] | [symbol] | [symbol] |

| [symbol] | [symbol] | [symbol] | [symbol] | [symbol] | [symbol] | [symbol] | [symbol] | [symbol] |
|---|---|---|---|---|---|---|---|---|
| 0 | 4 | 1 | 4 | 1 | 4 | 1 | 4 | 1 |
| 1 | 8 | 1 | 4 | 2 | 4 | 1 | 4 | 1 |
| 2 | 12 | 1 | 4 | 3 | 4 | 1 | 4 | 1 |
| 3 | 16 | 1 | 4 | 4 | 4 | 1 | 4 | 1 |
| 4 | 16 | 1 | 8 | 2 | 4 | 2 | 4 | 1 |
| 5 | 20 | 1 | 4 | 5 | 4 | 1 | 4 | 1 |
| 6 | 24 | 1 | 4 | 6 | 4 | 1 | 4 | 1 |
| 7 | 24 | 1 | 12 | 2 | 4 | 3 | 4 | 1 |
| 8 | 28 | 1 | 4 | 7 | 4 | 1 | 4 | 1 |
| 9 | 32 | 1 | 16 | 2 | 8 | 2 | 4 | 2 |
| 10 | 36 | 1 | 12 | 3 | 4 | 3 | 4 | 1 |
| 11 | 40 | 1 | 20 | 2 | 4 | 5 | 4 | 1 |
| 12 | 48 | 1 | 16 | 3 | 8 | 2 | 4 | 2 |
| 13 | 48 | 1 | 24 | 2 | 12 | 2 | 4 | 3 |
| 14 | 52 | 1 | 4 | 13 | 4 | 1 | 4 | 1 |
| 15 | 56 | 1 | 28 | 2 | 4 | 7 | 4 | 1 |
| 16 | 60 | 1 | 20 | 3 | 4 | 5 | 4 | 1 |
| 17 | 64 | 1 | 32 | 2 | 16 | 2 | 4 | 4 |
| 18 | 72 | 1 | 24 | 3 | 12 | 2 | 4 | 3 |
| 19 | 72 | 1 | 36 | 2 | 12 | 3 | 4 | 3 |
| 20 | 76 | 1 | 4 | 19 | 4 | 1 | 4 | 1 |
| 21 | 80 | 1 | 40 | 2 | 20 | 2 | 4 | 5 |
| 22 | 88 | 1 | 44 | 2 | 4 | 11 | 4 | 1 |
| 23 | 96 | 1 | 32 | 3 | 16 | 2 | 4 | 4 |
| 24 | 96 | 1 | 48 | 2 | 24 | 2 | 4 | 6 |
| 25 | 104 | 1 | 52 | 2 | 4 | 13 | 4 | 1 |
| 26 | 112 | 1 | 56 | 2 | 28 | 2 | 4 | 7 |
| 27 | 120 | 1 | 60 | 2 | 20 | 3 | 4 | 5 |
| 28 | 120 | 1 | 40 | 3 | 8 | 5 | 4 | 2 |
| 29 | 120 | 1 | 24 | 5 | 12 | 2 | 4 | 3 |
| 30 | 128 | 1 | 64 | 2 | 32 | 2 | 4 | 8 |
| 31 | 128 | 1 | 64 | 2 | 16 | 4 | 4 | 4 |
| 32 | 128 | 1 | 16 | 8 | 8 | 2 | 4 | 2 |
| 33 | 132 | 1 | 44 | 3 | 4 | 11 | 4 | 1 |
| 34 | 136 | 1 | 68 | 2 | 4 | 17 | 4 | 1 |
| 35 | 144 | 1 | 72 | 2 | 36 | 2 | 4 | 9 |
| 36 | 144 | 1 | 48 | 3 | 24 | 2 | 12 | 2 |
| 37 | 144 | 1 | 48 | 3 | 16 | 3 | 4 | 4 |
| 38 | 144 | 1 | 16 | 9 | 8 | 2 | 4 | 2 |
| 39 | 152 | 1 | 76 | 2 | 4 | 19 | 4 | 1 |
| 40 | 160 | 1 | 80 | 2 | 40 | 2 | 4 | 10 |
| 41 | 160 | 1 | 80 | 2 | 20 | 4 | 4 | 5 |
| 42 | 160 | 1 | 32 | 5 | 16 | 2 | 4 | 4 |
| 43 | 168 | 1 | 84 | 2 | 28 | 3 | 4 | 7 |
| 44 | 176 | 1 | 88 | 2 | 44 | 2 | 4 | 11 |
| 45 | 184 | 1 | 92 | 2 | 4 | 23 | 4 | 1 |
| 46 | 192 | 1 | 96 | 2 | 48 | 2 | 4 | 12 |
| 47 | 192 | 1 | 96 | 2 | 24 | 4 | 4 | 6 |
| 48 | 192 | 1 | 64 | 3 | 16 | 4 | 4 | 4 |
| 49 | 192 | 1 | 24 | 8 | 8 | 3 | 4 | 2 |
| 50 | 208 | 1 | 104 | 2 | 52 | 2 | 4 | 13 |
| 51 | 216 | 1 | 108 | 2 | 36 | 3 | 4 | 9 |
| 52 | 224 | 1 | 112 | 2 | 56 | 2 | 4 | 14 |
| 53 | 240 | 1 | 120 | 2 | 60 | 2 | 4 | 15 |
| 54 | 240 | 1 | 80 | 3 | 20 | 4 | 4 | 5 |
| 55 | 240 | 1 | 48 | 5 | 16 | 3 | 8 | 2 |
| 56 | 240 | 1 | 24 | 10 | 12 | 2 | 4 | 3 |
| 57 | 256 | 1 | 128 | 2 | 64 | 2 | 4 | 16 |
| 58 | 256 | 1 | 128 | 2 | 32 | 4 | 4 | 8 |
| 59 | 256 | 1 | 16 | 16 | 8 | 2 | 4 | 2 |
| 60 | 264 | 1 | 132 | 2 | 44 | 3 | 4 | 11 |
| 61 | 272 | 1 | 136 | 2 | 68 | 2 | 4 | 17 |
| 62 | 272 | 1 | 68 | 4 | 4 | 17 | 4 | 1 |
| 63 | 272 | 1 | 16 | 17 | 8 | 2 | 4 | 2 |

[symbol]

indicates data missing or illegible when filed

Additionally, in NR SRS frequency hopping is supported based on the values in Table 31 above and a detailed procedure follows Table 32 below.

```
TABLE 32
    When SRS is transmitted on a given SRS resource, the sequence
r [symbol]  (n, l′) for each [symbol]  symbol [symbol]  and for each of the antenna ports of the
SRS resource shall be multiplied with the amplitude scaling factor β_{SRS} in
order to conform to the transmit pomer specified in [5, 38.213] and mapped
in sequence starting with [symbol]  to resource elements ( [symbol]  ) in a slot for
each of the antenna ports [symbol]  according to
    $\text{?} = \{ \begin{matrix}\frac{1}{\sqrt{\text{?}}} \text{?} & \text{?} \\ 0 & otherwise\end{matrix}$
    The length of the sounding reference signal sequence is given by
$M \text{?} = m \text{?}$
    where [symbol]  is given by a selected row of Table 6.4.1.4.3-1 with [symbol]
= [symbol]  where [symbol]  is given by the field b-SRS contained in the
higher-layer parameter freqHopping. The row of the table is selected
according to the index [symbol]  given by the field c-SRS contained in
the higher-layer parameter freqHopping.
    $The frequency - domain starting position \text{?} is defined by$
    $\text{?} = \text{?} + \text{?}$
    where
    $\text{?} = \text{?} + \text{?}$
    $\text{?} = \{ ( \begin{matrix}\text{?} & if \text{?} and \text{?} and \text{?} \\ \text{?} & otherwise\end{matrix}$
    $If {N}_{BWP}^{start} \leq \text{?} the reference point for k \text{?} = 0 is subcarrier 0 in$
common resource block 0, otherwise the reference point is the lowest
subcarrier of the [symbol]  .
    The frequency domain shift value [symbol]   adjusts the SRS allocation with
respect to the reference point grid and is contained in the higher-layer
parameter freqDomainShift in the SRS-Config [symbol]  . The transmissions comb offset [symbol]
∈ {0, 1, ... , K [symbol]  − 1} is contained in the higher-layer parameter
transmissionComb in the SRS-Config [symbol]   and [symbol]  is a frequency position index.
    Frequency hopping of the sounding reference signal is configured by
the parameter [symbol]  , given by the field [symbol]  -hop contained in the higher-
layer parameter freqhopping.
    If [symbol]  , frequency hopping is disabled and the frequency
position index [symbol]   remains constant (unless re-configured) and is defined by [symbol]
    = [symbol]
    $for all \text{?} \text{?} symbols of the SRS resource . The quantity \text{?} is$
given by the higher-layer parameter freqDomainPosition and the values of [symbol]
and [symbol]   for [symbol]   are given by the selected [symbol]   of Table 6.4.1.4.3-1
corresponding to the configured value of [symbol]  .
    If [symbol] , frequency hopping is enabled and the frequency position
indices [symbol]  are defined by
    $\text{?} = \{ \begin{matrix}\text{?} & \text{?} \\ \text{?} & otherwise\end{matrix}$
    where N [symbol]   is given by Table 6.4.1.4.3-1.
    $\text{?} = \{ \begin{matrix}\text{?} & if \text{?} \\ \text{?} & if \text{?}\end{matrix}$
    and where N [symbol]   = 1 regardless of the value of N [symbol]  . The quantity [symbol]
counts the number of SRS transmissions. For the case of an SRS resource
configured as aperiodic by the higher-layer parameter resourceType, it is
$given by \text{?} = \text{?} within the slot in which the \text{?} symbol SRS resource is$
$transmitted . The quantity \text{?} is the repetition factor given by the$
field repetitionFactor contained in the higher-layer parameter
resourceMapping. [symbol]
indicates data missing or illegible when filed
```

As described above, a 5G or NR UE supports a single user (SU-MIMO) technique and has a maximum of four transmission antennas. In addition, the NR UE may simultaneously transmit SRSs through multiple CCs or multiple SRS subbands in a CC. In a case of 5G or NR systems, various numerologies are supported unlike LTE systems, multiple SRS transmission symbols may be variously configured, and repeated transmission for SRS transmission through a repetition factor may also be allowed.

Therefore, counting SRS transmission considering the above description is needed. Counting SRS transmission may be variously used. For example, counting SRS transmission may be used to support antenna switching according to the SRS transmission. Specifically, an SRS transmission time point, an antenna, and a band wherein an SRS corresponding to the antenna is transmitted in the band at the SRS transmission time point may be determined by SRS transmission counting.

The UE may not expect that SRS resources in the same SRS resource set are configured by different time domain operations. In addition, the UE may not expect that an SRS resource set associated with an SRS resource is configured by a different time domain operation. An SRS request region included in DCI format 0_1, 1_1, 0_2 (if there is the SRS request region), or 1_2 (if there is the SRS request region) indicates an SRS resource set triggered as shown in [Table 33] below. If the higher layer parameter srs-TPC-PDCCH-Group for the UE is configured to be “typeB,” a 2-bit SRS request region included in DCI format 2_3 indicates a triggered SRS resource set. Alternatively, if the higher layer parameter srs-TPC-PDCCH-Group for the UE is configured to be “typeA,” a 2-bit SRS request region included in DCI format 2_3 indicates an SRS transmission for a set of support cells configured by a higher layer.

TABLE 33

| Value | Triggered aperiodic SRS resource | |
|---|---|---|
| of | set(s) for DCI format 0_1, 0_2, 1_1, | Triggered aperiodic SRS resource set(s) |
| SRS | 1_2, and 2_3 configured with higher | for DCI format 2_3 configured with |
| request | layer parameter srs-TPC-PDCCH- | higher layer parameter srs-TPC-PDCCH- |
| field | Group set to ‘typeB’ | Group set to ‘typeA’ |
| 00 | No aperiodic SRS resource set triggered | No aperiodic SRS resource set triggered |
| 01 | SRS resource set(s) configured by SRS- | SRS resource set(s) configured with higher |
| | ResourceSet with higher layer | layer parameter usage in SRS-ResourceSet |
| | parameter aperiodicSRS- | set to ‘antennaSwitching’ and resourceType |
| | ResourceTrigger set to 1 or an entry in | in SRS-ResourceSet set to ‘aperiodic’ for a |
| | aperiodicSRS-ResourceTriggerList set | 1st set of serving cells configured by higher |
| | to 1 | layers |
| | SRS resource set(s) configured by SRS- | |
| | PosResourceSet with an entry in | |
| | aperiodicSRS-ResourceTriggerList set | |
| | to 1 when triggered by DCI formats | |
| | 0_1, 0_2, 1_1, and 1_2 | |
| 10 | SRS resource set(s) configured by SRS- | SRS resource set(s) configured with higher |
| | ResourceSet with higher layer | layer parameter usage in SRS-ResourceSet |
| | parameter aperiodicSRS- | set to ‘antennaSwitching’ and resourceType |
| | ResourceTrigger set to 2 or an entry in | in SRS-ResourceSet set to ‘aperiodic’ for a |
| | aperiodicSRS-ResourceTriggerList set | 2nd set of serving cells configured by higher |
| | to 2 | layers |
| | SRS resource set(s) configured by SRS- | |
| | PosResourceSet with an entry in | |
| | aperiodicSRS-ResourceTriggerList set | |
| | to 2 when triggered by DCI formats | |
| | 0_1, 0_2, 1_1, and 1 2 | |
| 11 | SRS resource set(s) configured by SRS- | SRS resource set(s) configured with higher |
| | ResourceSet with higher layer | layer parameter usage in SRS-ResourceSet |
| | parameter aperiodicSRS- | set to ‘antennaSwitching’ and resourceType |
| | ResourceTrigger set to 3 or an entry in | in SRS-ResourceSet set to ‘aperiodic’ for a |
| | aperiodicSRS-ResourceTriggerList set | 3rd set of serving cells configured by higher |
| | to 3 | layers |
| | SRS resource set(s) configured by SRS- | |
| | PosResourceSet with an entry in | |
| | aperiodicSRS-ResourceTriggerList set | |
| | to 3 when triggered by DCI formats | |
| | 0_1, 0_2, 1_1, and 1_2 | |

With respect to a PUCCH and an SRS scheduled on the same carrier, when a semi-persistent SRS and a periodic SRS are configured on the same symbol as a PUCCH including only a CSI report, including only an L1-RSRP report, or including only an L1-SINR report, the UE may not transmit the SRSs. When a semi-persistent SRS or a periodic SRS is configured on the same symbol as a PUCCH including a HARQ-ACK, a link restoration request, and/or an SR, or an aperiodic SRS is triggered to be transmitted on the same symbol as a PUCCH including the above information, the UE may not transmit the SRS. If an SRS overlapping with a PUCCH fails to be transmitted, only an SRS symbol(s) overlapping with the PUCCH is dropped. When an aperiodic SRS is triggered to overlap the same symbol as a PUCCH including a semi-persistent/periodic CSI report or only a semi-persistent/periodic L1-RSRP or L1-SINR report, the PUCCH may not be transmitted.

In a case of a band-band combination for which simultaneous transmission of an SRS and a PUCCH/PUSCH is not allowed with respect to intra-band carrier aggregation or inter-band carrier aggregation, the UE may not expect that PUSCH/UL DM-RS/UL PT-RS/PUCCH formats are configured, on the same symbol, from a carrier different from a carrier on which an SRS is configured.

In a case of a band-band combination for which simultaneous transmission of an SRS and a PRACH is not allowed with respect to intra-band carrier aggregation or inter-band carrier aggregation, the SRS and the PRACH may not be simultaneously transmitted from one carrier and another carrier, respectively.

When an SRS resource for which the higher layer parameter resourceType is configured to be “aperiodic” is triggered on an OFDM symbol(s) for a periodic/semi-persistent SRS transmission, the UE may transmit the aperiodic SRS resource, periodic/semi-persistent SRS symbols overlapping a corresponding symbol(s) are dropped, and a non-overlapping periodic/semi-persistent SRS symbol(s) may be transmitted. When an SRS resource for which the higher layer parameter resourceType is configured to be “semi-persistent” is triggered on an OFDM symbol(s) for a periodic SRS transmission, the UE may transmit the semi-persistent SRS resource, a periodic SRS symbol(s) are dropped during overlapping symbols, and a non-overlapping periodic symbol(s) may be transmitted.

When the higher layer parameter usage in SRS-ResourceSet is configured to be “antennaSwitching” and a guard period of Y symbols is configured, the UE may follow the same priority rule as defined above as if an SRS were configured even during the guard period.

When the higher layer parameter spatialRelationInfo of a semi-persistent or aperiodic SRS resource is activated or updated through a MAC CE for CCs/bandwidth parts indicated by a set of the higher layer parameters applicableCellList, spatialRelationInfo may be applied to semi-persistent or aperiodic SRS resource(s) having the same SRS resource ID for all bandwidth parts in the indicated CCs.

When the higher layer parameter enableDefaultBeamPlForSRS is configured to be “enable,” the higher layer parameter spatialRelationInfo for an SRS resource except for a case where the higher layer parameter usage of an SRS resource is configured to be “beamManagement” or configured to be “nonCodebook” together with an associated CSI-RS configuration is not configured in FR2, and the higher layer parameter pathlossReferenceRS for the UE is not configured, the UE may transmit a target SRS resource according to the following configuration.
The UE transmits a target SRS resource through the same spatial domain transmission filter having been used to receive a CORESET having the lowest controlResoureSetID in a DL bandwidth part activated in a CC.
If any CORESET is not configured in a CC, the UE transmits a target SRS resource through the same spatial domain transmission filter having been used to receive an activated TCI state having the lowest ID applicable to a PDSCH in an active DL bandwidth part in the CC.

Table 34 indicates a UE capability containing resource-related information of an uplink reference signal for position information identification (positioning).

TABLE 34

| Index | Feature group | Components | |
|---|---|---|---|
| 13-8 | SRS Resources | 1. | Max number of SRS Sets for positioning supported by UE per |
| | for Positioning | | BWP |
| | | | Values = (1, 2, 4, 8, 12, 16) |
| | | 2. | Max number of P/SP/AP SRS Resources for positioning per BWP. |
| | | | Values = (1, 2, 4, 8, 16, 32, 64) |
| | | 3. | Max number of P/SP/AP SRS Resources including the SRS resources |
| | | | for positioning per BWP per slot. |
| | | | Values = (1, 2, 3, 4, 5, 6, 8, 10, 12, 14) |
| | | | Note: Max number of P/SP/AP SRS Resources in Component 3 include |
| | | | both SRS resources configured by SRS-Resource and SRS resources |
| | | | configured by SRS-PosResource-r16 suppored by UE |
| | | 4. | Max number of periodic SRS Resources for positioning per BWP. |
| | | | Values = (1, 2, 4, 8, 16, 32, 64) |
| | | 5. | Max number of periodic SRS Reources for positioning per BWP per |
| | | | slot. |
| | | | Values = (1, 2, 3, 4, 5, 6, 8, 10, 12, 14) |

OLPC for SRS for postioning based on SSB from serving cell is part of
FG13-8

Note:
no dedicated capability signaling is intended for this component

The UE having reported the UE capability (hereinafter, represented as FG 13-8) of Table 34 above may transmit an uplink reference signal in all OFDM symbol positions in a random slot when transmitting the uplink reference signal.

Table 35 indicates a UE capability containing information of a transmission symbol position of an uplink reference signal within a slot in an unlicensed band.

TABLE 35

| Index | Feature group | Components | |
|---|---|---|---|
| 10-11 | SRS starting position at any | 1. | Support transmitting SRS |
| | OFDM symbol in a slot | | starting in all symbols |
| | | | (0, . . . , 13) of a slot |

The UE having reported the UE capability (hereinafter, represented as FG 10-11) of Table 35 above may transmit an uplink reference signal in all OFDM symbol positions in a random slot in both an unlicensed band and a licensed band when transmitting the uplink reference signal.

Hereinafter, embodiments of the disclosure will be described in detail in conjunction with the accompanying drawings. The contents of the disclosure may be applied to FDD and TDD systems. As used herein, upper signaling (or upper layer signaling) is a method for transferring signals from a base station to a UE by using a downlink data channel of a physical layer, or from the UE to the base station by using an uplink data channel of the physical layer, and may also be referred to as “RRC signaling”, “PDCP signaling”, or “medium access control (MAC) control element (MAC CE)”.

Hereinafter, in the disclosure, the UE may use various methods to determine whether or not to apply cooperative communication, for example, PDCCH(s) that allocates a PDSCH to which cooperative communication is applied have a specific format, or PDCCH(s) that allocates a PDSCH to which cooperative communication is applied include a specific indicator indicating whether or not to apply cooperative communication, or PDCCH(s) that allocates a PDSCH to which cooperative communication is applied are scrambled by a specific RNTI, or cooperative communication application is assumed in a specific range indicated by an upper layer. Hereinafter, it will be assumed for the sake of descriptive convenience that NC-JT case refers to a case in which the UE receives a PDSCH to which cooperative communication is applied, based on conditions similar to those described above.

Hereinafter, determining priority between A and B may be variously described as, for example, selecting an entity having a higher priority according to a predetermined priority rule and performing an operation corresponding thereto, or omitting or dropping operations regarding an entity having a lower priority.

Hereinafter, the above examples may be described through several embodiments, but they are not independent of each other, and one or more embodiments may be applied simultaneously or in combination.

Hereinafter, for the sake of descriptive convenience, a cell, a transmission point, a panel, a beam, and/or a transmission direction which can be distinguished through an upper layer/L1 parameter such as a TCI state or spatial relation information, a cell ID, a TRP ID, or a panel ID may be described as a TRP, a beam, or a TCI state as a whole. Therefore, when actually applied, a TRP, a beam, or a TCI state may be appropriately replaced with one of the above terms.

Hereinafter, in the disclosure, the UE may use various methods to determine whether or not to apply cooperative communication, for example, PDCCH(s) that allocates a PDSCH to which cooperative communication is applied have a specific format, or PDCCH(s) that allocates a PDSCH to which cooperative communication is applied include a specific indicator indicating whether or not to apply cooperative communication, or PDCCH(s) that allocates a PDSCH to which cooperative communication is applied are scrambled by a specific RNTI, or cooperative communication application is assumed in a specific range indicated by an upper layer. Hereinafter, it will be assumed for the sake of descriptive convenience that NC-JT case refers to a case in which the UE receives a PDSCH to which cooperative communication is applied, based on conditions similar to those described above.

Hereinafter, embodiments of the disclosure will be described in detail in conjunction with the accompanying drawings. In the following description, a base station is an entity that allocates resources to terminals, and may be at least one of a gNode B, a gNB, an eNode B, an eNB, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the following description of embodiments of the disclosure, 5G systems will be described by way of example, but the embodiments of the disclosure may also be applied to other communication systems having similar technical backgrounds or channel types. Examples of such communication systems may include LTE or LTE-A mobile communication systems and mobile communication technologies developed beyond 5G. Therefore, based on determinations by those skilled in the art, the embodiments of the disclosure may be applied to other communication systems through some modifications without significantly departing from the scope of the disclosure. The contents of the disclosure may be applied to FDD and TDD systems.

In describing the disclosure below, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description of the disclosure, upper layer signaling may refer to signaling corresponding to at least one signaling among the following signaling, or a combination of one or more thereof.
Master information block (MIB)
   System information block (SIB) or SIB X (X=1, 2, . . . )
Radio resource control (RRC)
Medium access control (MAC) control element (CE)

In addition, L1 signaling may refer to signaling corresponding to at least one signaling method among signaling methods using the following physical layer channels or signaling, or a combination of one or more thereof.
Physical downlink control channel (PDCCH)
Downlink control information (DCI)
UE-specific DCI
Group common DCI
Common DCI
Scheduling DCI (for example, DCI used for the purpose of scheduling downlink or uplink data)
Non-scheduling DCI (for example, DCI not used for the purpose of scheduling downlink or uplink data)
Physical uplink control channel (PUCCH)
Uplink control information (UCI)

Hereinafter, determining priority between A and B may be variously described as, for example, selecting an entity having a higher priority according to a predetermined priority rule and performing an operation corresponding thereto, or omitting or dropping operations regarding an entity having a lower priority.

As used herein, the term “slot” may generally refer to a specific time unit corresponding to a transmit time interval (TTI), may specifically refer to a slot used in a 5G NR system, or may refer to a slot or a subframe used in a 4G LTE system.

Hereinafter, the above examples may be described through several embodiments, but they are not independent of each other, and one or more embodiments may be applied simultaneously or in combination.

### First Embodiment: SRS Resource Configuration and Indication Method

As an embodiment of the disclosure, an SRS resource configuration and indication method is described. A conventional SRS resource supports a maximum of four ports as described above, and the UE may perform SRS transmission through all ports on each symbol with respect to the positions of all SRS resource transmission symbols determined based on higher layer signaling. For example, if a 4-port SRS resource having 4 of the number of transmission symbols is configured for the UE by the base station through higher layer signaling, the UE may perform transmission through four ports on each symbol.

In a future advanced release of NR, it is expected that enhanced specifications are supportable in consideration of a maximum of eight antenna ports of the UE, and currently, corresponding functions are being discussed in NR Release 18. In a subsequent release, or further in a 6th-generation mobile communication system, it may be possible to consider more than eight antenna ports on the UE side. However, if SRS transmission is performed on all ports configured for each of the symbols on which an SRS is transmitted, as currently supported, an increased number of ports may result in reduced transmission power per port during SRS transmission. Therefore, when coverage is insufficient, such as for UEs located at the cell edge, the reception performance at the base station may be limited. Therefore, the base station and the UE may consider various methods as follows for SRS transmission having N antenna ports, where N is greater than 4.

### [Method 1-1] Single SRS Resource Use Method 1

A single SRS resource may be configured by the base station for the UE to transmit an SRS having N antenna ports. The base station may configure a single SRS resource having N antenna ports for the UE, and when a single or multiple symbols of the SRS resource are transmitted through the N antenna ports, the antenna ports may all be transmitted on each symbol. For example, if the UE transmits an SRS resource of N antenna ports configured to have Nₛ of 4, the UE may transmit the SRS resource through all the N antenna ports on each symbol.

In Method 1-1, current specification supports for 1, 2, and 4 antenna ports are based on a single SRS resource. Therefore, the definitions of various time and frequency resource allocation-related parameters in [Table 29] above may be used without change, and thus Method 1-1 may be a natural expansion according to a case where the number of antenna ports of the UE increases. However, if Method 1-1 is used, the UE transmits all antenna ports on one symbol, and thus a problem that the transmission power per antenna port on a single symbol decreases may occur.

### [Method 1-2] Single SRS Resource Use Method 2

A single SRS resource may be configured by the base station for the UE to transmit an SRS having N antenna ports. The base station may configure a single SRS resource having N antenna ports for the UE, if one or more symbols configured in the SRS resource are transmitted, the number of antenna ports used for each symbol transmission may be smaller than or equal to N, and the number of symbols required for transmitting the SRS resource through all the N antenna ports may be greater than or equal to 1.

In Method 1-2, an SRS resource is transmitted on each symbol through some antenna ports among the entire N antenna ports and thus the transmission power of each antenna port per symbol may be increased compared to Method 1-1 of transmission using all the entire N antenna ports per symbol. However, the transmission through antenna ports according to Method 1-2 is different from the definition of an existing specification where transmission is performed on each symbol through all antenna ports configured for a particular SRS resource. Therefore, the definitions of various time and frequency resource allocation-related parameters in [Table 29] above may be partially changed or require new definitions.

### [Method 1-3] Multi-SRS Resource Use Method

Multiple SRS resources may be configured by the base station for the UE to transmit an SRS having N antenna ports. In order to support SRS transmission corresponding N antenna ports from the UE, the base station may configure M (M>1) SRS resources having N or fewer antenna ports for the UE, and when a single or multiple symbols of a corresponding SRS resource are transmitted through the N or fewer antenna ports configured for each SRS resource, two SRS resources may both be transmitted on each symbol. For example, if two SRS resources each having four antenna ports are configured for the UE for SRS transmission of eight antenna ports, and Nₛ of both of the two SRS resources is configured to be 4, the two SRS resources may both be transmitted through four antenna ports on each symbol for each of the two SRS resources. The multiple SRS resources may be included in the same SRS resource set or included in respective different SRS resource set. N that is the number of antenna ports representable by multiple SRS resources may be greater than 4, for example, a value such as 6, 8, 12, and 16, and may be represented by an SRS resource having 1, 2, or 4 antenna ports. The UE may expect that all SRS resources included in each SRS resource group which may be configured by the base station or determined by the above particular rule may have the same number of antenna ports. In addition, a case where SRS resources have different number of antenna ports may also be included. For example, if two SRS resources are configured to express N antenna ports (N=8), each SRS resource may have four antenna ports.

In Method 1-3, unlike a method based on one SRS resource supported by the current specification, it is possible for multiple SRS resources to be transmitted through N antenna ports. Therefore, the definitions of various time and frequency resource allocation-related parameters in [Table 29] above may be partially changed or partially require new definitions. However, similarly to Method 1-2, the number of antenna ports used for transmission of each symbol each SRS resource is smaller than or equal to N that is the number of all antenna ports, and thus the power transmitted per port may increase.

[Method 1-4] Method of selecting among [Method 1-1] to [Method 1-3] above

In order to transmit an SRS having N antenna ports, one of [Method 1-1] to [Method 1-3] above may be semi-statically or dynamically indicated to the UE from the base station. For example, one of [Method 1-1] and [Method 1-3] above may be used by the UE after being configured by the base station through higher layer signaling, or may be dynamically indicated through L1 signaling. One of two methods, such as one of [Method 1-1] and [Method 1-2], one of [Method 1-1] and [Method 1-3], or one of [Method 1-2] and [Method 1-3], may be used after being configured by the base station through higher layer signaling, or may be dynamically indicated through L1 signaling. If the UE is positioned in a cell and has enough coverage, the base station may configure, for the UE, SRS transmission for N antenna ports based on [Method 1-1] through higher layer signaling, or dynamically indicate same through L1 signaling. A method of dynamically indicating through L1 signaling may, for example, be indicated through a new field in a DCI format, or indicated using a reserved codepoint of the currently existing DCI field, and as an example, an SRS request field may be used.

The UE may report, to the base station as a UE capability, whether the UE is able to support a combination of at least one of [Method 1-1] to [Method 1-4] above. The UE capability reporting may be performed differently according to frequency ranges (FRs), or may be performed per band, per band combination, per feature set, or per feature set per CC. In addition, the above UE capability may be an independent UE capability, or whether respective methods are supported may be defined as multiple components in a single UE capability.

If the UE supports a combination of at least one of [Method 1-1] to [Method 1-4] above, codebook and antenna switching may be possible as usage that is higher layer signaling of an SRS resource set. In addition, a case where usage is non-codebook and beam management may also be included.

When [Method 1-3] above is followed, if multiple SRS resources are configured in the same SRS resource set for the UE, a maximum number of SRS resources in the SRS resource set configurable for the UE through higher layer signaling may be equal to or greater than 4. If multiple SRS resources are configured in different SRS resource sets for the UE, two or more SRS resource sets having usage of codebook may be configured for the UE through higher layer signaling

When [Method 1-3] above is followed, the UE uses multiple SRS resources for SRS transmission having N antenna ports. Therefore, it may need to change a definition of a codepoint in an SRS resource indicator (SRI) in DCI format 0_1 or 0_2 transmitted from the base station for scheduling of codebook-based PUSCH transmission. While each codepoint of the current SRI indicates a single SRS resource, if the UE is configured to use [Method 1-3] above by the base station, a definition of a codepoint in an SRI field may be changed according to the following methods.

### [Method 1-3-1] SRS Resource Group Indication

The UE may assume that each codepoint of an SRI field in DCI format 0_1 and 0_2 indicated from the base station indicates an SRS resource group including multiple SRS resources. For example, if the number of codepoints of an SRI is 2, a first codepoint may indicate SRS resource group 0 and a second codepoint may indicate SRS resource group 1. SRS resource group 0 may include SRS resources 0 and 1 and SRS resource group 1 may include SRS resources 2 and 3. The SRS resource groups may be configured for the UE by the base station through a higher layer. In addition, if multiple SRS resources are configured in the same SRS resource set by the base station, the UE may determine, as a group, a particular number of SRS resource indexes starting from the lowest SRS resource index in the SRS resource set, and a total number of antenna ports represented through multiple SRS resources may be configured for each SRS resource set. For example, if the number of antenna ports in an SRS resource set is configured to be 8, a total number of SRS resources is configured to be 4, and the respective indexes of the SRS resources are 0 to 3, SRS resource indexes 0 and 1 may be a first SRS resource group and SRS resource indexes 2 and 3 may be a second SRS resource group. In this case, the first SRS resource group corresponds to a first codepoint of an SRI field and the second SRS resource group may correspond to a second codepoint.

### [Method 1-3-2] Multi-SRS Resource Combination Indication Similar to Noncodebook

The UE may assume that each codepoint of an SRI field in DCI format 0_1 and 0_2 indicated from the base station indicates a combination of a single or multiple SRS resources. This may be similar to the meaning of an SRI field in DCI format 0_1 and 0_2 for scheduling noncodebook-based PUSCH transmission. If four SRS resources are configured in an SRS resource set configured to have usage of noncodebook, respective codepoints of an SRI field in DCI format 0_1 and 0_2 for scheduling noncodebook-based PUSCH transmission represent all the methods of selecting one to four among the four SRS resources and thus a total of 15 codepoints (2⁴⁻1=15) may be required. As described above, similarly to a noncodebook scheme considering all methods of selecting a subset from all configured SRS resources, Method 1-3-2 may use a method of selecting all or some of subsets.

For example, when it is assumed that the number of all configured SRS resources is M, if all the M SRS resources are assumed to have the same number of antenna ports, only a combination of a particular number of SRS resources among the M SRS resources may be considered. For example, only a method of selecting two among the M SRS resources may be considered. If the M SRS resources are assumed to be able to have different numbers of antenna ports, in consideration of a combination of a particular number or another particular number of SRS resources among the M SRS resources, a case where each combination of SRS resources has the same total number of antenna ports may be generated. For example, if four SRS resources each having two antenna ports and two SRS resources each having four antenna ports are configured in a single SRS resource set, and a total of eight antenna ports are to be represented by using multiple SRS resources, a combination of the two SRS resources each having four antenna ports may be used or a combination of one SRS resource having four antenna ports and two SRS resources each having two antenna ports may be used.

### [Method 1-3-3] Single SRS Resource Indication and Automatic Indication of Other SRS Resources Connected to Indicated SRS Resource

The UE may assume that each codepoint of an SRI field in DCI format 0_1 and 0_2 indicated from the base station indicates a single SRS resource, and the single SRS resource indicated by each codepoint may be connected to multiple other SRS resources. The connection may be configured through higher layer signaling. The base station and the UE do not change the definition of each codepoint of an SRI field, and the base station may indicate a single SRS resource to the UE and, at the same time, indicate multiple SRS resources connected to the single SRS resource through higher layer signaling together.

The UE may report, to the base station as a UE capability, whether the UE is able to support a combination of at least one of [Method 1-3-1] to [Method 1-3-3] above. The UE capability reporting may be performed differently according to frequency ranges (FRs), or may be performed per band, per band combination, per feature set, or per feature set per CC. In addition, the above UE capability may be an independent UE capability, or whether respective methods are supported may be defined as multiple components in a single UE capability.

With respect to [Method 1-3] described above, if the UE receives higher layer signaling from the base station for multiple SRS resources in order to use [Method 1-3-1] to [Method 1-3-3] described above, the UE may classify various pieces of higher layer signaling configuration information in SRS resource mentioned in [Table 29] from the base station into pieces of higher layer signaling configuration information, which need to be configured to be identical for all of multiple SRS resources required for transmitting an SRS having N antenna port, and pieces of information, which are allowed to be identical or different.

The UE may expect that a parameter, such as groupOrSequenceHopping or sequenceId, which is a parameter related to a transmission sequence of an SRS and a parameter, such as resourceType, which indicates periodic, semi-persistent, or aperiodic transmission of an SRS resource among the parameters in [Table 29] are configured to be identical for all multiple SRS resources required for transmitting an SRS having N antenna ports.

The UE may expect that resourceMapping, resourceMapping-r16, or resourceMapping-17, which is information related to time resource allocation of an SRS, and freqDomainPosition, freqDomainShift, or freqHopping, which is information related to frequency resource allocation, among the parameters in [Table 29] are configured to be identical or different for multiple SRS resources required for transmitting an SRS having N antenna ports. In addition, the UE may expect that transmissionComb or transmissionComb-n8-r17 that determines the frequency and position of a transmission RE of an SRS has the same Comb value for multiple SRS resources, and a Comb offset is configured to be identical or different. In addition, the UE may expect that a partial factor configured for an RB level partial frequency sounding operation of an SRS also has the same value for multiple SRS resources.

The UE may expect that pieces of information, such as spatialrelationinfo and srs-TCIState-r17, which are information for determining a transmission beam of an SRS among the parameters in [Table 29] are configured to be identical or different for multiple SRS resources. Specifically, if multiple SRS resources are configured in different SRS resource sets, the UE may expect that the two parameters related to transmission beam determination are configured to be different for the multiple SRS resources.

### Second Embodiment: SRS Time Resource Allocation, Repeated Transmission, and Frequency Hopping Method

As an embodiment of the disclosure, an SRS time resource allocation, repeated transmission, and frequency hopping method according to the SRS resource configuration and indication method described in the above embodiment is described.

According to [Table 29] above, the UE may determine a time axis transmission resource position at the time of frequency hopping of an SRS resource through higher layer signalings, such as startPosition indicating a transmission start symbol in a slot of the SRS resource, nrofSymbols indicating the number of symbols consecutively transmitted starting from the transmission start symbol in a slot, and repetitionFactor indicating the number of consecutive symbols having frequency resources of the same position when frequency hopping is performed.

When [Method 1-1] is used in the above embodiment, that is, when all of N antenna ports are configured for a single SRS resource and the SRS resource is transmitted using all the N antenna ports on each transmission symbol, the UE may be able to perform the following operation according to a combination of the higher layer signalings startPosition, nrofSymbols, and repetitionFactor for periodic/semi-persistent/aperiodic SRS transmission.

The higher layer signaling nrofSymbols-r17 (hereinafter, named Nₛ) may be configured to be 2, 4, 8, 10, 12, or 14 for the UE with respect to an aperiodic SRS, repetitionFactor-r17 (hereinafter, named R) may be configured to be 1, only intra-slot frequency hopping may be possible when frequency hopping is performed, and the number of consecutive symbols having frequency resources of the same position when frequency hopping is performed may be 1 (=R).

The higher layer signaling Nₛ may be configured to be a value greater than or equal to 4 for the UE with respect to an aperiodic SRS, R may be configured to be a value greater than or equal to 2, wherein R may be a divisor of Nₛ, only intra-slot frequency hopping may be possible when frequency hopping is performed, and the number of consecutive symbols having frequency resources of the same position when frequency hopping is performed may be R.

Nₛ may be configured to be 1 for the UE with respect to a periodic/semi-persistent SRS, R may be configured to be 1, only inter-slot frequency hopping may be possible when frequency hopping is performed, and the number of consecutive symbols having frequency resources of the same position when frequency hopping is performed may be 1 (=R).

The higher layer signaling Nₛ may be configured to be a value greater than or equal to 4 for the UE with respect to a periodic/semi-persistent SRS, R may be configured to be a value greater than or equal to 2, wherein R may be a divisor of Nₛ, intra-slot or inter-slot frequency hopping may be possible when frequency hopping is performed, and the number of consecutive symbols having frequency resources of the same position when frequency hopping is performed may be R.

The higher layer signaling Nₛ may be configured to be a value greater than or equal to 4 for the UE with respect to a periodic/semi-persistent SRS, R may be configured to be a value identical to Nₛ, intra-slot or inter-slot frequency hopping may be possible when frequency hopping is performed, and the number of consecutive symbols having frequency resources of the same position when frequency hopping is performed may be R (=Nₛ).

When [Method 1-2] is used in the above embodiment, that is, when N antenna ports are configured for a single SRS resource and some of the N antenna ports are transmitted on each transmission symbol, the UE may perform the following operation by considering the definitions of the higher layer signalings startPosition, nrofSymbols, and repetitionFactor as described below.

### [Time Resource Operation 2-1]

The UE may consider that the definition of Nₛ indicates the number of consecutive symbols on which a corresponding SRS resource is transmitted, as defined previously. In a case where N antenna ports are configured for a single SRS resource and the SRS resource is transmitted through some of the N antenna ports on each transmission symbol, if it is assumed that M symbols are needed to transmit the SRS resource through all of the N antenna ports, the UE may expect that Nₛ having a divisor of M is configured for the SRS resource. For example, if the UE assumes that N(=8) antenna ports are configured, an SRS resource is transmitted through four antenna ports on each transmission symbol, and the SRS resource is transmitted through all the N(=8) antenna ports through M (=2) symbols, one of the values of Nₛ (=2, 4, 8, 10, 12, and 14) having a divisor of M=2 for the SRS resource may be configured for the UE. If Nₛ is equal to 4, the number of consecutive symbols on which the SRS resource is transmitted is 4, and the UE may expect that the SRS resource is transmitted on first and third symbols through some four (e.g., SRS antenna ports 0-3) of the total of eight antenna ports and the SRS resource is transmitted on second and fourth symbols through some other four (e.g., SRS antenna ports 4-7) of the total of eight antenna ports. As another method, the UE may expect that the SRS resource is transmitted on first two symbols through some four (e.g., SRS antenna ports 0-3) of the total of eight antenna ports and the SRS resource is transmitted on remaining two symbols through some other four (e.g., SRS antenna ports 4-7) of the total of eight antenna ports. (The disclosure is not limited to the above example, and as another example, some four of the total of eight antenna ports may be configured to be SRS antenna ports 0, 2, 4, and 6.)

The UE may assume that the definition of R indicates the number of consecutive symbols which has frequency resources of the same position and on which a corresponding SRS resource is transmitted, as defined previously. Therefore, an R value configurable for the UE may be a divisor of Nₛ as described above. In a case where N antenna ports are configured for a single SRS resource and the SRS resource is transmitted through some of the N antenna ports on each transmission symbol, if it is assumed that M symbols are needed to transmit the SRS resource through all of the N antenna ports, a minimum value of R is 1 or M.
If a minimum value of R configurable for the UE is 1, this implies that the number of consecutive symbols having the same frequency resource is 1. In this case, it is possible to transmit only some of the N antenna ports on one symbol, and thus an SRS corresponding to corresponding antenna ports may be transmitted on different frequency positions for each group of particular some antenna ports among the N antenna ports. Therefore, it is not possible for an SRS corresponding to all the N antenna ports to be transmitted on the same frequency position, and thus when the base station receives the SRS and performs channel estimation, channel information of a particular antenna port may be absent in some frequency resource positions. Accordingly, the base station may need to estimate channel information of a frequency position where channel information is absent, by using a frequency position where channel information is present. In this case, a frequency band of SRS transmission estimable by the base station may be broadened, but channel estimation performance at a frequency position where channel information of a particular antenna port is absent may be degraded.
If a minimum value of R configurable for the UE is M, this implies that the number of consecutive symbols having the same frequency resource is M. In this case, it is possible to transmit all the N antenna ports during M symbols, and thus an SRS corresponding to the N antenna ports may be transmitted on the same frequency position. Therefore, when the base station receives the SRS and performs channel estimation, channel information on all the N antenna ports may be acquired in all frequency positions. In this case, a frequency band of SRS transmission estimable by the base station may be reduced compared to a case where the minimum value of R is 1, but all the antenna ports are transmitted in all the frequency positions, and thus channel estimation performance may be enhanced.
The minimum value of R configurable for the UE may be configured via higher layer signaling among 1 or M, indicated via L1 signaling, notified by a combination of higher layer signaling and L1 signaling, activated/deactivated via MAC-CE signaling, or fixedly defined and operated in a specification.

Based on time resource operation 2-1 described above, the UE may be able to perform the following operation according to a combination of the higher layer signalings startPosition, nrofSymbols, and repetitionFactor for periodic/semi-persistent/aperiodic SRS transmission.
Nₛ may be configured to be 2, 4, 8, 10, 12, or 14 for the UE with respect to an aperiodic SRS, R may be configured to be 1 or M, wherein M may be a divisor of Nₛ, only intra-slot frequency hopping may be possible when frequency hopping is performed, and the number of consecutive symbols having frequency resources of the same position when frequency hopping is performed may be 1 or M (=R). Determination of the R value may follow one of the above schemes.
The higher layer signaling Nₛ may be configured to be a value greater than or equal to 4 for the UE with respect to an aperiodic SRS, R may be configured to be a value greater than or equal to 2 or a value greater than or equal to M, wherein R or M may be a divisor of Nₛ, only intra-slot frequency hopping may be possible when frequency hopping is performed, and the number of consecutive symbols having frequency resources of the same position when frequency hopping is performed may be R.
Nₛ may be configured to be M for the UE with respect to a periodic/semi-persistent SRS, R may be configured to be M, only inter-slot frequency hopping may be possible when frequency hopping is performed, and the number of consecutive symbols having frequency resources of the same position when frequency hopping is performed may be M (=R).
The higher layer signaling Nₛ may be configured to be a value greater than or equal to 4 for the UE with respect to a periodic/semi-persistent SRS, R may be configured to be a value greater than or equal to 2 or a value greater than or equal to M, wherein R or M may be a divisor of Nₛ, intra-slot or inter-slot frequency hopping may be possible when frequency hopping is performed, and the number of consecutive symbols having frequency resources of the same position when frequency hopping is performed may be R.
The higher layer signaling Nₛ may be configured to be a value greater than or equal to 4 for the UE with respect to a periodic/semi-persistent SRS, R may be configured to be a value identical to Nₛ, intra-slot or inter-slot frequency hopping may be possible when frequency hopping is performed, and the number of consecutive symbols having frequency resources of the same position when frequency hopping is performed may be R (=Nₛ).

### [Time Resource Operation 2-2]

If the number of symbols required for transmitting all antenna ports of a corresponding SRS resource is defined as M, the UE may understand that the definition of Nₛ is a value relating to what times M symbols are used to transmit the SRS resource. That is, rather than being the number of consecutive symbols used for transmitting an SRS resource as defined previously, Nₛ may be defined as information relating to what times an M-symbol unit used for transmitting all N antenna ports configured in an SRS resource is used continuously. For example, if the UE assumes that N(=8) antenna ports are configured, an SRS resource is transmitted through four antenna ports on each transmission symbol, and the SRS resource is transmitted through all the N(=8) antenna ports through M (=2) symbols, one of the values of Nₛ (=1, 2, 4, 5, 6, and 7) may be configured for the UE as information relating to what times an M-symbol unit (M=2) is continuously used for the SRS resource. If Nₛ is equal to 2, a total number of consecutive symbols on which the SRS resource is transmitted is 4 and this may imply that the M-symbol unit (M=2) is continuously used two times. In addition, the UE may expect that the SRS resource is transmitted on first and third symbols through some four (e.g., SRS antenna ports 0-3) of the total of eight antenna ports and the SRS resource is transmitted on second and fourth symbols through some other four (e.g., SRS antenna ports 4-7) of the total of eight antenna ports. As another method, the UE may expect that the SRS resource is transmitted on first two symbols through some four (e.g., SRS antenna ports 0-3) of the total of eight antenna ports and the SRS resource is transmitted on remaining two symbols through some other four (e.g., SRS antenna ports 4-7) of the total of eight antenna ports. (The disclosure is not limited to the above example, and as another example, some four of the total of eight antenna ports may be configured to be SRS antenna ports 0, 2, 4, and 6.)

The UE may assume that the definition of R indicates the number of consecutive symbols which has frequency resources of the same position and on which a corresponding SRS resource is transmitted, as defined previously. Therefore, an R value configurable for the UE may be a divisor of Nₛ as described above. In a case where N antenna ports are configured for a single SRS resource and some of the N antenna ports are transmitted on each transmission symbol, if it is assumed that M symbols are needed to transmit all of the N antenna ports, a minimum value of R is 1 or M.
If a minimum value of R configurable for the UE is 1, this implies that the number of consecutive symbols having the same frequency resource is 1. In this case, it is possible to transmit only some of the N antenna ports on one symbol, and thus an SRS corresponding to corresponding antenna ports may be transmitted on different frequency positions for each group of particular some antenna ports among the N antenna ports. Therefore, it is not possible for an SRS corresponding to all the N antenna ports to be transmitted on the same frequency position, and thus when the base station receives the SRS and performs channel estimation, channel information of a particular antenna port may be absent in some frequency resource positions. Accordingly, the base station may need to estimate channel information of a frequency position where channel information is absent, by using a frequency position where channel information is present. In this case, a frequency band of SRS transmission estimable by the base station may be broadened, but channel estimation performance at a frequency position where channel information of a particular antenna port is absent may be degraded.
If a minimum value of R configurable for the UE is M, this implies that the number of consecutive symbols having the same frequency resource is M. In this case, it is possible to transmit all the N antenna ports during M symbols, and thus an SRS corresponding to the N antenna ports may be transmitted on the same frequency position. Therefore, when the base station receives the SRS and performs channel estimation, channel information on all the N antenna ports may be acquired in all frequency positions. In this case, a frequency band of SRS transmission estimable by the base station may be reduced compared to a case where the minimum value of R is 1, but all the antenna ports are transmitted in all the frequency positions, and thus channel estimation performance may be enhanced.
The minimum value of R configurable for the UE may be configured via higher layer signaling among 1 or M, indicated via L1 signaling, notified by a combination of higher layer signaling and L1 signaling, activated/deactivated via MAC-CE signaling, or fixedly defined and operated in a specification.

Based on time resource operation 2-2 described above, the UE may be able to perform the following operation according to a combination of the higher layer signalings startPosition, nrofSymbols, and repetitionFactor for periodic/semi-persistent/aperiodic SRS transmission.
Nₛ may be configured to be 1, 2, 4, 5, 6, or 7 for the UE with respect to an aperiodic SRS, R may be configured to be 1 or M, only intra-slot frequency hopping may be possible when frequency hopping is performed, and the number of consecutive symbols having frequency resources of the same position when frequency hopping is performed may be 1 or M (=R). Determination of the R value may follow one of the above schemes.
The higher layer signaling Nₛ may be configured to be a value (=one of 2, 4, 5, 6, and 7) greater than or equal to 2 for the UE with respect to an aperiodic SRS, R may be configured to be a value greater than or equal to 2 or a value greater than or equal to M, only intra-slot frequency hopping may be possible when frequency hopping is performed, and the number of consecutive symbols having frequency resources of the same position when frequency hopping is performed may be R.
Nₛ may be configured to be M for the UE with respect to a periodic/semi-persistent SRS, R may be configured to be M, only inter-slot frequency hopping may be possible when frequency hopping is performed, and the number of consecutive symbols having frequency resources of the same position when frequency hopping is performed may be M (=R).
The higher layer signaling Nₛ may be configured to be a value (=one of 2, 4, 5, 6, and 7) greater than or equal to 2 for the UE with respect to a periodic/semi-persistent SRS, R may be configured to be a value greater than or equal to 2 or a value greater than or equal to M, intra-slot or inter-slot frequency hopping may be possible when frequency hopping is performed, and the number of consecutive symbols having frequency resources of the same position when frequency hopping is performed may be R.
The higher layer signaling Nₛ may be configured to be a value (=one of 2, 4, 5, 6, and 7) greater than or equal to 2 for the UE with respect to a periodic/semi-persistent SRS, R may be configured to be a value identical to M*Nₛ, intra-slot or inter-slot frequency hopping may be possible when frequency hopping is performed, and the number of consecutive symbols having frequency resources of the same position when frequency hopping is performed may be R (=M*Nₛ).

When [Method 1-3] is used in the above embodiment, that is, when N antenna ports are configured for the entirety of multiple SRS resources and some of the N antenna ports are configured and transmitted per SRS resource, the UE may perform the following operation by considering the definitions of the higher layer signalings startPosition, nrofSymbols, and repetitionFactor as described below.

### [Time Resource Operation 3-1]

The UE may configure a total number of symbols on which multiple SRS resources are transmitted as Nₛ of each SRS resource. If each of n SRS resources is transmitted on M symbols, Nₛ may be equal to n*M and Nₛ in each SRS resource may be configured to have the same value. In a case where N antenna ports are configured for multiple SRS resources and some of the N antenna ports are transmitted per SRS resource, if it is assumed that m symbols (m may be smaller than or equal to M) for each SRS resource are needed to transmit all of the N antenna ports, the UE may expect that Nₛ having divisors of m and M is configured for each SRS resource. For example, if two SRS resources capable of representing N(=8) antenna ports are configured for the UE and each SRS resource is transmitted on M (=2) symbols, one of the values of Nₛ (=2, 4, 8, 10, 12, and 14) having a divisor of M=2 for each of the multiple SRS resources may be configured for the UE. If Nₛ is equal to 4, a total number of symbols on which the multiple SRS resources are transmitted is 4, and the UE may expect that some four (e.g., SRS antenna ports 0-3) of the total of eight antenna ports are configured for a first SRS resource among the two SRS resources, the SRS resource (the first SRS resource) is transmitted on first and third symbols, other some four (e.g., SRS antenna ports 4-7) of the total of eight antenna ports are configured for a second SRS resource, and the SRS resource (the second SRS resource) is transmitted on second and fourth symbols. As another method, the UE may expect that the SRS resource is transmitted on first two symbols through some four (e.g., SRS antenna ports 0-3) of the total of eight antenna ports and the SRS resource is transmitted on remaining two symbols through some other four (e.g., SRS antenna ports 4-7) of the total of eight antenna ports. (The disclosure is not limited to the above example, and as another example, some four of the total of eight antenna ports may be configured to be SRS antenna ports 0, 2, 4, and 6.)

The UE may assume that the definition of R indicates the number of consecutive symbols which has frequency resources of the same position and on which a corresponding SRS resource is transmitted, as defined previously. Therefore, an R value configurable for the UE may be a divisor of Nₛ as described above. In a case where N antenna ports are configured for multiple SRS resources and each SRS resource is transmitted through some of the N antenna ports, if it is assumed that m symbols are needed to transmit the SRS resources through all of the N antenna ports, a minimum value of R is 1 or m.
If a minimum value of R configurable for the UE is 1, this implies that the number of consecutive symbols having the same frequency resource is 1. In this case, it is possible to transmit only some of the N antenna ports on one symbol, and thus an SRS corresponding to corresponding antenna ports may be transmitted on different frequency positions for each group of particular some antenna ports among the N antenna ports. Therefore, it is not possible for an SRS corresponding to all the N antenna ports to be transmitted on the same frequency position, and thus when the base station receives the SRS and performs channel estimation, channel information of a particular antenna port may be absent in some frequency resource positions. Accordingly, the base station may need to estimate channel information of a frequency position where channel information is absent, by using a frequency position where channel information is present. In this case, a frequency band of SRS transmission estimable by the base station may be broadened, but channel estimation performance at a frequency position where channel information of a particular antenna port is absent may be degraded.
If a minimum value of R configurable for the UE is m, this implies that the number of consecutive symbols having the same frequency resource is m. In this case, it is possible to transmit all the N antenna ports during m symbols, and thus an SRS corresponding to the N antenna ports may be transmitted on the same frequency position. Therefore, when the base station receives the SRS and performs channel estimation, channel information on all the N antenna ports may be acquired in all frequency positions. In this case, a frequency band of SRS transmission estimable by the base station may be reduced compared to a case where the minimum value of R is 1, but all the antenna ports are transmitted in all the frequency positions, and thus channel estimation performance may be enhanced.
The minimum value of R configurable for the UE may be configured via higher layer signaling among 1 or m, indicated via L1 signaling, notified by a combination of higher layer signaling and L1 signaling, activated/deactivated via MAC-CE signaling, or fixedly defined and operated in a specification.

Based on time resource operation 3-1 described above, the UE may be able to perform the following operation according to a combination of the higher layer signalings startPosition, nrofSymbols, and repetitionFactor for periodic/semi-persistent/aperiodic SRS transmission.
Nₛ may be configured to be 2, 4, 8, 10, 12, or 14 for the UE with respect to an aperiodic SRS, R may be configured to be 1 or m, wherein m may be a divisor of Nₛ, only intra-slot frequency hopping may be possible when frequency hopping is performed, and the number of consecutive symbols having frequency resources of the same position when frequency hopping is performed may be 1 or m (=R). Determination of the R value may follow one of the above schemes.
The higher layer signaling Nₛ may be configured to be a value greater than or equal to 4 for the UE with respect to an aperiodic SRS, R may be configured to be a value greater than or equal to 2 or a value greater than or equal to m, wherein R or m may be a divisor of Nₛ, only intra-slot frequency hopping may be possible when frequency hopping is performed, and the number of consecutive symbols having frequency resources of the same position when frequency hopping is performed may be R.
Nₛ may be configured to be m for the UE with respect to a periodic/semi-persistent SRS, R may be configured to be m, only inter-slot frequency hopping may be possible when frequency hopping is performed, and the number of consecutive symbols having frequency resources of the same position when frequency hopping is performed may be m (=R).
The higher layer signaling Nₛ may be configured to be a value greater than or equal to 4 for the UE with respect to a periodic/semi-persistent SRS, R may be configured to be a value greater than or equal to 2 or a value greater than or equal to m, wherein R or m may be a divisor of Nₛ, intra-slot or inter-slot frequency hopping may be possible when frequency hopping is performed, and the number of consecutive symbols having frequency resources of the same position when frequency hopping is performed may be R.
The higher layer signaling Nₛ may be configured to be a value greater than or equal to 4 for the UE with respect to a periodic/semi-persistent SRS, R may be configured to be a value identical to Nₛ, intra-slot or inter-slot frequency hopping may be possible when frequency hopping is performed, and the number of consecutive symbols having frequency resources of the same position when frequency hopping is performed may be R (=Nₛ).

### [Time Resource Operation 3-2]

The UE may configure the number of symbols on which each of multiple SRS resources is transmitted as Nₛ of each SRS resource. In a case where N antenna ports are configured for m SRS resources and each SRS resource is transmitted through some of the N antenna ports, if it is assumed that m symbols are needed for the entirety of the m SRS resources to transmit the SRS resources through all of the N antenna ports, the UE may expect that all the SRS resources are transmitted through the N antenna ports on a total of m*Nₛ symbols. For example, if m (=2) SRS resources capable of representing N(=8) antenna ports are configured for the UE and each SRS resource is transmitted on Nₛ (=2) symbols through four antenna ports, one of the values of Nₛ (=1, 2, 4, 5, 6, and 7) for each of the multiple SRS resources may be configured for the UE. If Nₛ is equal to 2, a total number of symbols on which the two SRS resources are transmitted is 4, and the UE may expect that some four (e.g., SRS antenna ports 0-3) of the total of eight antenna ports are configured for a first SRS resource among the two SRS resources, the SRS resource (the first SRS resource) is transmitted on first and third symbols, other some four (e.g., SRS antenna ports 4-7) of the total of eight antenna ports are configured for a second SRS resource, and the SRS resource (the second SRS resource) is transmitted on second and fourth symbols. As another method, the UE may expect that the SRS resource is transmitted on first two symbols through some four (e.g., SRS antenna ports 0-3) of the total of eight antenna ports and the SRS resource is transmitted on remaining two symbols through some other four (e.g., SRS antenna ports 4-7) of the total of eight antenna ports. (The disclosure is not limited to the above example, and as another example, some four of the total of eight antenna ports may be configured to be SRS antenna ports 0, 2, 4, and 6.)

The UE may assume that the definition of R indicates the number of consecutive symbols which has frequency resources of the same position and on which a corresponding SRS resource is transmitted, as defined previously. Therefore, an R value configurable for the UE may be a divisor of Nₛ as described above. In a case where N antenna ports are configured for multiple SRS resources and some of the N antenna ports are transmitted for each SRS resource, if it is assumed that m symbols are needed to transmit all of the N antenna ports, a minimum value of R is 1 or m.
If a minimum value of R configurable for the UE is 1, this implies that the number of consecutive symbols having the same frequency resource is 1. In this case, it is possible to transmit only some of the N antenna ports on one symbol, and thus an SRS corresponding to corresponding antenna ports may be transmitted on different frequency positions for each group of particular some antenna ports among the N antenna ports. Therefore, it is not possible for an SRS corresponding to all the N antenna ports to be transmitted on the same frequency position, and thus when the base station receives the SRS and performs channel estimation, channel information of a particular antenna port may be absent in some frequency resource positions. Accordingly, the base station may need to estimate channel information of a frequency position where channel information is absent, by using a frequency position where channel information is present. In this case, a frequency band of SRS transmission estimable by the base station may be broadened, but channel estimation performance at a frequency position where channel information of a particular antenna port is absent may be degraded.
If a minimum value of R configurable for the UE is m, this implies that the number of consecutive symbols having the same frequency resource is m. In this case, it is possible to transmit all the N antenna ports during m symbols, and thus an SRS corresponding to the N antenna ports may be transmitted on the same frequency position. Therefore, when the base station receives the SRS and performs channel estimation, channel information on all the N antenna ports may be acquired in all frequency positions. In this case, a frequency band of SRS transmission estimable by the base station may be reduced compared to a case where the minimum value of R is 1, but all the antenna ports are transmitted in all the frequency positions, and thus channel estimation performance may be enhanced.
The minimum value of R configurable for the UE may be configured via higher layer signaling among 1 or m, indicated via L1 signaling, notified by a combination of higher layer signaling and L1 signaling, activated/deactivated via MAC-CE signaling, or fixedly defined and operated in a specification.

Based on time resource operation 3-2 described above, the UE may be able to perform the following operation according to a combination of the higher layer signalings startPosition, nrofSymbols, and repetitionFactor for periodic/semi-persistent/aperiodic SRS transmission.
Nₛ may be configured to be 1, 2, 4, 5, 6, or 7 for the UE with respect to an aperiodic SRS, R may be configured to be 1 or m, only intra-slot frequency hopping may be possible when frequency hopping is performed, and the number of consecutive symbols having frequency resources of the same position when frequency hopping is performed may be 1 or m (=R). Determination of the R value may follow one of the above schemes.
The higher layer signaling Nₛ may be configured to be a value (=one of 2, 4, 5, 6, and 7) greater than or equal to 2 for the UE with respect to an aperiodic SRS, R may be configured to be a value greater than or equal to 2 or a value greater than or equal to m, only intra-slot frequency hopping may be possible when frequency hopping is performed, and the number of consecutive symbols having frequency resources of the same position when frequency hopping is performed may be R.
Nₛ may be configured to be 1 for the UE with respect to a periodic/semi-persistent SRS, R may be configured to be 1, only inter-slot frequency hopping may be possible when frequency hopping is performed, and the number of consecutive symbols having frequency resources of the same position when frequency hopping is performed may be R.
The higher layer signaling Nₛ may be configured to be a value (=one of 2, 4, 5, 6, and 7) greater than or equal to 2 for the UE with respect to a periodic/semi-persistent SRS, R may be configured to be a value greater than or equal to 2 or a value greater than or equal to m, intra-slot or inter-slot frequency hopping may be possible when frequency hopping is performed, and the number of consecutive symbols having frequency resources of the same position when frequency hopping is performed may be R.
The higher layer signaling Nₛ may be configured to be a value (=one of 2, 4, 5, 6, and 7) greater than or equal to 2 for the UE with respect to a periodic/semi-persistent SRS, R may be configured to be a value identical to m*Nₛ, intra-slot or inter-slot frequency hopping may be possible when frequency hopping is performed, and the number of consecutive symbols having frequency resources of the same position when frequency hopping is performed may be R (=m*Nₛ).

The UE may report, to the base station as a UE capability, whether the UE is able to support a combination of at least one of [Time resource operation 2-1], [Time resource operation 2-2], [Time resource operation 3-1], and [Time resource operation 3-2] above. The UE capability reporting may be performed differently according to frequency ranges (FRs), or may be performed per band, per band combination, per feature set, or per feature set per CC. In addition, the above UE capability may be an independent UE capability, or whether respective methods are supported may be defined as multiple components in a single UE capability.

A combination of at least one of [Time resource operation 2-1], [Time resource operation 2-2], [Time resource operation 3-1], and [Time resource operation 3-2] above may be configured for the UE by the base station via higher layer signaling, indicated via L1 signaling, notified by a combination of higher layer signaling and L1 signaling, activated/deactivated via MAC-CE signaling, or fixedly defined and operated in a specification.

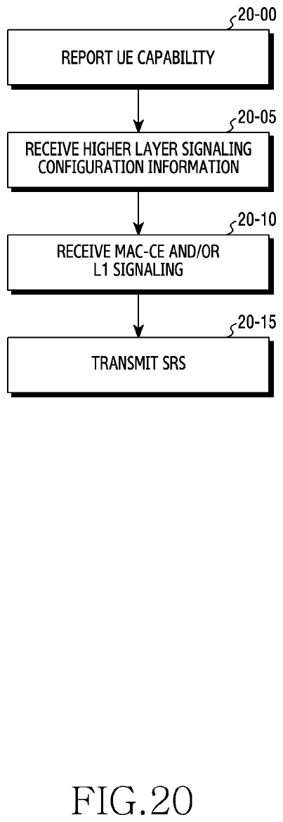

FIG. 20 is a diagram illustrating an operation of a UE for SRS transmission according to an embodiment of the disclosure.

A UE may report a UE capability to a base station (operation 20-00). A UE capability report may be a combination of at least one of UE capabilities mentioned in the above embodiment. For example, the UE capability reported by the UE may include at least one of UE capabilities indicating whether to support [Method 1-1] to [Method 1-4], whether to support [Method 1-3-1] to [Method 1-3-3], and whether to support [Time resource operation 2-1], [Time resource operation 2-2], [Time resource operation 3-1], and [Time resource operation 3-2].

Thereafter, the UE may receive higher layer signaling configuration information from the base station (operation 20-05). Higher layer signaling may be a combination of at least one of pieces of higher layer signaling configuration information mentioned in the above embodiment. For example, the higher layer signaling may be higher layer signaling related to at least one of [Method 1-1] to [Method 1-4], [Method 1-3-1] to [Method 1-3-3], [Time resource operation 2-1], [Time resource operation 2-2], [Time resource operation 3-1], and [Time resource operation 3-2].

The UE may additionally receive MAC-CE and/or L1 signaling from the base station (operation 20-10). For example, the MAC-CE and/or L1 signaling may be MAC-CE and/or L1 signaling related to at least one of [Method 1-1] to [Method 1-4], [Method 1-3-1] to [Method 1-3-3], [Time resource operation 2-1], [Time resource operation 2-2], [Time resource operation 3-1], and [Time resource operation 3-2]. The UE may transmit an SRS having N antenna ports, based on an indication received from the base station through the higher layer signaling and MAC-CE and/or L1 signaling described above (operation 20-15).

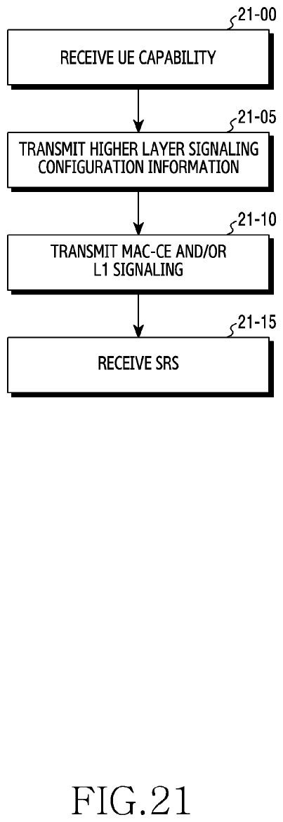

FIG. 21 is a diagram illustrating an operation of a base station for SRS reception according to an embodiment of the disclosure.

A base station may receive a UE capability from a UE (operation 21-00). A UE capability report may be a combination of at least one of UE capabilities mentioned in the above embodiment. For example, the UE capability reported by the UE may include at least one of UE capabilities indicating whether to support [Method 1-1] to [Method 1-4], whether to support [Method 1-3-1] to [Method 1-3-3], and whether to support [Time resource operation 2-1], [Time resource operation 2-2], [Time resource operation 3-1], and [Time resource operation 3-2].

Thereafter, the base station may transmit higher layer signaling configuration information to the UE (operation 21-05). Higher layer signaling may be a combination of at least one of pieces of higher layer signaling configuration information mentioned in the above embodiment. For example, the higher layer signaling may be higher layer signaling related to at least one of [Method 1-1] to [Method 1-4], [Method 1-3-1] to [Method 1-3-3], [Time resource operation 2-1], [Time resource operation 2-2], [Time resource operation 3-1], and [Time resource operation 3-2].

The base station may additionally transmit MAC-CE and/or L1 signaling to the UE (operation 21-10). For example, the MAC-CE and/or L1 signaling may be MAC-CE and/or L1 signaling related to at least one of [Method 1-1] to [Method 1-4], [Method 1-3-1] to [Method 1-3-3], [Time resource operation 2-1], [Time resource operation 2-2], [Time resource operation 3-1], and [Time resource operation 3-2]. The base station may receive an SRS having N antenna ports transmitted by the UE, based on information indicated through the higher layer signaling and MAC-CE and/or L1 signaling described above (operation 21-15).

### Third Embodiment: TPC Timeline Determination Method

As an embodiment of the disclosure, a TPC timeline determination method to be applied at the time of SRS transmission of the UE according to the SRS resource configuration and indication method described in the above embodiment is described.

A method of, when the UE performs transmission through an uplink reference signal (sounding reference signal, SRS) in response to a power control command received from a base station, configuring the transmission power of the uplink reference signal and transmitting same by the UE will be described. Uplink reference signal transmission power of the UE together with an SRS power control adjustment state corresponding to the i-th SRS transmission occasion and closed loop index l may be determined as Equation 8 below expressed by a unit of dBm. In Equation 8 below, when the UE supports multiple carrier frequencies in multiple cells, each parameter may be determined by cell c, carrier frequency f and bandwidth part b, and may be distinguished by the indexes b, f and c.

$${P}_{SRS , b , f , c} ( i , {q}_{s} , l ) = min \{ \begin{matrix}{P}_{CMAX , f , c} ( i ) , {P}_{0 \_ SRS , b , f , c} ( {q}_{s} ) + \\ 10 {log}_{10} ( {2}^{μ} * {M}_{SRS , b , f , c} ( i ) ) + {α}_{SRS , b , f , c} ( {q}_{s} ) \cdot \\ {PL}_{b , f , c} ( {q}_{d} ) + {h}_{b , f , c} ( i , l )\end{matrix} \} [ dBm ] \qquad [ Equation 8 ]$$

P_{CMAX,f,c}(i): This is maximum transmission power usable by the UE in the i-th transmission occasion, and is determined by the power class of the UE, and parameters activated by the base station and various parameters embedded in the UE.
P_{0_SRS,b,f,c}(qₛ): This may be configured by the higher layer signaling p0 for bandwidth part b, carrier frequency f and cell c, and the SRS resource set qₛ may be configured through the higher layer signalings SRS-ResourceSet and SRS-ResourceSetId.
μ: Subcarrier spacing configuration value
M_{SRS,b,f,c}(i): This may indicate a resource amount (e.g., the number of resource blocks (RBs) used for SRS transmission on the frequency axis) used in the i-th SRS transmission occasion.
M_{SRS,b,f,c}(i): This may be configured by the higher layer signaling alpha for bandwidth part b, carrier frequency f and cell c, and the SRS resource set qₛ may be configured through the higher layer signalings SRS-ResourceSet and SRS-ResourceSetId.
PL_{b,f,c}(q_{d}): This represents a pathloss between the base station and the UE, and the UE calculates a pathloss from the difference between the transmission power of a reference signal (RS) resource qa signaled by the base station and the UE reception signal level of a reference signal.
h_{b,f,c}(i,l): This may indicate an SRS power control adjustment state value for the i-th SRS transmission occasion corresponding to closed loop index l in bandwidth part b, carrier frequency f and cell c.

The SRS power control adjustment state may be determined through bandwidth part b, carrier frequency f cell c, and the i-th transmission occasion.

If the UE is configured to have the same power control adjustment state value between SRS transmission and PUSCH transmission through the higher layer signaling srs-PowerControlAdjustmentStates, the SRS power control adjustment state may be represented as shown in Equation 9 below, f_{b,f,c}(i,l) in Equation 9 may indicate a current PUSCH power control adjustment state, and the value may be substituted into h_{b,f,c}(i,l) for use.

$${h}_{b , f , c} ( i , l ) = {f}_{b , f , c} ( i , l ) \qquad [ Equation 9 ]$$

If the UE fails to be configured for PUSCH transmission in bandwidth part b, carrier frequency f and cell c, the UE is configured to have different power control adjustment state values between SRS transmission and PUSCH transmission through the higher layer signaling srs-PowerControlAdjustmentStates, and the higher layer signaling tpc-Accumulation is not configured, an SRS power control adjustment state may be represented independently to closed loop l as shown in Equation 10 below.

TABLE 36

| TPC | Accumulated δ_{PUCSH, b, f, c} or δ_{SRS, b, f, c} |
|---|---|
| command | [dB] (when no tpc-Accumulation is |
| field value | configured) |
| 0 | −1 |
| 1 | 0 |
| 2 | 1 |
| 3 | 3 |

$${h}_{b , f , c} ( i ) = {h}_{b , f , c} ( i - {i}_{0} ) + {\sum }_{m = 0}^{c ( {S}_{i} ) - 1} {δ}_{SRS , b , f , c} ( m ) \qquad [ Equation 10 ]$$

S_{SRS,b,f,c}(m): This may be a value indicated by a TPC command field included in DCI format 2_3, and the value may follow Table 36 above.

$$- {\sum }_{m = 0}^{c ( {S}_{i} ) - 1} {δ}_{SRS , b , f , c} ( m )$$

may indicate the sum of δ_{SRS,b,f,c} for all corresponding transmission occasions in the particular set Sᵢ according to the above TPC command value. c(Sᵢ) may indicate the number of all elements belonging to the set Sᵢ. Sᵢ may indicate a set of pieces of DCI including all TPC command values to which a TPC command accumulation operation is to be performed for the i-th PUSCH transmission occasion. In order to determine Sᵢ, a start point and an end point on the time dimension are defined and the pieces of DCI received by the UE between the two points may all be included as the elements of Sᵢ.
The end point for determining Sᵢ may be a point preceding the start symbol of the i-th SRS transmission occasion by K_{SRS}(i) symbols.
The start point for determining Sᵢ may be a point preceding the start symbol of the (i−i₀)-th SRS transmission occasion by K_{SRS}(i−i₀)−1 symbols. i₀, which is a positive integer, may be determined to be the smallest value satisfying that a time point preceding the start symbol of the (i−i₀)-th SRS transmission occasion by K_{SRS}(i) or K_{SRS}(i−i₀) symbols is earlier, in time, than the end point for determining Sᵢ (e.g., a point preceding the start symbol of the i-th SRS transmission occasion by K_{SRS}(i) symbols).

For example, when the end point for determining Sᵢ may be defined as sym(i), and the time point preceding the start symbol of the (i−i₀)-th SRS transmission occasion by K_{SRS}(i−₀) symbols may be defined as sym(i−i₀), if the expression sym(i)=sym(i−1)>sym(i−2)>sym(i−3) is satisfied, i₀ may be determined to be 2.

If the UE fails to be configured for PUSCH transmission in bandwidth part b, carrier frequency f and cell c, or the UE is configured to have different power control adjustment state values between SRS transmission and PUSCH transmission through the higher layer signaling srs-PowerControlAdjustmentStates, and the higher layer signaling tpc-Accumulation is configured (i.e., the UE is unable to perform a TPC command accumulation operation and an absolute TCP command value is applicable), an SRS power control adjustment state may be represented independently to closed loop l as shown in Equation 11 below.

TABLE 37

| TPC command | Absolute δ_{PUCSH, b, f, c} or δ_{SRS, b, f, c} [dB] |
|---|---|
| field value | (when tpc-Accumulation is configured) |
| 0 | −4 |
| 1 | −1 |
| 2 | 1 |
| 3 | 4 |

$${h}_{b , f , c} ( i ) = {δ}_{SRS , b , f , c} ( i ) \qquad [ Equation 11 ]$$

S_{SRS,b,f,c}(i) may be, as described above, a value indicated by a TPC command field included in DCI format 2_3 in bandwidth part b, carrier frequency f and cell c, and the value may follow Table 37 above. For example, if the value of the TPC command field is 0, S_{SRS,b,f,c} may have a value of −4 dB.
Various methods for determining the definition of K_{SRS}(i) applicable to the i-th SRS transmission occasion in bandwidth part b, carrier frequency f, and cell c may be considered according to a case where the UE is able to perform a TPC command accumulation operation described above (i.e., the higher layer signaling tpc-Accumulation is not configured), or various methods for determining the definition of S_{SRS,b,f,c}(i) applicable to the i-th SRS transmission occasion in bandwidth part b, carrier frequency f, and cell c may be considered according to a case where the UE is unable to performing a TPC command accumulation operation and operates through an absolute value (i.e., the higher layer signaling tpc-Accumulation is configured).

### [Condition 3-1]

If aperiodic SRS transmission triggering is indicated to the UE from the base station through a DCI format

### [Condition 3-1-1]

In addition to Condition 3-1 above, if the UE is able to perform a TPC command accumulation operation (i.e., the higher layer signaling tpc-Accumulation is not configured)

[Method 3-1-1-1]K_{SRS}(i) applicable to the i-th SRS transmission occasion may indicate a symbol length from the end point of the last symbol on which a PDCCH having triggered the i-th SRS transmission occasion is received, to the start point of the i-th SRS transmission occasion.
If i-th, (i+1)-th, . . . , and (i+N−1)-th SRS transmission occasions are triggered for the UE through reception of one corresponding PDCCH, all K_{SRS}(i), K_{SRS}(+1), . . . , and K_{SRS}(i+N−1) applicable to the i-th, (i+1)-th, . . . , and (i+N−1)-th SRS transmission occasions may be determined by the same last symbol of the PDCCH. Therefore, the end points for determining Sᵢ are all the same as described above, and thus the values obtained by applying TPC command accumulation may be all the same for all the SRS transmission occasions scheduled by the PDCCH. In this case, applying a power control value determinable at a PDCCH triggering time point to all SRS transmission occasions has the advantage of simplifying the UE's operation without adding complexity. However, this method may not be flexible in that dynamic power control via L1 signaling (e.g., DCI format 2_3) is not possible for SRS transmission occasions transmitted later in time.

[Method 3-1-1-2]K_{SRS}(i) applicable to the i-th SRS transmission occasion may indicate a symbol length from the end point of the last symbol on which a PDCCH having triggered the i-th SRS transmission occasion is received, to the start point of an SRS transmission occasion that is transmitted earliest in time among all SRS transmission occasions triggered by the PDCCH.
If one SRS transmission occasion is triggered for the UE through reception of one corresponding PDCCH, Method 3-1-1-2 may derive the same K_{SRS}(i) value as Method 3-1-1-1 above.
If i-th, (i+1)-th, . . . , and (i+N−1)-th SRS transmission occasions are triggered for the UE through reception of one corresponding PDCCH, K_{SRS}(i), K_{SRS}(i+1), . . . , and K_{SRS}(i+N−1) applicable to the i-th, (i+1)-th, . . . , and (i+N−1)-th SRS transmission occasions may have the same value as K_{SRS}(i) which is applicable to the i-th SRS transmission occasion that is transmitted earliest in time among all the SRS transmission occasions triggered by the PDCCH. Therefore, the end points for determining Sᵢ are different as described above, and thus a value to which TPC command accumulation may vary for each of the SRS transmission occasions scheduled by the PDCCH. In this case, not only a power control value determinable at the PDCCH triggering point is used, but dynamic power control via L1 signaling (e.g., DCI format 2_3) is also possible for SRS transmission occasions that are transmitted later in time. Therefore, this method may lead to increased complexity in UE operation but is a more flexible approach from a power control perspective.

[Method 3-1-1-3]K_{SRS}(i) applicable to the i-th SRS transmission occasion may indicate a symbol length configured through higher layer signaling.
If one SRS transmission occasion is triggered for the UE through reception of one corresponding PDCCH, one symbol length may be configured for the UE through higher layer signaling.
If i-th, (i+1)-th, . . . , and (i+N−1)-th SRS transmission occasions are triggered for the UE through reception of one corresponding PDCCH, K_{SRS}(i), K_{SRS}(i+1), . . . , K_{SRS}(i+N−1) applicable to the i-th, (i+1)-th, . . . , and (i+N−1)-th SRS transmission occasions may all have the same value, based on one higher layer signaling value, or may have respective different values, based on N different higher layer signalings. Therefore, the end points for determining Sᵢ are different as described above, and thus a value to which TPC command accumulation may vary for each of the SRS transmission occasions scheduled by the PDCCH. In addition, if Method 3-1-1-2 is used, a symbol interval to the first SRS transmission occasion triggered by a random PDCCH may not be always the same as a symbol interval to the first SRS transmission occasion triggered by another PDCCH, and thus, K_{SRS}(i) required to be considered from a particular SRS transmission occasion may vary according to different PDCCH triggering. On the contrary, if a corresponding value is configured through higher layer signaling as in Method 3-1-1-3, there may be an advantage in that a UE operation may be relatively simply and consistently controlled.
If there is one higher layer signaling described above,
   For example, the signaling may have a value in units of symbols as independent higher layer signaling for TCP command accumulation, and may be defined as K_{SRS,min}.
   As another example, the signaling may be the number of symbols obtained by multiplying, by 14, the smallest value among all triggering slot offsets k2 or k2-16 that are higher layer signalings configured in all TDRA entries, and may be defined as K_{SRS,min}.
   As another example, the signaling may be the number of symbols obtained by multiplying, by 14, the smallest value among all SRS triggering slot offset values configured in all SRS resource sets, and may be defined as K_{SRS,min}.
   As another example, the signaling may be the number of symbols obtained by multiplying, by 14, the smallest value of triggering slot offsets k2 configured in the higher layer signaling PUSCH-ConfigCommon, and may be defined as K_{SRS,min}.
If there are multiple higher layer signalings described above,
   For example, the signalings may have values in units of symbols as independent multiple higher layer signalings for TCP command accumulation, and if a repeated transmission count is N, the values may be defined as K_{SRS,min,1}, . . . , and K_{SRS,min,N}.
   As another example, the signalings may be the numbers of symbols obtained by multiplying, by 14, a number of k2 or k2-16 values equal to the number of SRS transmission occasions triggered by the PDCCH among the smallest values of all triggering slot offsets k2 or k2-16 that are higher layer signalings configured in all TDRA entries, and if a repeated transmission count is N, may be defined as K_{SRS,min,1} . . . , and K_{SRS,min,N}.
   As another example, the signalings may be the numbers of symbols obtained by multiplying, by 14, a number of slot offsets equal to the number of SRS transmission occasions triggered by the PDCCH among the smallest values of all SRS triggering slot offset values configured in all SRS resource sets, and if a repeated transmission count is N, may be defined as K_{SRS,min,1}, . . . , and K_{SRS,min,N}.
   As another example, the signalings may be the numbers of symbols obtained by multiplying, by 14, a number of offsets k2 equal to the number of SRS transmission occasions triggered by the PDCCH among the smallest values of all triggering slot offsets k2 configured in the higher layer signaling PUSCH-ConfigCommon, and if a repeated transmission count is N, may be defined as K_{SRS,min,1} . . . , and K_{SRS,min,N}.

[Method 3-1-1-4]K_{SRS}(i) applicable to the i-th SRS transmission occasion may, if the i-th SRS transmission occasion is the first SRS transmission occasion triggered through a PDCCH, indicate a symbol length from the end point of the last symbol on which the PDCCH is received, to the start point of the i-th SRS transmission occasion, and if the i-th SRS transmission occasion is not the first SRS transmission occasion triggered through a PDCCH, indicate a symbol length from the end point of the last symbol on which the (i−1)-th SRS transmission occasion is transmitted, to the start point of the i-th SRS transmission occasion.
If one SRS transmission occasion is triggered for the UE through reception of one corresponding PDCCH, Method 3-1-1-4 may derive the same K_{SRS}(i) value as Method 3-1-1-1 above.
If i-th, (i+1)-th, . . . , and (i+N−1)-th SRS transmission occasions are triggered for the UE through reception of one corresponding PDCCH, K_{SRS}(i) applicable to the i-th SRS transmission occasion is calculated using the time points of the PDCCH scheduling same and the i-th SRS transmission occasion, and when K_{SRS}(i), K_{SRS}(i+1), . . . , and K_{SRS}(i+N−1) applicable to the (i+1)-th, . . . , and (i+N−1)-th SRS transmission occasions are determined, a method of considering the i-th, . . . , and (i+N−2)-th SRS transmission occasions to be similar to the PDCCH having been used to calculate K_{SRS}(i) for the i-th SRS transmission occasion may be used.

[Method 3-1-1-5]K_{SRS}(i) applicable to the i-th SRS transmission occasion may, if the i-th SRS transmission occasion is the first SRS transmission occasion triggered through a PDCCH, indicate a symbol length from the end point of the last symbol on which the PDCCH is received, to the start point of the i-th SRS transmission occasion, and if the i-th SRS transmission occasion is not the first SRS transmission occasion triggered through a PDCCH, indicate a symbol length from the end point of the closest downlink symbol existing before the i-th SRS transmission occasion, to the start point of the i-th transmission occasion.

If one SRS transmission occasion is triggered for the UE through reception of one corresponding PDCCH, Method 3-1-1-5 may derive the same K_{SRS}(i) value as Method 3-1-1-1 above.

[Method 3-1-1-6] The UE may define K_{SRS}(i) applicable to the i-th SRS transmission occasion through a combination of Methods 3-1-1-1 to 3-1-1-5 described above. For example, if N repeated i-th, (i+1)-th, . . . , and (i+N−1)-th SRS transmission occasions are triggered for the UE through a PDCCH, Method 3-1-1-1 is used as a method of defining K_{SRS}(i) for the i-th SRS transmission occasion, which is the first transmission occasion, and [Method 3-1-1-2] may be used for K_{SRS}(i), K_{SRS}(i+1), . . . , and K_{SRS}(i+N−1) for the remaining (i+1)-th, . . . , and (i+N−1)-th SRS transmission occasions.

[Method 3-1-1-7] The UE may configure one of Methods 3-1-1-1 to 3-1-1-6 described above through higher layer signaling from the base station, and use same as a method of defining K_{SRS}(i). For example, the UE may receive a configuration referred to as the higher layer signaling tpcAccumulationTimeDetermination from the base station, the higher layer signaling may be configured to be one of scheme1 to scheme6, and scheme1 to scheme6 may indicate Methods 3-1-1-1 to 3-1-1-6 described above, respectively.

[Method 3-1-1-8] Higher layer signaling indicating whether to use a method of defining K_{SRS}(i) may be configured for the UE by the base station (e.g., enableTPCAccumulationTimeDetermination). If the higher layer signaling is not configured, this may imply that one (e.g., Method 3-1-1-1) of Methods 3-1-1-1 to 3-1-1-6 described above is used to define K_{SRS}(i), and if the higher layer signaling is configured (e.g., a configuration value of “on” is received by the UE), this indicates that a particular K_{SRS}(i) defining method is available. The particular K_{SRS}(i) defining method may be one (e.g., method 3-1-1-6) of methods remaining after excluding a method used when the higher layer signaling is not configured from Methods 3-1-1-1 to 3-1-1-6 described above.

[Method 3-1-1-1] to [Method 3-1-1-8] described above may also be applied to a UE operation scheme in all time dimensions of SRS transmission. For example, [Method 3-1-1-1] to [Method 3-1-1-8] described above may also be applied to all the periodic, semi-persistent, and aperiodic SRS transmission. In addition, some of [Method 3-1-1-1] to [Method 3-1-1-8] described above may be applied to only some time-dimensional operations and the remaining some may be applied to only the remaining some time-dimensional operations. For example, [Method 3-1-1-3] above may be applied to periodic and semi-persistent SRS transmission, and [Method 3-1-1-1] may be applied to aperiodic SRS transmission

### [Condition 3-1-2]

In addition to Condition 3-1 above, if the UE is unable to perform a TPC command accumulation operation and operates through an absolute value (i.e., the higher layer signaling tpc-Accumulation is configured)

[Method 3-1-2-1]S_{SRS,b,f,c}(i) may be a TPC command field value included in a PDCCH having triggered the i-th SRS transmission occasion corresponding to closed loop index l in bandwidth part b, carrier frequency f, and cell c.
In the method, if one SRS transmission occasion is triggered for the UE through reception of one corresponding PDCCH, or multiple SRS transmission occasions are triggered for the UE through reception of one corresponding PDCCH, the same absolute TPC command value may be applied to all SRS transmission occasions.
In the method, if multiple SRS transmission occasions are triggered for the UE through reception of one corresponding PDCCH, S_{SRS,b,f,c}(i) follows only a TPC command field value included in the PDCCH triggering the transmission occasions, and thus a TPC command field value included in DCI format 2_3 between transmissions of two SRS transmission occasions may not be applied.

[Method 3-1-2-2]S_{SRS,b,f,c}(i) may be a TPC command value most recently received before the i-th SRS transmission occasion corresponding to closed loop index l in bandwidth part b, carrier frequency f and cell c.
In the method, if one SRS transmission occasion is triggered for the UE through reception of one corresponding PDCCH, multiple SRS transmission occasions are triggered for the UE through reception of one corresponding PDCCH, or there is no DCI format 2_3 transmitted more recently than the triggering PDCCH for all SRS transmission occasions, an absolute TPC command value included in the triggering PDCCH may be identically applied to all the SRS transmission occasions.
In the method, in a case where multiple SRS transmission occasions are triggered for the UE through reception of one corresponding PDCCH, if DCI format 2_3 is received between transmissions of the i-th and (i+1)-th SRS transmission occasions, and a TPC command value most recently received from the i-th SRS transmission occasion is a value indicated through a TPC command field included in the triggering PDCCH, an absolute TPC command value applied to the i-th SRS transmission occasion may follow a value indicated by the triggering PDCCH, and an absolute TPC command value included in DCI format 2_3 may be followed for the (i+1)-th SRS transmission occasion.

[Method 3-1-2-3]S_{SRS,b,f,c}(i) may be a TPC command value most recently received from a time point preceding, by K_{SRS}(i) symbols, transmission of the i-th SRS transmission occasion corresponding to closed loop index l in bandwidth part b, carrier frequency f and cell c.
One of Methods 3-1-1-1 to 3-1-1-8 above may be applied as a method of defining K_{SRS}(i).

An SRS transmission occasion described above may be one of each SRS transmission symbol, multiple SRS transmission symbols, a set of all symbols corresponding to a particular SRS resource, or a set of all symbols corresponding to all SRS resources to be used to transmit all defined ports, and may be configured for the UE by the base station through higher layer signaling, may be activated through MAC-CE, may be indicated through L1 signaling, may be notified through a combination of higher layer signaling and L1 signaling, or may follow a definition fixed in a specification.

An SRS transmission occasion described above may have the same definition or different definitions according to [Method 1-1] to [Method 1-4] described above. For example, if the UE transmits, to the base station, an SRS including eight or more ports by using [Method 1-1], the base station and the UE may use, as an SRS transmission occasion, a set of all symbols corresponding to a particular SRS resource. If the UE transmits, to the base station, an SRS including eight or more ports by using [Method 1-2], the base station and the UE may use, as an SRS transmission occasion, each SRS transmission symbol or multiple SRS transmission symbols capable of representing all the eight or more ports. If the UE transmits, to the base station, an SRS including eight or more ports by using [Method 1-3], the base station and the UE may use, as an SRS transmission occasion, a set of all symbols corresponding to a particular SRS resource, or a set of all symbols corresponding to all SRS resources to be used to transmit all the defined ports. However, this merely corresponds to an example, an SRS transmission occasion such a set of all symbols corresponding to a particular SRS resource may also be provided for all [Method 1-1] to [Method 1-4], and it may also possible to use each SRS transmission occasion differently from the above example for each method.

The UE may report, as a UE capability to the base station, an SRS transmission occasion described above that the UE is able to use to apply TPC. The UE may report UE capability information for each of [Method 1-1] to [Method 1-4] described above, or may report one method regardless of [Method 1-1] to [Method 1-4]. If the UE has not reported a UE capability for an SRS transmission occasion to the base station, the base station may consider one SRS resource as a basic SRS transmission occasion of the UE. Alternatively, if the UE has not reported a UE capability for an SRS transmission occasion to the base station, the base station may consider the largest transmission occasion or the smallest transmission occasion among SRS transmission occasions reportable by the UE, as a basic SRS transmission occasion of the UE.

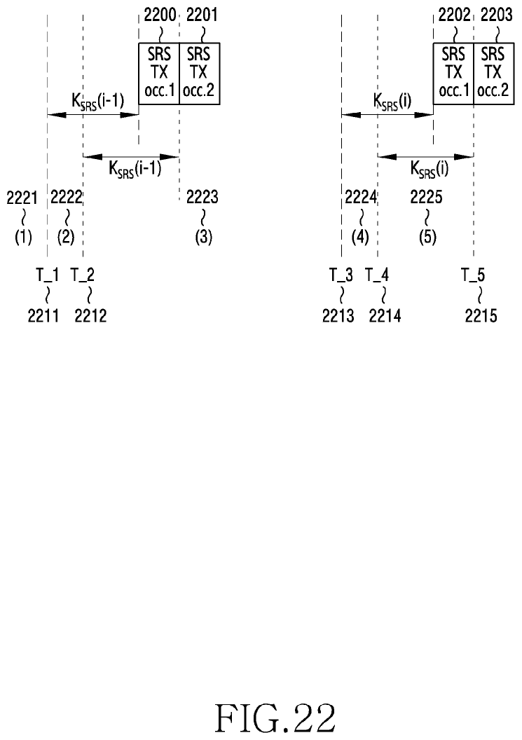

FIG. 22 is a diagram illustrating a TPC application time order for each SRS transmission occasion according to an embodiment of the disclosure.

FIG. 22 illustrates a situation where a UE periodically transmits two SRS transmission occasions to a base station. Between time points of first SRS transmission occasion 1 2200 and occasion 2 2201 and time points of second SRS transmission occasion 1 2202 and occasion 2 2203, that is, in time position (1) 2221 to time position (5) 2225, a TPC value indicated through DCI format 2_3 from the base station to the UE may be applied to all transmission of first SRS transmission occasions 1 and 2 and second SRS transmission occasions 1 and 2, or may be applied to one type of the first or second SRS transmission occasions according to which time position among time positions (1) to (5) in which the TPC value has been transmitted. A time point T_1 2211 and a time point T_2 2212 are respective time points preceding first SRS transmission occasion 1 2200 and first SRS transmission occasion 2 2201 by K_{SRS}(i−1) symbols, a time point T_3 2213 and a time point T_4 2214 are respective time points preceding second SRS transmission occasion 1 2202 and second SRS transmission occasion 2 2203 by K_{SRS}(i) symbols, and a time point T_5 2215 may indicate a transmission start time point of second SRS transmission occasion 2 2203.

According to a conventional TPC application scheme, respective TPC values indicated by the base station to the UE through DCI format 23 in the time positions (1) to (5) may be applied to first and second SRS transmission occasions 1 and 2 as follows.
If the UE receives a TPC in time position (1) 2221, the UE may apply the TPC to first SRS transmission occasion 1 2200 and occasion 2 2201, and may not apply the TPC to both second SRS transmission occasion 1 2202 and occasion 2 2203.
If the UE receives a TPC in time position (2) 2222, the UE may not apply the TPC to first SRS transmission occasion 1 2200 and second SRS transmission occasion 2 2203, and may apply the TPC to both first SRS transmission occasion 2 2201 and second SRS transmission occasion 1 2202.
If the UE receives a TPC in time position (3) 2223, the UE may not apply the TPC to first SRS transmission occasion 1 2200 and first SRS transmission occasion 2 2201, and may apply the TPC to both second SRS transmission occasion 1 2202 and second SRS transmission occasion 2 2203.
If the UE receives a TPC in time position (4) 2224, the UE may not apply the TPC to first SRS transmission occasion 1 2200, first SRS transmission occasion 2 2201, and second SRS transmission occasion 1 2202, and may apply the TPC to second SRS transmission occasion 2 2203.
If the UE receives a TPC in time position (5) 2225, the UE may not apply the TPC to all of first SRS transmission occasion 1 2200, first SRS transmission occasion 2 2201, second SRS transmission occasion 1 2202, and second SRS transmission occasion 2 2203.

However, when the conventional TPC application scheme is followed, if the UE performs SRS transmission including 8 or more ports, for example, if each of SRS transmission occasions 1 and 2 indicate different 4-port transmission for 8-port SRS transmission in consideration of [Method 1-2] by the UE (in this case, SRS transmission occasions 1 and 2 may be different sets of symbols included in a single SRS resource or may be represented by different SRS resources, respectively), considering a TPC application time point for each SRS transmission occasion as in the definition of a conventional specification may cause different transmission power per port according to a reception time point of a TPC indication from the base station.

Therefore, the complexity of a power allocation scheme of the UE may increase. Accordingly, even at the time of uplink channel estimation at the base station having received a transmitted SRS, there may be a burden of having to perform different corrections for reception power per port after SRS reception for each port. When SRS transmission including 8 or more ports is performed as described above, the aforementioned situation may be referred to as an “situation where SRS transmission occasions are connected to each other” or “SRS transmission including multiple connected SRS transmission occasions,” the UE and the base station may need to add different interpretations for the connected SRS transmission occasions compared to the conventional TPC application time point, and methods therefor may be described as follows.

If the higher layer signaling tpc-Accumulation is not configured for the UE by the base station, that is, if the UE is able to perform a TPC command accumulation operation, the following items may be considered and used together with a combination of at least one of [Method 3-1-1-1] to [Method 3-1-1-8] described above.

If the higher layer signaling tpc-Accumulation is configured for the UE by the base station, that is, if the UE is unable to perform a TPC command accumulation operation and operates through an absolute value, the following items may be considered and used together with a combination of at least one of [Method 3-1-2-1] to [Method 3-1-2-3] described above.

[Method 3-2-1] when the UE receives a TPC from the base station, if the TPC is applied to only some of multiple connected SRS transmission occasions, based on a TPC reception time point, the UE may apply the same TPC to all the connected SRS transmission occasions. The UE may perform a detailed operation as described below according to a reception time point of a TPC applied to only some of connected SRS transmission occasions.
When applying a TPC, based on a TPC reception time point, if the TPC is not applied to an earlier transmitted SRS transmission occasion among connected SRS transmission occasions and is applicable to a later transmitted SRS transmission occasion, the UE may not apply the TPC to all the connected SRS transmission occasions. For example, a case of TPC reception time point (2) 2222 in FIG. 22 may correspond to a case where the TPC is not applied to an earlier transmitted first SRS transmission occasion 1 2200 and is applied to a later transmitted first SRS transmission occasion 2 2201, and in this case, if first SRS transmission occasions 1 and 2 are connected, the UE may apply a TPC received in time point (2) to only first SRS transmission occasion 2 according to the conventional rule, but may not apply both of the two SRS transmission occasions according to the corresponding method.
When applying a TPC, based on a TPC reception time point, if the TPC is applied to an earlier transmitted SRS transmission occasion among connected SRS transmission occasions and is not applied to a later transmitted SRS transmission occasion, the UE may apply the TPC to all the connected SRS transmission occasions.

### [Method 3-2-2]

When the UE receives a TPC from the base station, if the TPC is applied to only some of multiple connected SRS transmission occasions, based on a TPC reception time point, the UE may not apply the TPC to all the connected SRS transmission occasions, and only when the UE receives a TPC at a time point enabling application of all the multiple connected SRS transmission occasions, the UE may apply the TPC to all the SRS transmission occasions. For example, if the UE receives a TPC in time position (3) 2223 in FIG. 22, the UE may apply the TPC to both second SRS transmission occasion 1 2202 and occasion 2 2203, but, in a case of time position (4) 2224, the UE is unable to apply the TPC to second SRS transmission occasion 1 2202 and may apply same to second SRS transmission occasion 2 2203. Through the corresponding method, when a TPC is received in the same position as time point (3), the UE may apply the TPC to all the connected SRS transmission occasions, and when a TPC is received in other positions (e.g., time point (4)), the UE may not apply the TPC to all the connected SRS transmission occasions.

### [Method 3-2-3]

If the UE considers a TPC application time point when transmitting multiple connected SRS transmission occasions, the UE may not consider the TPC application time point by using a parameter, such as K_{SRS}(i), for each of the multiple connected SRS transmission occasions and consider the multiple connected SRS transmission occasions as a single SRS transmission occasion to consider a parameter, such as K_{SRS}(i), considering the TPC application time point only for the earliest SRS transmission occasion among the multiple connected SRS transmission occasions.

For example, in FIG. 22, the UE may consider first SRS transmission occasion 1 2200 and occasion 2201 as a single SRS transmission occasion, and may consider a TPC application time point only for the earlier transmitted first SRS transmission occasion 1 2200 by using a parameter, such as K_{SRS}(i). Therefore, according to the corresponding method, the UE may not consider T_2 2212 and T_4 2214 that are TPC application time points considered from first SRS transmission occasion 2 2201 and second SRS transmission occasion 2 2203, and determine whether to apply a TPC by considering only T_1 2211 and T_3 2213.

### [Method 3-2-4]

If the UE considers a TPC application time point when transmitting multiple connected SRS transmission occasions, the UE may consider the TPC application time point for each of the multiple connected SRS transmission occasions in the conventional scheme. At this time, as described above, TPC values to be applied to each port during the UE's SRS transmission may vary. When the base station receives a corresponding SRS and performs uplink channel estimation, additional considerations such as post-processing may be required to account for different transmission power for each port by the UE. If the base station is unable to accommodate such additional considerations, the UE may expect to receive a TPC from the base station only at a time point applicable to all of multiple connected SRS transmission occasions.

In other words, the UE may not expect to receive a TPC from the base station at a time point that is applicable to only some of multiple connected SRS transmission occasions. If the base station is capable of accommodating such additional considerations, the UE may expect to receive a TPC from the base station at a random time point, and a TPC application time point may follow the conventional method. The corresponding method may be available only when the UE does not perform UE capability reporting that notifies that the UE is able to support a combination of at least one of [Method 3-2-1] to [Method 3-2-3] and [Method 3-2-5].

### [Method 3-2-5]

A combination of at least one of [Method 3-2-1] to [Method 3-2-4] above may be configured for the UE by the base station through higher layer signaling, may be activated through MAC-CE, may be indicated through L1 signaling, may be notified through a combination of higher layer signaling and L1 signaling, or may be fixedly defined in a specification.

The UE may report, to the base station, a UE capability relating to whether the UE supports a combination of at least one of [Method 3-2-1] to [Method 3-2-5] above. The UE capability may include at least one component within a single UE capability, which indicates support for a combination of at least one of [Method 3-2-1] to [Method 3-2-5], or may be defined as multiple different UE capabilities. As mentioned in [Method 3-2-4] above, if a UE capability for a specific method is not reported, this may be interpreted as indicating that another method is supportable.

For the aforementioned multiple connected SRS transmission occasions, when different ports are transmitted in different SRS transmission occasions, the UE may introduce at least one OFDM symbol as a type of guard symbol between two adjacent SRS transmission occasions, by considering various time delay factors that may occur during port switching. The guard symbol may have different values depending on the subcarrier spacing (numerology) of a cell and bandwidth part to which the base station and the UE belong. Whether the guard symbol exists and the value thereof may be reported from the UE to the base station as a UE capability and be used without change, may be configured by the base station through higher layer signaling, based on a UE capability reported from the UE, may be activated through MAC-CE, may be indicated through L1 signaling, or may be fixedly defined in a specification.

According to an embodiment, if the UE reports corresponding information as a UE capability, the UE may report a different value for each subcarrier spacing. Additionally, if the UE reports the corresponding information as a UE capability, the UE may report the information by using an expression of symbols, slots, or absolute time. Moreover, the number of guard symbols used in an SRS transmission for antenna switching may be used without change as the value of the guard symbol. For example, in FIG. 22, it is shown that there are no guard symbols between first SRS transmission occasion 1 2200 and SRS transmission occasion 2 2201 and they are consecutively transmitted. However, as described above, if the base station and the UE have a common understanding of the use of guard symbols, a particular number of guard symbols may be required between SRS transmission occasion 1 and 2. All of the aspects mentioned in the above embodiment may be applied regardless of whether guard symbols exist between multiple connected SRS transmission occasions.

A TPC reception position on a time resource of the UE may be determined based on whether the first symbol, all symbols, or the last symbol of the DCI including TPC information is included. For example, if a TPC reception position is determined through whether the first symbol of DCI including TPC information is included, for example, the fact that the UE has received a TPC at time point (1) 2221 in FIG. 22 may imply that the first symbol of the DCI including the TPC information is included within a time resource of time point (1). The definition of such a TPC reception position may be reported as a UE capability from the UE to the base station, configured for the UE by the base station via higher layer signaling, activated via MAC-CE, indicated via L1 signaling, notified by a combination of higher layer signaling and L1 signaling, or fixedly defined in a specification.

The content of the described embodiment is applicable to a periodic, semi-persistent, and aperiodic SRS and may be applicable when usage that is higher layer signaling in SRS resource set is codebook, non-codebook, antenna switching, or beam management.

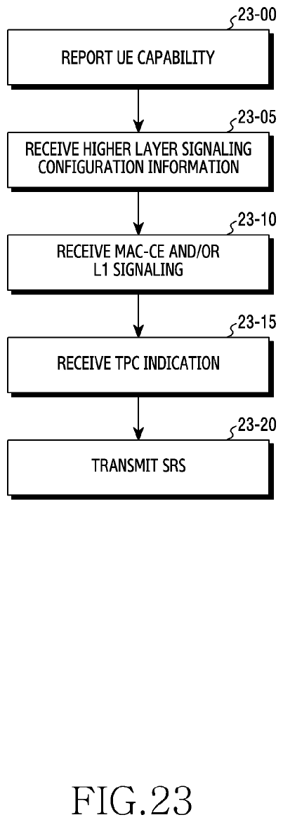

FIG. 23 is a diagram illustrating an operation for TPC application at the time of SRS transmission of a UE according to an embodiment of the disclosure.

A UE may report a UE capability to a base station (operation 23-00). A corresponding UE capability report may be a combination of at least one of UE capabilities mentioned in the above embodiment. For example, the UE capability reported by the UE may include a combination of at least one of UE capabilities related to whether to support [Method 1-1] to [Method 1-4], whether to support [Method 1-3-1] to [Method 1-3-3], whether to support [Time resource operation 2-1], [Time resource operation 2-2], [Time resource operation 3-1], and [Time resource operation 3-2], whether to support [Method 3-2-1] to [Method 3-2-4], a guard symbol between two adjacent SRS transmission occasions, and a TPC reception position.

Thereafter, the UE may receive higher layer signaling configuration information from the base station (operation 23-05). The corresponding higher layer signaling may be a combination of at least one of pieces of higher layer signaling configuration information mentioned in the above embodiment. For example, the higher layer signaling may be higher layer signaling related to at least one of [Method 1-1] to [Method 1-4], [Method 1-3-1] to [Method 1-3-3], [Time resource operation 2-1], [Time resource operation 2-2], [Time resource operation 3-1], [Time resource operation 3-2], [Method 3-2-1] to [Method 3-2-4], a guard symbol between two adjacent SRS transmission occasions, and a TPC reception position.

The UE may additionally receive MAC-CE and/or L1 signaling from the base station (operation 23-10). For example, the MAC-CE and/or L1 signaling may be MAC-CE and/or L1 signaling related to at least one of [Method 1-1] to [Method 1-4], [Method 1-3-1] to [Method 1-3-3], [Time resource operation 2-1], [Time resource operation 2-2], [Time resource operation 3-1], [Time resource operation 3-1-4], [Method 3-2-1] to [Method 3-2-4], a guard symbol between two adjacent SRS transmission occasions, and a TPC reception position. Thereafter, the UE may receive a TPC indication from the base station (operation 23-15).

Thereafter, the UE may determine whether to apply a TPC received from the base station, for each SRS transmission occasion among multiple connected SRS transmission occasions, based on an indication received from the base station through the above higher layer signaling and MAC-CE and/or L1 signaling, and transmit multiple connected SRS transmission occasions or an SRS having N antenna ports (operation 23-20).

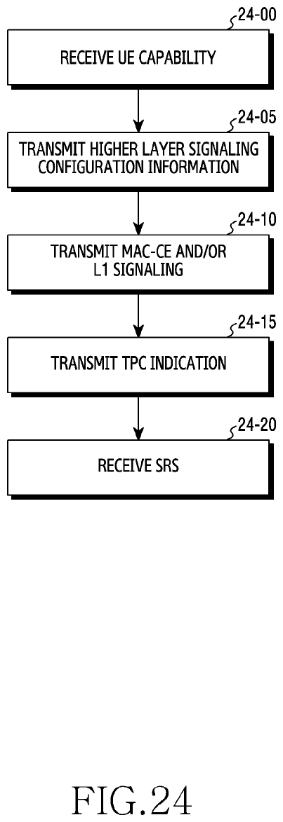

FIG. 24 is a diagram illustrating an operation of a base station for TPC application at the time of SRS transmission of a UE according to an embodiment of the disclosure.

A base station may receive a UE capability from a UE (operation 24-00). A corresponding UE capability report may be a combination of at least one of UE capabilities mentioned in the above embodiment. For example, the UE capability reported by the UE may include a combination of at least one of UE capabilities related to whether to support [Method 1-1] to [Method 1-4], whether to support [Method 1-3-1] to [Method 1-3-3], whether to support [Time resource operation 2-1], [Time resource operation 2-2], [Time resource operation 3-1], and [Time resource operation 3-2], whether to support [Method 3-2-1] to [Method 3-2-4], a guard symbol between two adjacent SRS transmission occasions, and a TPC reception position.

Thereafter, the base station may transmit higher layer signaling configuration information to the UE (operation 24-05). The corresponding higher layer signaling may be a combination of at least one of pieces of higher layer signaling configuration information mentioned in the above embodiment. For example, the higher layer signaling may be higher layer signaling related to at least one of [Method 1-1] to [Method 1-4], [Method 1-3-1] to [Method 1-3-3], [Time resource operation 2-1], [Time resource operation 2-2], [Time resource operation 3-1], [Time resource operation 3-2], [Method 3-2-1] to [Method 3-2-4], a guard symbol between two adjacent SRS transmission occasions, and a TPC reception position.

The base station may additionally transmit MAC-CE and/or L1 signaling to the UE (operation 24-10). For example, the MAC-CE and/or L1 signaling may be MAC-CE and/or L1 signaling related to at least one of [Method 1-1] to [Method 1-4], [Method 1-3-1] to [Method 1-3-3], [Time resource operation 2-1], [Time resource operation 2-2], [Time resource operation 3-1], [Time resource operation 3-2], [Method 3-2-1] to [Method 3-2-4], a guard symbol between two adjacent SRS transmission occasions, and a TPC reception position.

Thereafter, the base station may transmit a TPC indication to the UE (operation 24-15). Thereafter, the base station may determine whether a TPC is applied by the UE, for each SRS transmission occasion among multiple connected SRS transmission occasions, based the above higher layer signaling and MAC-CE and/or L1 signaling that the base station has transmitted to the UE, and receive connected SRS transmission occasions or an SRS having N antenna ports (operation 24-20).

### Fourth Embodiment: Method of Determining Priority of SRS Transmission when SRS Overlaps Other Uplink and Downlink Channels

As an embodiment of the disclosure, a method of determining the priority of an SRS transmission of the UE when the SRS transmission according to the SRS resource configuration and indication method described in the above embodiment overlaps another uplink channel and signal transmission or downlink channel and signal reception of the UE is described.

As described above, when an SRS transmission at the UE relates to multiple connected SRS transmission occasions and some time units (multiple symbols or some SRS transmission occasions) of the SRS transmission overlap another uplink channel and signal transmission or downlink channel and signal reception, an operation according to the following methods may be possible.

### [Method 4-1-1]

When some time units (multiple symbols or some SRS transmission occasions) of an SRS transmission for multiple connected SRS transmission occasions overlap another uplink channel and signal transmission or downlink channel and signal reception, the UE may also not perform transmission for all time units for the remaining SRS transmission of the SRS transmission for the multiple connected SRS transmission occasions, the remaining SRS transmission not overlapping with the other uplink channel and signal transmission or downlink channel and signal reception. For example, in a situation where, at the time of transmission of a periodic/semi-persistent SRS including eight ports, the UE performs an SRS transmission for ports 0 to 3 on a first OFDM symbol which is a first SRS transmission occasion and performs an SRS transmission for ports 4 to 7 on a second OFDM symbol which is a second SRS transmission occasion, if the SRS transmission for ports 4 to 7 that is a periodic/semi-persistent SRS transmission overlaps an aperiodic SRS transmission on the second OFDM symbol, the UE may drop (i.e., not transmit) the SRS transmission for ports 4 to 7 on the overlapped second OFDM symbol and also drop the SRS transmission for ports 0 to 3 on the non-overlapped first OFDM symbol.

### [Method 4-1-2]

When some time units (multiple symbols or some SRS transmission occasions) of an SRS transmission for multiple connected SRS transmission occasions overlap another uplink channel and signal transmission or downlink channel and signal reception, the UE may transmit all time units for the remaining SRS transmission of the SRS transmission for the multiple connected SRS transmission occasions, the remaining SRS transmission not overlapping with the other uplink channel and signal transmission or downlink channel and signal reception. For example, in a situation where, at the time of transmission of a periodic/semi-persistent SRS including eight ports, the UE performs an SRS transmission for ports 0 to 3 on a first OFDM symbol which is a first SRS transmission occasion and performs an SRS transmission for ports 4 to 7 on a second OFDM symbol which is a second SRS transmission occasion, if the SRS transmission for ports 4 to 7 that is a periodic/semi-persistent SRS transmission overlaps an aperiodic SRS transmission on the second OFDM symbol, the UE may drop (i.e., not transmit) the SRS transmission for ports 4 to 7 on the overlapped second OFDM symbol and perform the SRS transmission for ports 0 to 3 on the non-overlapped first OFDM symbol without change.

Thereafter, the UE may, in a case of periodic/semi-persistent SRS transmission, perform an SRS transmission for ports 0 to 3 on the first OFDM symbol which is the first SRS transmission occasion and perform an SRS transmission for ports 4 to 7 on the second OFDM symbol which is the second SRS transmission occasion, in the next transmission period. That is, regardless of a particular SRS transmission occasion (e.g., a particular OFDM symbol) being dropped in the previous transmission period, the UE may perform the same SRS transmission at every period, and when there is an overlap with another uplink channel and signal transmission or downlink channel and signal reception for each period, may operate the conventional priority and a corresponding method.

### [Method 4-1-3]

When some time units (multiple symbols or some SRS transmission occasions) of an SRS transmission for multiple connected SRS transmission occasions overlap another uplink channel and signal transmission or downlink channel and signal reception, the UE may transmit all time units for the remaining SRS transmission of the SRS transmission for the multiple connected SRS transmission occasions, the remaining SRS transmission not overlapping with the other uplink channel and signal transmission or downlink channel and signal reception. For example, in a situation where, at the time of transmission of a periodic/semi-persistent SRS including eight ports, the UE performs an SRS transmission for ports 0 to 3 on a first OFDM symbol which is a first SRS transmission occasion and performs an SRS transmission for ports 4 to 7 on a second OFDM symbol which is a second SRS transmission occasion, if the SRS transmission for ports 4 to 7 that is a periodic/semi-persistent SRS transmission overlaps an aperiodic SRS transmission on the second OFDM symbol, the UE may drop (i.e., not transmit) the SRS transmission for ports 4 to 7 on the overlapped second OFDM symbol and perform the SRS transmission for ports 0 to 3 on the non-overlapped first OFDM symbol without change.

Thereafter, in a case of periodic/semi-persistent SRS transmission, when SRS transmission is performed in the next transmission period, if particular SRS transmission occasions (e.g., particular OFDM symbols) are dropped in the previous period, the UE may start the SRS transmission on the first symbol of the first SRS transmission occasion among all the dropped SRS transmission occasions (e.g., OFDM symbols). That is, in the next period of the above situation, the UE may perform, on the first OFDM symbol, an SRS transmission for ports 4 to 7 required to be transmitted in the second SRS transmission occasion and then perform, on the second OFDM symbol, an SRS transmission for ports 0 to 3 required to be transmitted in the first SRS transmission occasion. When, as described above, the UE considers an SRS transmission dropped in the previous period to perform the dropped SRS transmission as the first transmission of the next period and thus port mapping for each transmission OFDM symbol position is changed, a Comb position and a cyclic shift allocation for each OFDM symbol may be maintained or changed.

For example, if the UE changes a Comb position and a cyclic shift allocation for each OFDM symbol, when an SRS transmission for ports 4 to 7 required to be transmitted in the second SRS transmission occasion is performed on the first OFDM symbol, the UE may use a Comb position and a cyclic shift allocation to be used in the second SRS transmission occasion, without change on the first symbol. Similarly, when an SRS transmission for ports 0 to 3 required to be transmitted in the first SRS transmission occasion is performed on the second OFDM symbol, the UE may use a Comb position and a cyclic shift allocation to be used in the first SRS transmission occasion, without change on the second symbol.

As another example, if the UE maintains a Comb position and a cyclic shift allocation for each OFDM symbol, when an SRS transmission for ports 4 to 7 required to be transmitted in the second SRS transmission occasion is performed on the first OFDM symbol, the UE may use a Comb position and a cyclic shift allocation to be used in the first SRS transmission occasion, without change on the first symbol. Similarly, when an SRS transmission for ports 0 to 3 required to be transmitted in the first SRS transmission occasion is performed on the second OFDM symbol, the UE may use a Comb position and a cyclic shift allocation to be used in the second SRS transmission occasion, without change on the second symbol.

When there is an overlap with another uplink channel and signal transmission or downlink channel and signal reception for each period, the UE may operate the conventional priority and a corresponding method.

### [Method 4-1-4]

When some time units (multiple symbols or some SRS transmission occasions) of an SRS transmission for multiple connected SRS transmission occasions overlap another uplink channel and signal transmission or downlink channel and signal reception, the UE may transmit the remaining SRS transmission of the SRS transmission for the multiple connected SRS transmission occasions after changing same into a conventional SRS transmission scheme, the remaining SRS transmission not overlapping with the other uplink channel and signal transmission or downlink channel and signal reception. The conventional SRS transmission scheme indicates SRS transmission based on a single SRS transmission occasion rather than SRS transmission based on multiple connected SRS transmission occasions, and for example, may be a scheme of transmitting all ports (e.g., eight ports) configured through higher layer signaling in a single SRS resource, in every OFDM symbol position in which the SRS resource is transmitted as in [Method 1-1] above. (e.g., if eight ports and two OFDM symbols are configured for the UE with respect to a particular SRS resource through higher layer signaling as the number of ports and the number of transmission OFDM symbols, the UE may perform 8-port transmission for each of the two OFDM symbols at the time of transmission of the SRS transmission.)

For example, in a situation where, at the time of transmission of a periodic/semi-persistent SRS including eight ports, the UE performs an SRS transmission for ports 0 to 3 on a first OFDM symbol which is a first SRS transmission occasion and performs an SRS transmission for ports 4 to 7 on a second OFDM symbol which is a second SRS transmission occasion, if the SRS transmission for ports 4 to 7 that is a periodic/semi-persistent SRS transmission overlaps an aperiodic SRS transmission on the second OFDM symbol, the UE may drop the SRS transmission on the overlapped second OFDM symbol and change the SRS transmission on the non-overlapped first OFDM symbol from an SRS transmission for ports 0 to 3 to an SRS transmission for ports 0 to 7.

In this case, a situation where it is possible for the UE to change an SRS transmission for ports 0 to 3 into an SRS transmission for ports 0 to 7 as described above may correspond to a case where the time interval between a reception time point of a PDCCH triggering the above aperiodic SRS and the periodic/semi-persistent SRS overlapped with the aperiodic SRS and thus dropped is longer than or equal to a particular time interval. The particular time interval may be reported as a UE capability from the UE, configured for the UE by the base station via higher layer signaling, activated via MAC-CE, indicated via L1 signaling, notified by a combination of higher layer signaling and L1 signaling, or fixedly defined in a specification. If the time interval is shorter than the particular time interval, the UE may perform an SRS transmission for a non-overlapped SRS transmission occasion by using a method that is a combination of at least one of [Method 4-1-1] to [Method 4-1-3].

Thereafter, the UE may, in a case of periodic/semi-persistent SRS transmission, perform an SRS transmission for ports 0 to 3 on the first OFDM symbol which is the first SRS transmission occasion and perform an SRS transmission for ports 4 to 7 on the second OFDM symbol which is the second SRS transmission occasion, in the next transmission period. That is, regardless of a particular SRS transmission occasion (e.g., a particular OFDM symbol) being dropped in the previous transmission period and an SRS transmission for ports 0 to 3 being changed to an SRS transmission for ports 0 to 7 and then being transmitted, the UE may perform the same SRS transmission at every period, and when there is an overlap with another uplink channel and signal transmission or downlink channel and signal reception for each period, may operate the conventional priority and a corresponding method.

### [Method 4-1-5]

A combination of at least one of [Method 4-1-1] to [Method 4-1-4] above may be configured for the UE by the base station through higher layer signaling, may be activated through MAC-CE, may be indicated through L1 signaling, may be notified through a combination of higher layer signaling and L1 signaling, or may be fixedly defined in a specification.

The UE may report, to the base station through a UE capability, whether the UE supports a method in which at least one of [Method 4-1-1] to [Method 4-1-5] is combined. The UE capability may include at least one component within a single UE capability, which indicates support for a combination of at least one of [Method 4-1] to [Method 4-3], or may be defined as multiple different UE capabilities. In addition, if a UE capability for a specific method is not reported, this may be interpreted as indicating that another method is supportable. The base station may use a method reported by the UE as a UE capability as it is without separate signaling, based on a corresponding UE capability report, and if there are one or more reportable methods reported by the UE as a UE capability, a particular selected method may be configured for the UE by the base station through higher layer signaling, may be activated through MAC-CE, may be indicated through L1 signaling, or may be fixedly defined in a specification.

In this case, with respect to all the above methods, when an SRS transmission for multiple connected SRS transmission occasions overlap another uplink channel and signal transmission or downlink channel and signal reception, the priority may follow the conventional rules as below.
If an aperiodic SRS overlaps a periodic/semi-persistent SRS on the same symbol position, the aperiodic SRS is transmitted and the periodic/semi-persistent SRS is not transmitted.
With respect to a PUCCH and an SRS scheduled on the same carrier, if a semi-persistent SRS and periodic SRS transmission is configured for the UE on the same symbol position as the transmission position of a PUCCH including only a CSI report, including only an L1-RSRP report, or including only an L1-SINR report, the UE may not perform the SRS transmission.
If a semi-persistent SRS or periodic SRS transmission is configured or an aperiodic SRS trigger is indicated for the UE on the same symbol position as the transmission position of a PUCCH including a HARQ-ACK, a link restoration request, and/or an SR, the UE may not transmit the SRS.
If a PUCCH transmission and an SRS transmission of the UE overlap, the UE may drop and not transmit only SRS symbols overlapping with the PUCCH among all the SRS transmission symbols.
When an aperiodic SRS transmission is triggered for the UE on the same symbol as the transmission position of a PUCCH including a semi-persistent/periodic CSI report or only a semi-persistent/periodic L1-RSRP or L1-SINR report, the UE may not transmit the PUCCH.
In a case of a band-band combination for which simultaneous transmission of an SRS and a PUCCH/PUSCH is not allowed with respect to intra-band carrier aggregation or inter-band carrier aggregation, the UE does not expect that PUSCH/UL DM-RS/UL PT-RS/PUCCH formats are configured, on the same symbol, from a carrier different from a carrier on which an SRS is configured.
In a case of a band-band combination for which simultaneous transmission of an SRS and a PRACH is not allowed with respect to intra-band carrier aggregation or inter-band carrier aggregation, the SRS and the PRACH are not be simultaneously transmitted from one carrier and another carrier, respectively.
If the UE receives a trigger for an aperiodic SRS transmission and the transmission position of the triggered aperiodic SRS overlaps an OFDM symbol position configured for a periodic and semi-persistent SRS transmission, the UE may transmit the aperiodic SRS on the overlapped symbol position, drop the periodic and semi-persistent SRS transmission overlapping with the aperiodic SRS, and transmit the non-overlapped periodic and semi-persistent SRS.
If the UE receives activation for a semi-persistent SRS transmission and the transmission position of the activated semi-persistent SRS overlaps an OFDM symbol position configured for a periodic SRS transmission, the UE may transmit the semi-persistent SRS on the overlapped symbol position, drop the periodic SRS transmission overlapping with the semi-persistent SRS, and transmit the non-overlapped periodic SRS.

If the UE transmits multiple SRS resources in an SRS resource set configured to have antennaSwitching as usage that is higher layer signaling in SRS-ResourceSet, the UE may define, as a guard period, Y OFDM symbols between two SRS resources and whether the guard period is dropped or not dropped may follow the same priority rules as an SRS resource before or after the guard period.

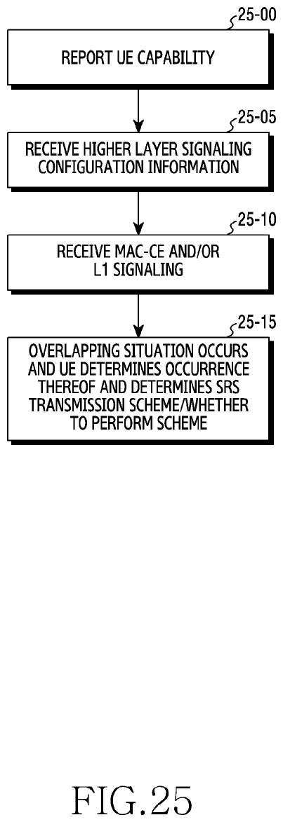

FIG. 25 is a diagram illustrating an operation of a UE when another uplink or downlink channel overlaps an SRS transmission of the UE according to an embodiment of the disclosure.

A UE may report a UE capability to a base station (operation 25-00). A corresponding UE capability report may be a combination of at least one of UE capabilities mentioned in the above embodiment. For example, the UE capability reported by the UE may include a combination of at least one of UE capabilities related to whether to support [Method 1-1] to [Method 1-4], whether to support [Method 1-3-1] to [Method 1-3-3], whether to support [Time resource operation 2-1], [Time resource operation 2-2], [Time resource operation 3-1], and [Time resource operation 3-2], whether to support [Method 3-2-1] to [Method 3-2-4], a guard symbol between two adjacent SRS transmission occasions, a TPC reception position, and [Method 4-1-1] to [Method 4-1-5]. Thereafter, the UE may receive higher layer signaling configuration information from the base station (operation 25-05).

The corresponding higher layer signaling may be a combination of at least one of pieces of higher layer signaling configuration information mentioned in the above embodiment. For example, the higher layer signaling may be higher layer signaling related to at least one of [Method 1-1] to [Method 1-4], [Method 1-3-1] to [Method 1-3-3], [Time resource operation 2-1], [Time resource operation 2-2], [Time resource operation 3-1], [Time resource operation 3-2], [Method 3-2-1] to [Method 3-2-4], a guard symbol between two adjacent SRS transmission occasions, a TPC reception position, and [Method 4-1-1] to [Method 4-1-5]. The UE may additionally receive MAC-CE and/or L1 signaling from the base station (operation 25-10).

For example, the MAC-CE and/or L1 signaling may be MAC-CE and/or L1 signaling related to at least one of [Method 1-1] to [Method 1-4], [Method 1-3-1] to [Method 1-3-3], [Time resource operation 2-1], [Time resource operation 2-2], [Time resource operation 3-1], [Time resource operation 3-2], [Method 3-2-1] to [Method 3-2-4], a guard symbol between two adjacent SRS transmission occasions, a TPC reception position, and [Method 4-1-1] to [Method 4-1-5].

Thereafter, the UE may determine that there occurs a situation where transmission of an SRS including multiple connected SRS transmission occasions overlaps another uplink channel and signal transmission or downlink channel and signal reception, based on an indication received from the base station through the above higher layer signaling and MAC-CE and/or L1 signaling, and determine an SRS transmission method and whether to perform same according to a combination of at least one of [Method 4-1-1] to [Method 4-1-5] above (operation 25-15).

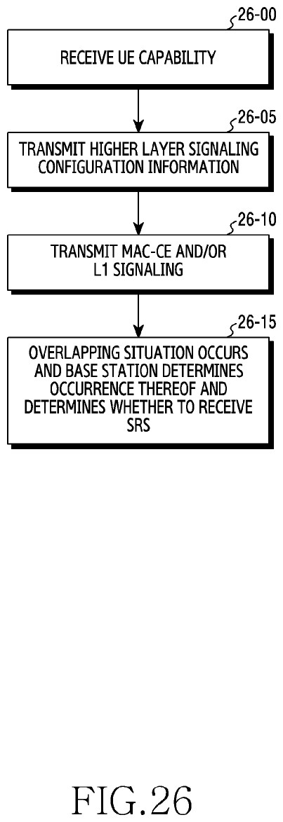

FIG. 26 is a diagram illustrating an operation of a base station when another uplink or downlink channel overlaps an SRS transmission of the UE according to an embodiment of the disclosure.

A base station may receive a UE capability from a UE (operation 26-00). A corresponding UE capability report may be a combination of at least one of UE capabilities mentioned in the above embodiment. For example, the UE capability reported by the UE may include a combination of at least one of UE capabilities related to whether to support [Method 1-1] to [Method 1-4], whether to support [Method 1-3-1] to [Method 1-3-3], whether to support [Time resource operation 2-1], [Time resource operation 2-2], [Time resource operation 3-1], and [Time resource operation 3-2], whether to support [Method 3-2-1] to [Method 3-2-4], a guard symbol between two adjacent SRS transmission occasions, a TPC reception position, and [Method 4-1-1] to [Method 4-1-5]. Thereafter, the base station may transmit higher layer signaling configuration information to the UE (operation 26-05).

The corresponding higher layer signaling may be a combination of at least one of pieces of higher layer signaling configuration information mentioned in the above embodiment. For example, the higher layer signaling may be higher layer signaling related to at least one of [Method 1-1] to [Method 1-4], [Method 1-3-1] to [Method 1-3-3], [Time resource operation 2-1], [Time resource operation 2-2], [Time resource operation 3-1], [Time resource operation 3-2], [Method 3-2-1] to [Method 3-2-4], a guard symbol between two adjacent SRS transmission occasions, a TPC reception position, and [Method 4-1-1] to [Method 4-1-5]. The base station may additionally transmit MAC-CE and/or L1 signaling to the UE (operation 25-10).

For example, the MAC-CE and/or L1 signaling may be MAC-CE and/or L1 signaling related to at least one of [Method 1-1] to [Method 1-4], [Method 1-3-1] to [Method 1-3-3], [Time resource operation 2-1], [Time resource operation 2-2], [Time resource operation 3-1], [Time resource operation 3-2], [Method 3-2-1] to [Method 3-2-4], a guard symbol between two adjacent SRS transmission occasions, a TPC reception position, and [Method 4-1-1] to [Method 4-1-5].

Thereafter, the base station may determine that there occurs a situation where transmission of an SRS including multiple connected SRS transmission occasions overlaps another uplink channel and signal transmission or downlink channel and signal reception, based on the above higher layer signaling and MAC-CE and/or L1 signaling transmitted to the UE, determine an SRS transmission method of the UE and whether to perform same according to a combination of at least one of [Method 4-1-1] to [Method 4-1-5] above, and receive an SRS transmission of the UE (operation 26-15).

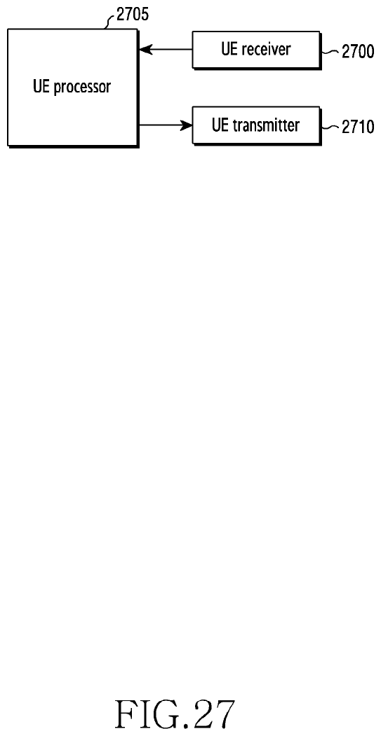

FIG. 27 illustrates a structure of a UE in a wireless communication system according to an embodiment of the disclosure.

Referring to FIG. 27, the base station may include a transceiver, which refers to a base station receiver 2700 and a base station transmitter 2710 as a whole, a memory (not illustrated), and a base station processor 2705 (or base station controller or processor). The UE transceiver 2700 and 2710, the memory, and the UE processor 2705 may operate according to the above-described communication methods of the UE. Components of the UE are not limited to the above-described example. For example, the UE may include a larger or smaller number of components than the above-described components. Furthermore, the transceiver 2700 and 2710, the memory (not illustrated), and the UE processor (or UE controller or processor) 2705 may be implemented in the form of a single chip.

The transceiver 2700 and 2710 may transmit/receive signals with the base station. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver. In addition, the transceiver 2700 and 2710 may receive signals through a radio channel, output the same to the UE processor (or UE controller or processor) 2705, and transmit signals output from the UE processor (or UE controller or processor) 2705 through the radio channel.

The memory may store programs and data necessary for operations of the UE. In addition, the memory may store control information or data included in signals transmitted/received by the UE. The memory may include a storage medium such as a ROM, a RAM, a hard disk, a CD-ROM, or a DVD, or a combination of storage media. In addition, the memory may include multiple memories, and the memory may store instructions for performing the above-described communication methods.

Furthermore, the UE processor (or UE controller or processor) 2705 may control a series of processes such that the UE can operate according to the above-described embodiments. The UE processor (or UE controller or processor) 2705 may include multiple processors, and the UE processor (or UE controller or processor) 2705 may perform operations of controlling the components of the UE by executing programs stored in the memory.

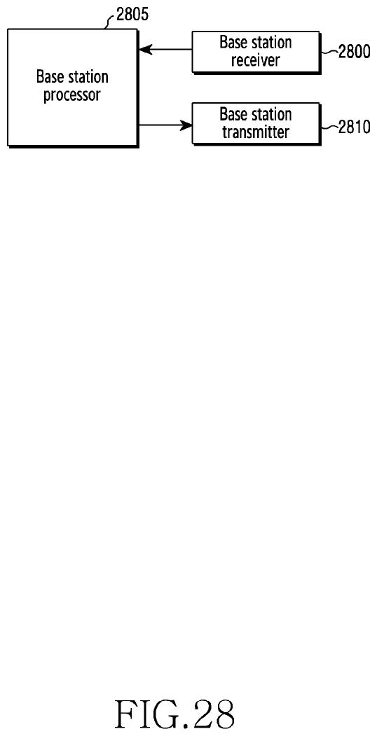

FIG. 28 illustrates a structure of a base station in a wireless communication system according to an embodiment of the disclosure.

Referring to FIG. 28, the base station may include a transceiver, which refers to a base station receiver 2800 and a base station transmitter 2810 as a whole, a memory (not illustrated), and a base station processor (or base station controller or processor) 2805. The base station transceiver 2800 and 2810, the memory, and the base station processor (or base station controller or processor) 2805 may operate according to the above-described communication methods of the base station. However, components of the base station are not limited to the above-described example. For example, the base station may include a larger or smaller number of components than the above-described components. Furthermore, the transceiver 2800 and 2810, the memory (not illustrated), and the base station processor (or base station controller or processor) 2805 may be implemented in the form of a single chip.

The transceiver 2800 and 2810 may transmit/receive signals with the UE. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the base station. In addition, the memory may store control information or data included in signals transmitted/received by the base station. The memory may include a storage medium such as a ROM, a RAM, a hard disk, a CD-ROM, or a DVD, or a combination of storage media. In addition, the memory may include multiple memories, and the memory may store instructions for performing the above-described communication methods.

The base station processor (or base station controller or processor) 2805 may control a series of operations so that the base station can operate according to the above-described embodiments. The base station processor (or base station controller or processor) 2805 may include multiple processors, and the base station processor (or base station controller or processor) 2805 may perform operations of controlling the components of the base station by executing programs stored in the memory.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of embodiments of the disclosure and help understanding of embodiments of the disclosure, and are not intended to limit the scope of embodiments of the disclosure. That is, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. As an example, a part of a first embodiment of the disclosure may be combined with a part of a second embodiment to operate a base station and a terminal. Moreover, although the above embodiments have been described based on the FDD LTE system, other variants based on the technical idea of the embodiments may also be implemented in other communication systems such as TDD LTE, and 5G, or NR systems.

In the drawings in which methods of the disclosure are described, the order of the description does not always correspond to the order in which steps are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

In addition, in methods of the disclosure, some or all of the contents of each embodiment may be implemented in combination without departing from the essential spirit and scope of the disclosure.

Various embodiments of the disclosure have been described above. The above description of the disclosure is for the purpose of illustration, and is not intended to limit embodiments of the disclosure to the embodiments set forth herein. Those skilled in the art will appreciate that other specific modifications and changes may be easily made to the forms of the disclosure without changing the technical idea or essential features of the disclosure. The scope of the disclosure is defined by the appended claims, rather than the above detailed description, and the scope of the disclosure should be construed to include all changes or modifications derived from the meaning and scope of the claims and equivalents thereof.

1. A method performed by a terminal (user equipment, UE) in a wireless communication system, the method comprising:
receiving, from a base station, configuration information including information on a sounding reference signal (SRS) resource for transmitting an SRS by the terminal through eight antenna ports, the SRS resource including at least two SRS transmission occasions associated with at least two antenna port subsets included in the eight antenna ports, respectively; and
based on the configuration information, transmitting, to the base station, the SRS on a first antenna port subset associated with a first SRS transmission occasion and a second antenna port subset associated with a second SRS transmission occasion in the at least two SRS transmission occasions, respectively,
wherein, in case that at least one SRS transmission occasion among the first SRS transmission occasion or the second SRS transmission occasion overlaps at least one of an aperiodic uplink transmission or an aperiodic downlink reception, an SRS transmission for all or a part of the first SRS transmission occasion and the second SRS transmission occasion is dropped.

2. The method of claim 1, wherein, in case that an SRS transmission for a part of the first SRS transmission occasion and the second SRS transmission occasion is dropped,
the transmitting of the SRS comprises transmitting the SRS on an antenna port subset related to a remaining SRS transmission occasion except for a dropped SRS transmission occasion, and
wherein an SRS transmission for the dropped SRS transmission occasion is preferentially performed during an SRS transmission period subsequent to an SRS transmission period related to the first SRS transmission occasion and the second SRS transmission occasion.

3. The method of claim 1, further comprising receiving, from the base station, downlink control information (DCI) including a transmission power control (TPC) command value for a TPC command accumulation operation, performed in an i-th (i is a natural number) SRS transmission occasion among the at least two SRS transmission occasions, during a time interval related to the TPC command accumulation operation,
wherein an end time point of the time interval is a time point preceding a start symbol of the i-th SRS transmission occasion by a symbol length of a predetermined number of symbols.

4. The method of claim 3, wherein, in case that the terminal is a terminal capable of performing the TPC command accumulation operation, the symbol length related to the end time point of the time interval is determined to be a symbol length from an end time point of a last symbol of a physical downlink control channel (PDCCH), through which the terminal receives DCI triggering the i-th SRS transmission occasion, to a start time point of the i-th SRS transmission occasion.

5. A method performed by a base station in a wireless communication system, the method comprising:
transmitting, to a terminal, configuration information including information on a sounding reference signal (SRS) resource for receiving an SRS through eight antenna ports of the terminal, the SRS resource including at least two SRS transmission occasions associated with at least two antenna port subsets included in the eight antenna ports, respectively; and
based on the configuration information, receiving, from the terminal, the SRS on a first antenna port subset associated with a first SRS transmission occasion and a second antenna port subset associated with a second SRS transmission occasion in the at least two SRS transmission occasions, respectively,
wherein, in case that at least one SRS transmission occasion among the first SRS transmission occasion or the second SRS transmission occasion overlaps at least one of an aperiodic uplink reception or an aperiodic downlink transmission, an SRS reception for all or a part of the first SRS transmission occasion and the second SRS transmission occasion is dropped.

6. The method of claim 5, wherein, in case that an SRS reception for a part of the first SRS transmission occasion and the second SRS transmission occasion is dropped,
the receiving of the SRS comprises receiving the SRS on an antenna port subset related to a remaining SRS transmission occasion except for a dropped SRS transmission occasion, and
wherein an SRS reception for the dropped SRS transmission occasion is preferentially performed during an SRS transmission period subsequent to an SRS transmission period related to the first SRS transmission occasion and the second SRS transmission occasion.

7. The method of claim 5, further comprising transmitting, to the terminal, downlink control information (DCI) including a transmission power control (TPC) command value for a TPC command accumulation operation, performed in an i-th (i is a natural number) SRS transmission occasion among the at least two SRS transmission occasions, during a time interval related to the TPC command accumulation operation,
wherein an end time point of the time interval is a time point preceding a start symbol of the i-th SRS transmission occasion by a symbol length of a predetermined number of symbols.

8. The method of claim 7, wherein, in case that the terminal is a terminal capable of performing the TPC command accumulation operation, the symbol length related to the end time point of the time interval is determined to be a symbol length from an end time point of a last symbol of a physical downlink control channel (PDCCH), through which the terminal receives DCI triggering the i-th SRS transmission occasion, to a start time point of the i-th SRS transmission occasion.

9. A terminal (user equipment, UE) in a wireless communication system, the terminal comprising:
a transceiver; and
a controller connected to the transceiver,
wherein the controller is configured to:
receive, from a base station, configuration information including information on a sounding reference signal (SRS) resource for transmitting an SRS by the terminal through eight antenna ports, the SRS resource including at least two SRS transmission occasions associated with at least two antenna port subsets included in the eight antenna ports, respectively; and
based on the configuration information, transmit, to the base station, the SRS on a first antenna port subset associated with a first SRS transmission occasion and a second antenna port subset associated with a second SRS transmission occasion in the at least two SRS transmission occasions, respectively, and
wherein, in case that at least one SRS transmission occasion among the first SRS transmission occasion or the second SRS transmission occasion overlaps at least one of an aperiodic uplink transmission or an aperiodic downlink reception, an SRS transmission for all or a part of the first SRS transmission occasion and the second SRS transmission occasion is dropped.

10. The terminal of claim 9, wherein, in case that an SRS transmission for a part of the first SRS transmission occasion and the second SRS transmission occasion is dropped,
the controller is configured to transmit the SRS on an antenna port subset related to a remaining SRS transmission occasion except for a dropped SRS transmission occasion, and
wherein an SRS transmission for the dropped SRS transmission occasion is preferentially performed during an SRS transmission period subsequent to an SRS transmission period related to the first SRS transmission occasion and the second SRS transmission occasion.

11. The terminal of claim 9, wherein the controller is further configured to receive, from the base station, downlink control information (DCI) including a transmission power control (TPC) command value for a TPC command accumulation operation, performed in an i-th (i is a natural number) SRS transmission occasion among the at least two SRS transmission occasions, during a time interval related to the TPC command accumulation operation, and
wherein an end time point of the time interval is a time point preceding a start symbol of the i-th SRS transmission occasion by a symbol length of a predetermined number of symbols.

12. The terminal of claim 11, wherein, in case that the terminal is a terminal capable of performing the TPC command accumulation operation, the symbol length related to the end time point of the time interval is determined to be a symbol length from an end time point of a last symbol of a physical downlink control channel (PDCCH), through which the terminal receives DCI triggering the i-th SRS transmission occasion, to a start time point of the i-th SRS transmission occasion.

13. A base station in a wireless communication system, the base station comprising:
a transceiver; and
a controller connected to the transceiver,
wherein the controller is configured to:
transmit, to a terminal, configuration information including information on a sounding reference signal (SRS) resource for receiving an SRS through eight antenna ports of the terminal, the SRS resource including at least two SRS transmission occasions associated with at least two antenna port subsets included in the eight antenna ports, respectively; and
based on the configuration information, receive, from the terminal, the SRS on a first antenna port subset associated with a first SRS transmission occasion and a second antenna port subset associated with a second SRS transmission occasion in the at least two SRS transmission occasions, respectively, and
wherein, in case that at least one SRS transmission occasion among the first SRS transmission occasion or the second SRS transmission occasion overlaps at least one of an aperiodic uplink reception or an aperiodic downlink transmission, an SRS reception for all or a part of the first SRS transmission occasion and the second SRS transmission occasion is dropped.

14. The base station of claim 13, wherein, in case that an SRS reception for a part of the first SRS transmission occasion and the second SRS transmission occasion is dropped,
the controller is configured to receive the SRS on an antenna port subset related to a remaining SRS transmission occasion except for a dropped SRS transmission occasion, and
wherein an SRS reception for the dropped SRS transmission occasion is preferentially performed during an SRS transmission period subsequent to an SRS transmission period related to the first SRS transmission occasion and the second SRS transmission occasion.

15. The base station of claim 13, wherein the controller is further configured to transmit, to the terminal, downlink control information (DCI) including a transmission power control (TPC) command value for a TPC command accumulation operation, performed in an i-th (i is a natural number) SRS transmission occasion among the at least two SRS transmission occasions, during a time interval related to the TPC command accumulation operation, and
wherein an end time point of the time interval is a time point preceding a start symbol of the i-th SRS transmission occasion by a symbol length of a predetermined number of symbols.
